(19) United States
(12) Patent Application Publication
(10) Pub. No.: US 2026/0308433 A1
(43) Pub. Date: Oct. 8, 2026

(54) COMPOSITIONS

(71) Applicant: MEXICHEM UK LIMITED, Runcorn (GB)

(72) Inventors: Robert E. LOW, Ince (GB); Christopher J. SEETON, Waltham, MA (US)

(21) Appl. No.: 19/474,891

(22) PCT Filed: Apr. 12, 2024
(86) PCT No.: PCT/GB2024/050955

§ 371 Date: Oct. 13, 2025

Related U.S. Application Data
(60) Provisional application No. 63/496,093, filed on Apr. 14, 2023.

(30) Foreign Application Priority Data
May 24, 2023 (GB) 2307786.0

(51) Int. Cl. C09K 5/04; B60H 1/00; H01M 10/613; H01M 10/625; H01M 10/6569

(52) U.S. Cl. CPC C09K 5/045; B60H 1/00385; H01M 10/613; H01M 10/625; H01M 10/6569; C09K 2205/126

(57) ABSTRACT

According to the present invention, there is provided a composition comprising: (a) 1,1-difluoroethylene (R-1132a); (b) difluoromethane (R-32); (c) 1,1-difluoroethane (R-152a); and (d) trans-1,3,3,3-tetrafluoropropene (R-1234ze(E)).

The present invention relates to compositions, particularly refrigerant compositions suitable for use as replacement for existing refrigerants in liquid chiller systems, especially those found in thermal management systems of electric vehicles.

The listing or discussion of a prior-published document or any background in the specification should not necessarily be taken as an acknowledgement that a document or background is part of the state of the art or is common general knowledge.

In new internal combustion engine (ICE) vehicles, comfort heating of the passenger cabin is typically accomplished via direct heat exchange between waste heat from the combustion engine and passenger air. ICE vehicles also typically include an air-conditioning system, the sole function of which is to provide comfort cooling and dehumidification of air in passenger cabin.

In contrast, most electric vehicles (EVs, whether purely electric or hybrid vehicles) have no source of waste heat at a temperature high enough to deliver comfort heating of cabin air by direct heat exchange. Although the battery, power electronics and electric motors may act as sources of heat in EVs, they typically yield heat at too low a temperature to be directly used for heating of cabin air. In addition, a considerable amount of battery energy is used for thermal management of the battery itself. As there is no high-temperature waste heat available, using battery energy to provide passenger cabin heating and battery thermal management can significantly reduce EV range in winter conditions.

To address this, most EV designs have now incorporated heat pumping into the function of air-conditioning and require a refrigeration cycle not just for air-conditioning but to be integrated into the vehicle's “thermal management system”, whose function is to move heat into, around or out of the vehicle as necessary to simultaneously maintain passenger comfort, battery thermal condition and component cooling. There are two main design types of thermal management systems of EVs, namely air-to-air and fluid-to-fluid architectures (hereinafter ‘chiller architectures’).

Typical air-to-air architectures comprise heat exchangers where heat transfer occurs predominantly in crossflow, with air flowing perpendicular to one or more rows of refrigerant tubes.

By contrast, chiller architectures comprise a refrigeration cycle that is integrated into circuits of hot/cold heat transfer fluid, such as water. The purpose of the refrigeration cycle is to move heat from the cold loop to the hot loop.

Propane (R-290) has been successfully tested for application in chiller systems. However, propane is considered as a Volatile Organic Chemical (VOC) and a precursor to photochemical smog generation which is environmentally undesirable. In addition, propane's ability to operate in a heat pump cycle will be limited to external temperatures of about −30° C., which is typically insufficient for extremely low temperature winter conditions.

1,1-difluoroethane (R-152a) has been proposed for use in chiller architectures. It is relatively low cost, has acceptable Global Warming Potential (GWP) of 124 and is efficient as an air-conditioning refrigerant. However, its flammability (ASHRAE Class 2) precludes its use in direct heat exchange with cabin air; and its normal boiling point is higher than that of R-1234yf, meaning that its performance in heat pump mode will be poor and limited to temperatures above −15° C. making it inefficient for cold ambient heat pumps.

2,3,3,3-tetrafluoropropene (R-1234yf) is currently used in automobile air-conditioning systems. R-1234yf is weakly flammable (class “2L” as per ASHRAE SSPC34). This degree of flammability has been accepted by the automotive industry following extensive risk assessment processes as sufficiently low to allow safe engineering design to mitigate its hazards. It would be desirable to identify alternative refrigerants that may give better performance in EV thermal management applications while maintaining acceptably low flammability, like that of R-1234yf.

Refrigerants such as R-454C (R-32/R-1234yf 21.5%/78.5%) and R-474A (R-1132(E)/R-1234yf 23%/77%) have GWP lower than 150 and a higher vapour pressure than that of R-1234yf. However, they are formulated using R-1234yf. Even though R-1234yf has certain desirable performance characteristics, it has been found to break down rapidly in the environment with 100% molar yield to form trifluoroacetic acid (TFA). TFA is toxic and is very resistant to environmental degradation. The large-scale implementation of R-1234yf or blends comprising this compound in EV systems would lead to an increase in levels of TFA in groundwater. Therefore, there exists a need for new refrigerants that will generate less TFA on release to the environment than R-1234yf.

Surprisingly, the compositions of the invention which contain very low levels of R-1234yf (or preferably substantially no R-1234yf), for example compositions in which any R-1234yf is effectively replaced by R-1234ze(E), exhibit one or more of improved energy efficiency and lower flammable limit (e.g. at room temperature), in addition to reduced TFA generation.

Thus, there is a need to provide alternative refrigerants for use in EV thermal management systems, such as those employing chiller architectures, said refrigerants having improved properties such as low GWP (so as to reduce the environmental impact of refrigerant leakage), yet possessing acceptable refrigeration performance, flammability characteristics and toxicology in the event of an accidental release into the passenger space.

The present invention addresses the above and other deficiencies/needs by the provision of a composition comprising 1,1-difluoroethylene (R 1132a), difluoromethane (R-32), 1,1-difluoroethane (R-152a) and trans-1,3,3,3-tetrafluoropropene (R-1234ze(E)).

The compositions of the invention have been surprisingly found to exhibit similar or improved performance to that of propane when used in EV thermal management systems, such as those employing chiller architectures, and particularly under extreme winter conditions. Similarly, the compositions of the invention have been found to exhibit better environmental characteristics compared to propane or R-1234yf. Surprisingly, the compositions of the invention have also been found to exhibit a temperature glide in evaporation or condensation that is close to typical temperature changes of heat transfer fluids (such as water, glycol or fluorinated fluids) used in EV thermal management systems employing chiller architectures. This enables improvements in capacity and energy efficiency of such thermal management systems.

The compositions of the invention typically contain from about 1 to about 20% by weight R-1132a. For example, the compositions may comprise from about 2 to about 20% by weight R-1132a, such as from about 3 to about 20% by weight, preferably from about 4 to about 18% by weight, such as from about 6 to about 16% by weight, preferably from 8 to 16% by weight.

The compositions of the invention may comprise from about 1 to about 35% by weight R-32. Conveniently, the compositions comprise from about 2 to about 30% by weight R-32, for example from about 5 to about 28% by weight, such as from about 7 to about 25% by weight, preferably from about 10 to about 22% by weight.

The R-152a may be included in the compositions of the invention in an amount of from about 1 to about 50% by weight, such as from about 2 to about 40% by weight, for example from about 2 or about 3 to about 35% by weight, such as from about 2 or about 3 to about 30% by weight, for example from about 3 or about 4 to about 25% by weight, preferably from 6 to 18% by weight.

The compositions of the invention conveniently comprise from about 30 to about 90% by weight R-1234ze(E), such as from about 30 to about 85% by weight, for example from about 35 to about 80% by weight, such as from about 40 to about 75% by weight, such as from about 45 to about 70% by weight, preferably from about 45 to about 63 weight %.

Thus, the present invention provides a composition comprising from about 1 to about 20% by weight R-1132a, from about 1 to about 35% by weight R-32, from about 1 to about 50% by weight R-152a and from about 30 to about 90% by weight R-1234ze(E).

For example, the compositions of the invention may comprise from about 2 to about 20% by weight R-1132a, from about 2 to about 30% by weight R-32, from about 2 to about 40% by weight R-152a and from about 30 to about 85% by weight R-1234ze(E).

The compositions of the invention may comprise from about 3 to about 20% by weight R-1132a, from about 5 to about 28% by weight R-32, from about 3 to about 35% by weight R-152a and from about 35 to about 80% by weight R-1234ze(E).

Conveniently, the compositions of the invention comprise from about 4 to about 18% by weight R-1132a, from about 7 to about 25% by weight R-32, from about 3 to about 30% by weight R-152a and from about 40 to about 75% by weight R-1234ze(E).

Advantageously, the compositions of the invention comprise from about 4 to about 16% by weight R-1132a, from about 10 to about 22% by weight R-32, from about 4 to about 25% by weight R-152a and from about 45 to about 70% by weight R-1234ze(E).

Certain preferred compositions of the invention comprise from about 6 to about 16% by weight R-1132a, from about 15 to about 22% by weight R-32, from about 7 to about 20% by weight R-152a and from about 50 to 60% by weight R-1234ze(E), such as from about 8 to about 16% by weight R-1132a, from about 16 to about 21% by weight R-32, from about 8 to about 18% by weight R-152a and from about 50 to 60% by weight R-1234ze(E).

Typically, the weight ratio of R-152a to R-1234ze(E) in the compositions of the invention is 1:1.5 or less, such as 1:2 or less or 1:2.5 or less. For example, the R-152a is present in the compositions of the invention in an amount such that the weight ratio of R-152a and R-1234ze(E) is from about 1:1.5 to about 1:30, such as from about 1:2 to about 1:25, for example from about 1:2.5 to about 1:20.

Preferably, the weight ratio of R-152a to R-1234ze(E) in the compositions of the invention is 1:3 or less, such as 1:3.1 or less or 1:3.2 or less. Thus, in preferred embodiments, the R-152a and R-1234ze(E) are present in the compositions of the invention in an amount such that the weight ratio of R-152a and R-1234ze(E) is from about 1:3 to about 1:15, preferably from about 1:3.1 to about 1:12 or from about 1:3.2 to 1:10. We have surprisingly found that, by including R-152a in accordance with these ratios, it is possible to maximise the benefits of the refrigeration properties of R-152a in the context of COP and volumetric refrigeration capacity of the compositions of the invention, at the same time achieving low flammability (class 2L) of the compositions, even though R-152a itself has flammability classified as class ‘2’ (flammable refrigerant) by ASHRAE Standard 34. This is particularly desirable if the compositions of the invention are to be used in EV thermal management systems where there is a possibility of a refrigerant leaking into the passenger cabin.

Optionally, the compositions of the invention further comprise R-1132(E). Thus, the present invention provides a composition comprising R-1132a, R-32, R-152a, R-1234ze(E), particularly in the amounts described above, and from about 1 to about 32% by weight R-1132(E), such as from about 1 to about 28% by weight, for example from about 2 to about 25% by weight or from about 6 to about 24% by weight, preferably from about 9 to about 21% by weight. If R-1132(E) is included in the compositions of the invention, it is also preferred that the compositions comprise R-1132(E) in an amount (on weight basis) less than that of R-32. It has been surprisingly found that R-1132(E) can be used to reduce the GWP of the compositions of the invention without compromising their performance properties.

The compositions of the invention may comprise from 0 to about 15% by weight 2,3,3,3-tetrafluoropropene (R-1234yf), such as from 0 to about 10% by weight, preferably from 0 to about 5% by weight or from 0 to about 1% by weight. In one embodiment, the compositions of the invention contain substantially no R-1234yf. The inclusion of R-1234yf in these amounts ensures that the total generation potential of TFA from unit mass of the composition of the invention is significantly lower than that of the same quantity of other refrigerants which are formulated using R-1234yf, at the same time optionally allowing for the compositions of the invention to exploit advantageous properties of R-1234yf.

Any of the above-described compositions may further comprise carbon dioxide (CO₂). Although the presence of CO₂ generally tends to increase compressor discharge temperature and temperature glide (which may not desirable), the present inventors have surprisingly found that by including CO₂ in the compositions of the invention, it possible to formulate low GWP blends whose both WCF and WCFF has flammability classified as ‘2L’ under ASHRAE 34 assessment process.

When present, the CO₂ is typically included in the compositions of the invention in an amount of from about 1 to about 20% by weight, such as from about 1 or about 2 to about 18% by weight, for example from about 2 to about 16% by weight.

When CO₂ is present in the compositions of the invention, the R-1132a may be included in the composition in an amount of from about 1 to about 20% by weight, such as from about 1 or about 2 to about 18% by weight, for example from about 2 to about 16% by weight.

Advantageously, the R-1132a and the CO₂ are present in the compositions of the invention in a combined amount of from about 2 to about 25% by weight, such as from about 3 or about 4 to about 20% by weight, preferably from about 5 to about 18% by weight or from about 6 to about 18% by weight.

Thus, the present invention provides a composition comprising R-1132a and CO₂ in a combined amount of from about 2 to about 25% by weight, from about 1 to about 35% by weight R-32, from about 1 to about 50% by weight R-152a and from about 30 to about 90% by weight R-1234ze(E).

For example, the compositions of the invention may comprise R-1132a and CO₂ in a combined amount of from about 3 to about 20% by weight, from about 2 to about 30% by weight R-32, from about 2 to about 40% by weight R-152a and from about 30 to about 85% by weight R-1234ze(E).

The compositions of the invention may comprise R-1132a and CO₂ in a combined amount of from about 5 to about 20% by weight, from about 5 to about 28% by weight R-32, from about 3 to about 35% by weight R-152a and from about 35 to about 80% by weight R-1234ze(E).

Conveniently, the compositions of the invention comprise R-1132a and CO₂ in a combined amount of from about 5 to about 18% by weight, from about 7 to about 25% by weight R-32, from about 3 to about 30% by weight R-152a and from about 40 to about 75% by weight R-1234ze(E).

Advantageously, the compositions of the invention comprise R-1132a and CO₂ in a combined amount of from about 6 to about 18% by weight, from about 10 to about 23% by weight R-32, from about 4 to about 25% by weight R-152a and from about 45 to about 70% by weight R-1234ze(E).

Certain preferred compositions of the invention comprise CO₂ and R-1132a in a combined amount of from about 4 to about 16% by weight, from about 15 to about 22% by weight R-32, from about 11 to about 22% by weight R-152a and from about 50 to 65% by weight R-1234ze(E), preferably CO₂ and R-1132a in a combined amount of from about 6 to about 14% by weight, from about 16 to about 21% by weight R-32, from about 12 to about 20% by weight R-152a and from about 50 to 60% by weight R-1234ze(E).

Such compositions of the invention may comprise from about 3 to about 7% by weight CO₂, from about 3 to about 7% by weight R-1132a, from about 10 to about 22% by weight R-32, from about 8 to about 16% by weight R-152a and from about 50 to about 60% by weight R-1234ze(E).

For the avoidance of doubt, it is to be understood that the disclosure of the weight ratios of R-152a to R-1234ze(E) and effects thereof is also relevant to the compositions comprising CO₂ and other compositions described in this specification.

Any of the above-described compositions may further contain one or more compound(s) selected from the group consisting of 1,1,1,2-tetrafluoroethane (R-134a), butane (R-600), isobutane (R-600a), propane (R-290), octafluoropropane (R-218), 1,1,1,2,3,3,3-heptafluoropropane (R-227ea), trifluoroethylene (R-1123), fluoromethane (R-41), 3,3,3-trifluoropropene (R-1243zf) and/or fluoroethane (R-161) and mixtures thereof. Typically, the compositions of the invention contain from about 1 to about 15% by weight of the one or more compound(s), such as from about 1 to about 10% by weight, for example from about 1 to about 5% by weight.

In an embodiment, the compositions may consist essentially of the stated components. By the term “consist essentially of”, we include the meaning that the compositions of the invention contain substantially no other components, particularly no further (hydro)(fluoro)compounds (e.g. (hydro)(fluoro)alkanes or (hydro)(fluoro)alkenes) known to be used in heat transfer compositions. The term “consist of” is included within the meaning of “consist essentially of”.

Preferably, the compositions of the invention comprise substantially no trifluoroethylene (R-1123). Surprisingly, it has been found that such compositions have improved lifetime and chemical stability when used in thermal management systems of EVs.

In an embodiment, the compositions of the invention are substantially free of any component that has heat transfer properties other than the components specified. For instance, the compositions of the invention may be substantially free of any other hydrofluorocarbon compound.

By “substantially no” and “substantially free of”, we include the meaning that the compositions of the invention contain 0.5% by weight or less of the stated component, preferably 0.4%, 0.3%, 0.2% or 0.1% or less, based on the total weight of the composition.

In one embodiment, the compositions contain substantially no trifluoroiodomethane (CF₃I).

All of the chemicals herein described are commercially available. For example, the fluorochemicals may be obtained from Apollo Scientific (UK) and carbon dioxide may be obtained from liquefied gas suppliers such as Linde AG.

As used herein, all % amounts mentioned in compositions herein, including in the claims, are by weight based on the total weight of the compositions, unless otherwise stated.

By the term “about”, as used in connection with numerical values of amounts of components in % by weight, we include the meaning of ±0.5% by weight, for example ±0.1% by weight.

For the avoidance of doubt, it is to be understood that the stated upper and lower values for ranges of amounts of components in the compositions of the invention described herein may be interchanged in any way, provided that the resulting ranges fall within the broadest scope of the invention.

The compositions of the invention have zero ozone depletion potential.

Typically, the compositions of the invention have Global Warming Potential (GWP) of less than 300. Preferably, the compositions of the invention a GWP of less than 250, for example less than 200, such as less than 175, preferably less than 150.

Typically, the compositions of the invention are of reduced flammability hazard when compared to R-1132a and R-1132(E) alone.

Flammability may be determined in accordance with ASHRAE Standard 34 incorporating the ASTM Standard E-681 with test methodology as per Addendum 34p dated 2004, the entire content of which is incorporated herein by reference.

In one aspect, the compositions have one or more of (a) a higher ‘lower flammable limit’ (LFL); (b) a higher ignition energy (sometimes referred to as auto ignition energy or pyrolysis); or (c) a lower flame velocity compared to R-1132a and R-1132(E) alone. Preferably, the compositions of the invention are less flammable compared to R-1132a and R-1132(E) in one or more of the following respects: lower flammable limit at 23° C.; lower flammable limit at 60° C.; breadth of flammable range at 23° C. or 60° C.; auto-ignition temperature (thermal decomposition temperature); minimum ignition energy in dry air or flame speed. The flammable limits being determined according to the methods specified in ASHRAE-34 and the auto-ignition temperature being determined in a 500 ml glass flask by the method of ASTM E659-78.

Preferably, the compositions of the invention which contain very low levels of R-1234yf (or preferably substantially no R-1234yf) have a higher LFL than R-1234yf or compositions which contain significant amounts of R-1234yf, for example compositions which contain high amounts of R-1234yf compared to R-1234ze(E). For instance, compositions of the invention which contain very low levels of R-1234yf (preferably substantially no R-1234yf) have a higher LFL than a comparable composition in which the R-1234ze(E) in the composition of the invention is effectively replaced with R-1234yf.

In one embodiment, the compositions of the invention have a flammability classifiable as 2 or 2L according to the ASHRAE Standard 34 classification method, indicating a weakly flammable fluid with flame speed lower than 10 cm/s (class 2L) or flammable fluid (class 2).

The flammability of a refrigerant composition is classified by ASHRAE SSPC34 and ISO817 by a complex assessment process. Two compositions are considered: the “Worst Case Formulation” (WCF) and the “Worst Case Formulation for Flammability” (WCFF). The WCF is the composition that has the maximum permitted level of the most flammable species in the blend according to the manufacturing tolerances specified by the blend designer during the application process. The WCFF is the most flammable composition that can arise during vapour leakage of refrigerant from a cylinder or system at any temperature between −40° C. and +60° C.

Typically, at least the WCF of the compositions of the invention has flammability classified as ‘2L’ by ASHRAE-34 assessment process and certain compositions of the invention, as explained above, have both WCF and WCFF have flammability classified as ‘2L’ by ASHRAE-34 assessment process.

The compositions of the invention exhibit an unexpected combination of low-/non-flammability, low GWP, improved lubricant miscibility and improved refrigeration performance properties. Some of these refrigeration performance properties are explained in more detail below.

The compositions of the invention typically have a coefficient of performance COP (whether cooling and/or heating COP) that is within 15% of that of propane. Advantageously, the compositions of the invention have a COP that is within about 10% of that of propane, such as within about 7%, for example within about 5%, preferably equivalent or higher than that of propane.

Typically, the compositions of the invention have a volumetric refrigeration capacity (whether cooling and/or heating capacity) that is within about 15% of that of propane. Conveniently, the compositions of the invention have a volumetric refrigeration capacity that is within about 10% of that of propane, for example within about 5%. More preferably, the volumetric refrigeration capacity is greater than or equal to that of propane.

The compositions of the invention typically have a temperature glide in an evaporator or condenser of from about 25K to about 3K, conveniently from about 20K to about 5K, preferably from about 15K to about 5K. Such temperature glides are particularly suitable in thermal management systems employing chiller architectures, such as those using water/ethylene glycol or triacetin/carbon dioxide.

The compositions of the invention typically have a bubble point at atmospheric pressure of below about −35° C. Preferably, the compositions have a bubble point at atmospheric pressure of below about −42° C., preferably below about −50° C. Alternatively or additionally, it is preferred that the compositions of the invention have a vapour pressure greater than 1 bar at −40° C.

Conveniently, the compositions of the invention have a burning velocity of less than about 10 cm/s as measured by ASHRAE Standard 34.

Conveniently, the total generation potential of TFA from unit mass of the composition of the invention is less than that of the equivalent mass of R-1234yf, such as 10% or less, advantageously 5% or less, preferably 2% or less or even 1% or less.

The compositions of the invention are typically suitable for use in existing designs of equipment and are compatible with all classes of lubricant currently used with established HFC refrigerants. They may be optionally stabilised or compatibilised with mineral oils (e.g. lubricants) by the use of appropriate additives such as polyol esters (POEs), for example POEs with a viscosity of about 7 to 32 cSt at about 40° C.

Therefore, in one aspect, the composition of the invention is combined with a lubricant, particularly when used in heat transfer equipment.

Conveniently, the lubricant is selected from the group consisting of mineral oil, silicone oil, polyalkyl benzenes (PABs), polyol esters (POEs), polyalkylene glycols (PAGs, also known as polyethers), polyalkylene glycol esters (PAG esters), polyvinyl ethers (PVEs), poly (alpha-olefins) and combinations thereof. PAGs and POEs are currently preferred lubricants for the compositions of the invention.

Advantageously, the lubricant further comprises a stabiliser. In a similar aspect, the composition of the invention may be combined with a stabiliser.

Preferably, the stabiliser is selected from the group consisting of diene-based compounds, phosphates, phenol compounds (such as 2,6-Di-tert-butyl-4-methylphenol) and epoxides, and mixtures thereof.

Conveniently, the composition of the invention may be combined with a flame retardant.

Advantageously, the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

In one aspect of the invention, there is provided a liquid chiller system comprising a refrigerant, wherein the refrigerant is a composition of the invention, further wherein the liquid chiller system comprises at least one counter-flow heat exchanger for exchanging heat between the refrigerant and the liquid.

Such a chiller architecture can be used in conjunction with an air-to-air architecture. For example, a chiller architecture can be used for managing the temperature of the battery of an EV, while air-to-air architecture can be used for air-conditioning of the passenger cabin.

Typically, the liquid employed in the liquid chiller system as disclosed above is selected from water, brine, glycol, a synthetic hydrocarbon fluid, a silicone-based fluid or wholly or partially fluorinated organic fluid (for example a fluorinated ether or ketone), fluid blends with freeze point or viscosity reduction additives (such as Triacetin, Diacetin, acetone and/or carbon dioxide, for example acetone with carbon dioxide) and mixtures thereof. Preferably, the liquid chiller system is a water chiller system, a water/glycol chiller system or a chiller system employing a wholly or partially fluorinated organic fluid.

The counter-flow heat exchanger is adapted such that the refrigerant and the liquid flow in a counter-current flow (including quasi-counter-current flow) relative to each other when the refrigerant and the liquid pass through the counter-flow heat exchanger. In such an arrangement, the refrigerant condensation temperature need only be higher than the temperature of coolant entering the condenser; and the highest refrigerant evaporation temperature need only be lower than the heat source inlet temperature. Thus, temperature glide may allow the refrigerant to operate over a lower temperature range than a fluid with no glide and, consequently, to gain in relative capacity and energy efficiency.

In a related aspect of the invention, there is provided the use of a composition of the invention as a refrigerant in a liquid chiller system (such as that disclosed above), preferably wherein the liquid chiller system is incorporated into or is a thermal management system of an electric vehicle. Typically, the liquid chiller system is a liquid chiller system adapted for heating and/or cooling a battery and/or a passenger cabin of an electric vehicle. For example, the liquid chiller system may be adapted for cooling and/or heating the passenger cabin of an electric vehicle and may be adapted for cooling the battery of an electric vehicle. Alternatively or additionally, the liquid chiller system may be adapted for cooling other sources of potentially useful waste heat such as power electronics, instrument displays or braking systems.

The thermal management system of an electric vehicle typically contains a heat pump and/or air-conditioning system.

The invention also provides the use of a composition of the invention as a replacement for an existing refrigerant (such as in a liquid chiller system as disclosed above), preferably wherein the existing refrigerant is or comprises propane and/or R-1234yf, such wherein the existing refrigerant is propane or R-1234yf.

Also provided is a method of retrofitting a heat transfer device comprising the step of removing an existing heat transfer composition, and introducing a composition of the invention. Conveniently, the heat transfer device is a thermal management system of an electric vehicle. Advantageously, the existing heat transfer composition is propane (R-290) or 2,3,3,3-tetrafluoropropene (R-1234yf).

In a related aspect of the invention, there is provided a thermal management system of an electric vehicle, wherein the thermal management system comprises the liquid chiller system as disclosed above.

In another aspect of the invention, there is provided a heat transfer device comprising a refrigerant, wherein the refrigerant is a composition of the invention, further wherein the device comprises a heat sink fluid or heat source and at least one counter-flow heat exchanger for exchanging heat between the refrigerant and the heat sink fluid or heat source. The invention also provides the use of a composition of the invention in such a heat transfer device as herein described.

The counter-flow heat exchanger is adapted such that the refrigerant and the liquid flow in a counter-current flow (including quasi-counter-current flow) relative to each other when the refrigerant and the liquid pass through the counter-flow heat exchanger.

Such a heat transfer device may comprise a stationary refrigeration device, air-conditioning device or heat pump.

In such a heat transfer device, the heat sink fluid or heat source may be selected from water, brine, glycol, a synthetic hydrocarbon fluid, a silicone-based fluid or wholly or partially fluorinated organic fluid (for example a fluorinated ether or ketone), fluid blends with freeze point or viscosity reduction additives (such as Triacetin, Diacetin, acetone and/or carbon dioxide, for example acetone with carbon dioxide) and mixtures thereof.

In another aspect, there is provided the use of the composition of the invention in a thermal management system of an electric vehicle, wherein the thermal management system comprises an air-to-air architecture. It has now been surprisingly found that these compositions can be used in air-to-air designs without little or no modification of the existing design architecture. In this aspect, the thermal management system typically comprises a heat pump and/or an air-conditioning system, preferably a heat pump adapted to perform air-conditioning. The EV thermal management systems of this aspect may also incorporate a chiller loop for cooling heat generating components of the electric vehicle, such as battery, power electronics and/or electric motors.

Further in this aspect, when hot air is passed in crossflow (near) perpendicularly over rows of refrigerant the tubes of the evaporator, the air is cooled while the refrigerant evaporates inside the tubes of the evaporator. Similarly, heat is rejected by flowing external air in crossflow over the tubes of the condenser and condensing the refrigerant inside the tubes. For the heat exchange to occur in the condenser of the refrigerant circuit, the lowest refrigerant condensation temperature must be higher than the temperature of air leaving the condenser. Similarly, in the evaporator, the highest refrigerant evaporation temperature must be lower than the temperature of air leaving the evaporator.

If a refrigerant undergoes temperature glide during evaporation or condensation, the crossflow arrangement tends to reduce the effective temperature difference between air and refrigerant compared to a single-component refrigerant with no glide thus decreasing the efficiency of the heat exchanger. This has the effect of penalizing the performance of the refrigerant relative to a fluid with no glide. For this reason, it is generally desirable when using crossflow heat exchangers for the refrigerant glide to be kept low.

In another aspect of the invention, there is provided a method of producing cooling which method comprises evaporating a composition of the invention in the vicinity of a body to be cooled. Preferably, the method is a method for producing cooling in an electric vehicle.

According to a further aspect of the invention, there is provided a method for producing heating which method comprises condensing a composition of the invention in the vicinity of a body to be heated. Preferably, the method is a method for producing heating in an electric vehicle.

The compositions of the invention may also be prepared simply by mixing the R-1132a, R-32, R-152a and R-1234ze(E) (and optional components such as R-1132(E), R-744, a lubricant, a stabiliser or an additional flame retardant) in the desired proportions. The compositions can then be added to a heat transfer device (or used in any other way as defined herein).

The invention will now be described with reference to the following, non-limiting examples.

### EXAMPLES

A thermodynamic property model was constructed using the NIST REFPROP9.1 software package. This was used to model refrigeration cycle performance for an idealised vapour compression cycle with known heat exchanger sizes, using the performance of propane (R-290) as a reference fluid.

The heat exchangers were modelled as being arranged in counter-current flow. The sizes of heat exchangers required were determined firstly based on using propane as refrigerant, with specified temperature changes of heat source and heat sink fluids and specified minimum temperature difference between refrigerant and external fluid. Then, the performance of selected refrigerant blends of the invention was evaluated by adjusting condensation and evaporation pressures of the refrigerant so that the same cooling or heating capacity was achieved with the same size of heat exchanger. This approach is known as “UA Cycle” modelling as described in Chapter 3 of “Vapor Compression Heat Pumps With Refrigerant Mixtures”, R. Radermacher, Y. Hwang, pub. CRC Press (Taylor & Francis) 2005, which is incorporated herein by reference.

For the air-conditioning cycle, the following cycle modelling conditions were assumed:

| | | |
|---|---|---|
| Heat sink fluid inlet temperature | ° C. | 45 |
| Heat sink fluid temperature rise | K | 10 |
| Minimum temperature difference in | K | 4 |
| condenser | | |
| Condenser subcooling | K | 1 |
| Heat source fluid inlet temperature | ° C. | 15 |
| Heat source fluid temperature drop | K | 5 |
| Minimum temperature difference in | K | 4 |
| evaporator | | |
| Evaporator superheat | K | 2 |
| Suction line superheat | K | 10 |
| System cooling or heating duty | kW | 5 |
| Compressor efficiency | | 65% |

The table below shows the results for propane (R-290) at these conditions.

Results for propane (R-290)

| | | |
|---|---|---|
| Heating COP | 3.30 | |
| Cooling COP | 2.13 | |
| Heating Capacity | 3750 | kJ/m³ |
| Cooling Capacity | 2418 | kJ/m³ |
| Condensing Pressure | 20.7 | bar |
| Evaporating Pressure | 5.4 | bar |

Results for the selected compositions in air-conditioning mode are shown in Tables 1 to 28.

Subsequently, performance of selected compositions of the invention in heat pump mode was assessed using propane as a reference refrigerant. The following cycle modelling conditions were used:

| | | |
|---|---|---|
| Heat sink fluid inlet temperature | ° C. | 50 |
| Heat sink fluid temperature rise | K | 10 |
| Minimum temperature difference in | K | 4 |
| condenser | | |
| Condenser subcooling | K | 1 |
| Heat source fluid inlet temperature | ° C. | −10 |
| Heat source fluid temperature drop | K | 5 |
| Minimum temperature difference in | K | 4 |
| evaporator | | |
| Evaporator superheat | K | 2 |
| Suction line superheat | K | 10 |
| System cooling or heating duty | kW | 5 |
| Compressor efficiency | | 65% |

The following table shows the results for propane (R-290) at these conditions.

Results for propane (R-290)

| | | |
|---|---|---|
| Heating COP | 2.09 | |
| Cooling COP | 1.00 | |
| Heating Capacity | 1851 | kJ/m³ |
| Cooling Capacity | 886 | kJ/m³ |
| Condensing Pressure | 23.0 | bar |
| Evaporating Pressure | 2.4 | bar |

Results for the selected compositions in heat pump mode are shown in Tables 29 to 58.

Surprisingly, the compositions of the invention have been found to have a temperature glide in evaporation or condensation that is close to typical temperature changes of heat transfer fluids (such as water, glycol or fluorinated fluids) used in EV thermal management systems employing chiller architectures. This enables improvements in capacity and energy efficiency of such thermal management systems.

The tables show that is possible to formulate compositions whose volumetric capacity is within at least 10% of that of propane and can exceed that of propane. This means that compressor designs for propane (or other refrigerants of comparable performance) may readily be adapted for use with the fluids of the invention. The tables also show that it is possible to increase COP in both heating and cooling modes of operation relative to propane. Thus, the compositions of the invention provide superior energy efficiency, which will benefit EV range. Finally, it can be seen that the operating pressures of the compositions of the invention are comparable to those of propane. It is believed that this will make adaptation of existing automotive componentry straightforward.

The data in the Tables surprisingly shows that the use of R-152a in the compositions of the invention enables an increase in both capacity and COP while reducing temperature glide.

TABLE 1
R-1132a/R-32/R-152a/R-1234ze(E) compositions comprising 4% by weight R-1132a

| R1132a | 4% | 4% | 4% | 4% | 4% | 4% | 4% | 4% | 4% | 4% | 4% | 4% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 86% | 84% | 82% | 80% | 78% | 76% | 74% | 72% | 70% | 68% | 66% | 64% |
| GWP | 68 | 71 | 73 | 76 | 78 | 81 | 83 | 86 | 88 | 91 | 93 | 95 |
| Heating COP relative to R-290 | 104% | 104% | 104% | 104% | 105% | 105% | 105% | 105% | 105% | 105% | 106% | 106% |
| Cooling COP relative to R-290 | 107% | 108% | 108% | 109% | 109% | 109% | 110% | 110% | 110% | 110% | 111% | 111% |
| Heating Capacity relative to R-290 | 84% | 85% | 85% | 85% | 86% | 86% | 86% | 87% | 87% | 87% | 87% | 88% |
| Cooling Capacity relative to R-290 | 88% | 88% | 89% | 89% | 89% | 90% | 90% | 91% | 91% | 91% | 92% | 92% |
| Condensing Pressure (bar) | 18.1 | 18.1 | 18.1 | 18.1 | 18.1 | 18.1 | 18.1 | 18.1 | 18.0 | 18.0 | 18.0 | 18.0 |
| Evaporating Pressure (bar) | 3.8 | 3.8 | 3.8 | 3.8 | 3.8 | 3.8 | 3.8 | 3.8 | 3.8 | 3.8 | 3.8 | 3.8 |
| Average Glide (K) | 9.1 | 8.9 | 8.8 | 8.6 | 8.5 | 8.3 | 8.2 | 8.1 | 7.9 | 7.8 | 7.7 | 7.6 |
| R1132a | 4% | 4% | 4% | 4% | 4% | 4% | 4% | 4% | 4% | 4% | 4% | 4% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 84% | 82% | 80% | 78% | 76% | 74% | 72% | 70% | 68% | 66% | 64% | 62% |
| GWP | 82 | 84 | 87 | 89 | 92 | 94 | 97 | 99 | 102 | 104 | 106 | 109 |
| Heating COP relative to R-290 | 104% | 104% | 104% | 104% | 105% | 105% | 105% | 105% | 105% | 105% | 106% | 106% |
| Cooling COP relative to R-290 | 108% | 108% | 108% | 109% | 109% | 109% | 110% | 110% | 110% | 111% | 111% | 111% |
| Heating Capacity relative to R-290 | 88% | 88% | 89% | 89% | 89% | 89% | 90% | 90% | 90% | 90% | 91% | 91% |
| Cooling Capacity relative to R-290 | 91% | 92% | 92% | 93% | 93% | 93% | 94% | 94% | 94% | 95% | 95% | 95% |
| Condensing Pressure (bar) | 18.7 | 18.7 | 18.7 | 18.7 | 18.7 | 18.7 | 18.7 | 18.6 | 18.6 | 18.6 | 18.6 | 18.6 |
| Evaporating Pressure (bar) | 3.9 | 3.9 | 3.9 | 3.9 | 4.0 | 4.0 | 4.0 | 4.0 | 4.0 | 4.0 | 4.0 | 4.0 |
| Average Glide (K) | 9.6 | 9.4 | 9.2 | 9.1 | 8.9 | 8.8 | 8.6 | 8.5 | 8.4 | 8.2 | 8.1 | 8.0 |

TABLE 2
R-1132a/R-32/R-152a/R-1234ze(E) compositions comprising 4% by weight R-1132a

| R1132a | 4% | 4% | 4% | 4% | 4% | 4% | 4% | 4% | 4% | 4% | 4% | 4% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 95 | 98 | 100 | 103 | 105 | 108 | 110 | 113 | 115 | 118 | 120 | 122 |
| Heating COP relative to R-290 | 104% | 104% | 104% | 104% | 105% | 105% | 105% | 105% | 105% | 106% | 106% | 106% |
| Cooling COP relative to R-290 | 108% | 108% | 109% | 109% | 109% | 109% | 110% | 110% | 110% | 111% | 111% | 111% |
| Heating Capacity relative to R-290 | 92% | 92% | 92% | 92% | 93% | 93% | 93% | 93% | 93% | 93% | 94% | 94% |
| Cooling Capacity relative to R-290 | 95% | 95% | 96% | 96% | 97% | 97% | 97% | 98% | 98% | 98% | 98% | 99% |
| Condensing Pressure (bar) | 19.4 | 19.4 | 19.3 | 19.3 | 19.3 | 19.3 | 19.2 | 19.2 | 19.2 | 19.2 | 19.2 | 19.1 |
| Evaporating Pressure (bar) | 4.1 | 4.1 | 4.1 | 4.1 | 4.1 | 4.1 | 4.1 | 4.1 | 4.1 | 4.1 | 4.1 | 4.1 |
| Average Glide (K) | 10.0 | 9.8 | 9.6 | 9.5 | 9.3 | 9.1 | 9.0 | 8.8 | 8.7 | 8.6 | 8.4 | 8.3 |
| R1132a | 4% | 4% | 4% | 4% | 4% | 4% | 4% | 4% | 4% | 4% | 4% | 4% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 109 | 111 | 114 | 116 | 119 | 121 | 124 | 126 | 129 | 131 | 133 | 136 |
| Heating COP relative to R-290 | 104% | 104% | 104% | 104% | 105% | 105% | 105% | 105% | 105% | 106% | 106% | 106% |
| Cooling COP relative to R-290 | 108% | 108% | 109% | 109% | 109% | 110% | 110% | 110% | 111% | 111% | 111% | 111% |
| Heating Capacity relative to R-290 | 95% | 95% | 95% | 96% | 96% | 96% | 96% | 96% | 96% | 97% | 97% | 97% |
| Cooling Capacity relative to R-290 | 99% | 99% | 99% | 100% | 100% | 100% | 101% | 101% | 101% | 101% | 102% | 102% |
| Condensing Pressure (bar) | 20.0 | 20.0 | 20.0 | 19.9 | 19.9 | 19.9 | 19.8 | 19.8 | 19.8 | 19.7 | 19.7 | 19.7 |
| Evaporating Pressure (bar) | 4.3 | 4.3 | 4.3 | 4.3 | 4.3 | 4.3 | 4.3 | 4.3 | 4.3 | 4.3 | 4.3 | 4.3 |
| Average Glide (K) | 10.3 | 10.1 | 9.9 | 9.8 | 9.6 | 9.4 | 9.3 | 9.1 | 9.0 | 8.8 | 8.7 | 8.6 |

TABLE 3
R-1132a/R-32/R-152a/R-1234ze(E) compositions comprising 4% by weight R-1132a

| | | | | | | | | | | | | |
|---|---|---|---|---|---|---|---|---|---|---|---|---|
| R1132a | 4% | 4% | 4% | 4% | 4% | 4% | 4% | 4% | 4% | 4% | 4% | 4% |
| R32 | 18% | 18% | 18% | 18% | 18% | 18% | 18% | 18% | 18% | 18% | 20% | 20% |
| R152a | 0% | 2% | 4% | 6% | 8% | 10% | 12% | 14% | 16% | 18% | 0% | 2% |
| R1234zeE | 78% | 76% | 74% | 72% | 70% | 68% | 66% | 64% | 62% | 60% | 76% | 74% |
| GWP | 122 | 125 | 127 | 130 | 132 | 135 | 137 | 140 | 142 | 144 | 136 | 138 |
| Heating COP relative to R-290 | 104% | 104% | 104% | 104% | 105% | 105% | 105% | 105% | 105% | 106% | 104% | 104% |
| Cooling COP relative to R-290 | 108% | 108% | 109% | 109% | 109% | 110% | 110% | 110% | 111% | 111% | 108% | 108% |
| Heating Capacity relative to R-290 | 99% | 99% | 99% | 99% | 99% | 99% | 99% | 99% | 100% | 100% | 102% | 102% |
| Cooling Capacity relative to R-290 | 102% | 103% | 103% | 103% | 104% | 104% | 104% | 104% | 105% | 105% | 106% | 106% |
| Condensing Pressure (bar) | 20.6 | 20.6 | 20.6 | 20.5 | 20.5 | 20.4 | 20.4 | 20.3 | 20.3 | 20.3 | 21.2 | 21.2 |
| Evaporating Pressure (bar) | 4.4 | 4.4 | 4.4 | 4.4 | 4.4 | 4.4 | 4.4 | 4.4 | 4.4 | 4.4 | 4.6 | 4.6 |
| Average Glide (K) | 10.5 | 10.3 | 10.2 | 10.0 | 9.8 | 9.6 | 9.5 | 9.3 | 9.2 | 9.1 | 10.7 | 10.5 |

| | | | | | | |
|---|---|---|---|---|---|---|
| R1132a | 4% | 4% | 4% | 4% | 4% | 4% |
| R32 | 20% | 20% | 20% | 20% | 22% | 22% |
| R152a | 4% | 6% | 8% | 10% | 0% | 2% |
| R1234zeE | 72% | 70% | 68% | 66% | 75% | 73% |
| GWP | 141 | 143 | 146 | 148 | 146 | 148 |
| Heating COP relative to R-290 | 104% | 104% | 105% | 195% | 104% | 104% |
| Cooling COP relative to R-290 | 109% | 109% | 109% | 110% | 108% | 108% |
| Heating Capacity relative to R-290 | 102% | 102% | 102% | 102% | 104% | 105% |
| Cooling Capacity relative to R-290 | 107% | 107% | 107% | 107% | 109% | 109% |
| Condensing Pressure (bar) | 21.1 | 21.1 | 21.0 | 21.0 | 21.7 | 21.6 |
| Evaporating Pressure (bar) | 4.6 | 4.6 | 4.6 | 4.6 | 4.7 | 4.7 |
| Average Glide (K) | 10.3 | 10.1 | 10.0 | 9.8 | 10.7 | 10.6 |

TABLE 4
R-1132a/R-32/R-152a/R-1234ze(E) compositions comprising 6% by weight R-1132a

| R1132a | 6% | 6% | 6% | 6% | 6% | 6% | 6% | 6% | 6% | 6% | 6% | 6% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | | 8% | 10% | 12% | 14% | 16% | 18% | 20% | 22% |
| R1234zeE | 84% | 82% | 80% | 78% | 76% | 74% | 72% | 70% | 68% | 66% | 64% | 62% |
| GWP | 68 | 71 | 73 | 76 | 78 | 81 | 83 | 86 | 88 | 91 | 93 | 95 |
| Heating COP relative to R-290 | 103% | 103% | 104% | 104% | 104% | 104% | 104% | 104% | 105% | 105% | 105% | 105% |
| Cooling COP relative to R-290 | 107% | 107% | 107% | 108% | 108% | 108% | 109% | 109% | 109% | 110% | 110% | 110% |
| Heating Capacity relative to R-290 | 89% | 89% | 89% | 90% | 90% | 90% | 90% | 91% | 91% | 91% | 91% | 92% |
| Cooling Capacity relative to R-290 | 92% | 92% | 93% | 93% | 93% | 94% | 94% | 95% | 95% | 95% | 96% | 96% |
| Condensing Pressure (bar) | 19.1 | 19.1 | 19.1 | 19.1 | 19.1 | 19.0 | 19.0 | 19.0 | 19.0 | 19.0 | 19.0 | 19.0 |
| Evaporating Pressure (bar) | 4.0 | 4.0 | 4.0 | 4.0 | 4.0 | 4.0 | 4.0 | 4.0 | 4.0 | 4.0 | 4.0 | 4.0 |
| Average Glide (K) | 10.4 | 10.3 | 10.1 | 9.9 | 9.8 | 9.6 | 9.5 | 9.4 | 9.2 | 9.1 | 9.0 | 8.9 |
| R1132a | 6% | 6% | 6% | 6% | 6% | 6% | 6% | 6% | 6% | 6% | 6% | 6% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 82 | 84 | 87 | 89 | 92 | 94 | 97 | 99 | 102 | 104 | 106 | 109 |
| Heating COP relative to R-290 | 103% | 103% | 103% | 104% | 104% | 104% | 104% | 105% | 105% | 105% | 105% | 105% |
| Cooling COP relative to R-290 | 107% | 107% | 107% | 108% | 108% | 108% | 109% | 109% | 109% | 110% | 110% | 110% |
| Heating Capacity relative to R-290 | 92% | 92% | 93% | 93% | 93% | 93% | 94% | 94% | 94% | 94% | 94% | 95% |
| Cooling Capacity relative to R-290 | 95% | 96% | 96% | 97% | 97% | 97% | 98% | 98% | 98% | 99% | 99% | 99% |
| Condensing Pressure (bar) | 19.8 | 19.8 | 19.7 | 19.7 | 19.7 | 19.7 | 19.6 | 19.6 | 19.6 | 19.6 | 19.6 | 19.5 |
| Evaporating Pressure (bar) | 4.1 | 4.1 | 4.1 | 4.1 | 4.1 | 4.2 | 4.2 | 4.2 | 4.2 | 4.2 | 4.2 | 4.2 |
| Average Glide (K) | 10.8 | 10.7 | 10.5 | 10.3 | 10.2 | 10.0 | 9.9 | 9.7 | 9.6 | 9.5 | 9.3 | 9.2 |

TABLE 5
R-1132a/R-32/R-152a/R-1234ze(E) compositions comprising 6% by weight R-1132a

| R1132a | 6% | 6% | 6% | 6% | 6% | 6% | 6% | 6% | 6% | 6% | 6% | 6% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 95 | 98 | 100 | 103 | 105 | 108 | 110 | 113 | 115 | 118 | 120 | 122 |
| Heating COP relative to R-290 | 103% | 103% | 103% | 104% | 104% | 104% | 104% | 104% | 105% | 105% | 105% | 105% |
| Cooling COP relative to R-290 | 107% | 107% | 107% | 108% | 108% | 108% | 109% | 109% | 109% | 110% | 110% | 110% |
| Heating Capacity relative to R-290 | 96% | 96% | 96% | 96% | 97% | 97% | 97% | 97% | 97% | 97% | 98% | 98% |
| Cooling Capacity relative to R-290 | 99% | 99% | 100% | 100% | 101% | 101% | 101% | 101% | 102% | 102% | 102% | 103% |
| Condensing Pressure (bar) | 20.4 | 20.4 | 20.4 | 20.3 | 20.3 | 20.3 | 20.2 | 20.2 | 20.2 | 20.1 | 20.1 | 20.1 |
| Evaporating Pressure (bar) | 4.3 | 4.3 | 4.3 | 4.3 | 4.3 | 4.3 | 4.3 | 4.3 | 4.3 | 4.3 | 4.3 | 4.3 |
| Average Glide (K) | 11.2 | 11.0 | 10.8 | 10.6 | 10.5 | 10.3 | 10.2 | 10.0 | 9.9 | 9.7 | 9.6 | 9.5 |
| R1132a | 6% | 6% | 6% | 6% | 6% | 6% | 6% | 6% | 6% | 6% | 6% | 6% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 109 | 111 | 114 | 116 | 119 | 121 | 124 | 126 | 129 | 131 | 133 | 136 |
| Heating COP relative to R-290 | 103% | 103% | 103% | 104% | 104% | 104% | 104% | 104% | 105% | 105% | 105% | 105% |
| Cooling COP relative to R-290 | 107% | 107% | 107% | 108% | 108% | 108% | 109% | 109% | 109% | 110% | 110% | 110% |
| Heating Capacity relative to R-290 | 99% | 99% | 100% | 100% | 100% | 100% | 100% | 100% | 100% | 101% | 101% | 101% |
| Cooling Capacity relative to R-290 | 103% | 103% | 103% | 104% | 104% | 104% | 105% | 105% | 105% | 105% | 106% | 106% |
| Condensing Pressure (bar) | 21.1 | 21.0 | 21.0 | 20.9 | 20.9 | 20.9 | 20.8 | 20.8 | 20.7 | 20.7 | 20.7 | 20.6 |
| Evaporating Pressure (bar) | 4.5 | 4.5 | 4.5 | 4.5 | 4.5 | 4.5 | 4.5 | 4.5 | 4.5 | 4.5 | 4.5 | 4.5 |
| Average Glide (K) | 11.4 | 11.2 | 11.0 | 10.9 | 10.7 | 10.5 | 10.4 | 10.2 | 10.1 | 10.0 | 9.8 | 9.7 |

TABLE 6
R-1132a/R-32/R-152a/R-1234ze(E) compositions comprising 6% by weight R-1132a

| | | | | | | | | | | | | |
|---|---|---|---|---|---|---|---|---|---|---|---|---|
| R1132a | 6% | 6% | 6% | 6% | 6% | 6% | 6% | 6% | 6% | 6% | 6% | 6% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 122 | 125 | 127 | 130 | 132 | 135 | 137 | 140 | 142 | 144 | 147 | 149 |
| Heating COP relative to R-290 | 103% | 103% | 103% | 104% | 104% | 104% | 104% | 104% | 105% | 105% | 105% | 105% |
| Cooling COP relative to R-290 | 107% | 107% | 107% | 108% | 108% | 109% | 109% | 109% | 109% | 110% | 110% | 110% |
| Heating Capacity relative to R-290 | 103% | 103% | 103% | 103% | 103% | 103% | 103% | 104% | 104% | 104% | 104% | 104% |
| Cooling Capacity relative to R-290 | 106% | 107% | 107% | 107% | 107% | 108% | 108% | 108% | 108% | 109% | 109% | 109% |
| Condensing Pressure (bar) | 21.7 | 21.6 | 21.6 | 21.5 | 21.5 | 21.4 | 21.4 | 21.3 | 21.3 | 21.2 | 21.2 | 21.1 |
| Evaporating Pressure (bar) | 4.7 | 4.7 | 4.7 | 4.6 | 4.6 | 4.6 | 4.6 | 4.6 | 4.6 | 4.6 | 4.6 | 4.6 |
| Average Glide (K) | 11.6 | 11.4 | 11.2 | 11.0 | 10.9 | 10.7 | 10.5 | 10.4 | 10.2 | 10.1 | 10.0 | 9.8 |

| | | | | | | |
|---|---|---|---|---|---|---|
| R1132a | 6% | 6% | 6% | 6% | 6% | 6% |
| R32 | 20% | 20% | 20% | 20% | 20% | 20% |
| R152a | 0% | 2% | 4% | 6% | 8% | 10% |
| R1234zeE | 74% | 72% | 70% | 68% | 66% | 64% |
| GWP | 136 | 138 | 141 | 143 | 146 | 148 |
| Heating COP relative to R-290 | 103% | 103% | 103% | 104% | 104% | 104% |
| Cooling COP relative to R-290 | 107% | 107% | 107% | 108% | 108% | 109% |
| Heating Capacity relative to R-290 | 106% | 106% | 106% | 106% | 106% | 107% |
| Cooling Capacity relative to R-290 | 110% | 110% | 110% | 111% | 111% | 111% |
| Condensing Pressure (bar) | 22.3 | 22.2 | 22.2 | 22.1 | 22.1 | 22.0 |
| Evaporating Pressure (bar) | 4.8 | 4.8 | 4.8 | 4.8 | 4.8 | 4.8 |
| Average Glide (K) | 11.6 | 11.5 | 11.3 | 11.1 | 10.9 | 10.8 |

TABLE 7
R-1132a/R-32/R-152a/R-1234ze(E) compositions comprising 8% by weight R-1132a

| R1132a | 8% | 8% | 8% | 8% | 8% | 8% | 8% | 8% | 8% | 8% | 8% | 8% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 68 | 71 | 73 | 76 | 78 | 81 | 83 | 86 | 88 | 91 | 93 | 95 |
| Heating COP relative to R-290 | 102% | 102% | 103% | 103% | 103% | 103% | 104% | 104% | 104% | 104% | 104% | 104% |
| Cooling COP relative to R-290 | 105% | 106% | 106% | 107% | 107% | 107% | 108% | 108% | 108% | 109% | 109% | 109% |
| Heating Capacity relative to R-290 | 93% | 93% | 93% | 93% | 94% | 94% | 94% | 95% | 95% | 95% | 95% | 95% |
| Cooling Capacity relative to R-290 | 95% | 96% | 96% | 97% | 97% | 98% | 98% | 98% | 99% | 99% | 99% | 100% |
| Condensing Pressure (bar) | 20.1 | 20.1 | 20.1 | 20.1 | 20.1 | 20.0 | 20.0 | 20.0 | 20.0 | 20.0 | 19.9 | 19.9 |
| Evaporating Pressure (bar) | 4.2 | 4.2 | 4.2 | 4.2 | 4.2 | 4.2 | 4.2 | 4.2 | 4.2 | 4.2 | 4.2 | 4.2 |
| Average Glide (K) | 11.6 | 11.4 | 11.3 | 11.1 | 11.0 | 10.8 | 10.7 | 10.5 | 10.4 | 10.3 | 10.2 | 10.0 |
| R1132a | 8% | 8% | 8% | 8% | 8% | 8% | 8% | 8% | 8% | 8% | 8% | 8% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 82 | 84 | 87 | 89 | 92 | 94 | 97 | 99 | 102 | 104 | 106 | 109 |
| Heating COP relative to R-290 | 102% | 102% | 103% | 103% | 103% | 103% | 104% | 104% | 104% | 104% | 104% | 104% |
| Cooling COP relative to R-290 | 105% | 106% | 106% | 106% | 107% | 107% | 108% | 108% | 108% | 109% | 109% | 109% |
| Heating Capacity relative to R-290 | 96% | 96% | 97% | 97% | 97% | 97% | 98% | 98% | 98% | 98% | 98% | 99% |
| Cooling Capacity relative to R-290 | 99% | 100% | 100% | 100% | 101% | 101% | 101% | 102% | 102% | 102% | 103% | 103% |
| Condensing Pressure (bar) | 20.8 | 20.8 | 20.8 | 20.7 | 20.7 | 20.7 | 20.6 | 20.6 | 20.6 | 20.5 | 20.5 | 20.5 |
| Evaporating Pressure (bar) | 4.3 | 4.3 | 4.3 | 4.3 | 4.3 | 4.4 | 4.4 | 4.4 | 4.4 | 4.4 | 4.4 | 4.4 |
| Average Glide (K) | 11.9 | 11.8 | 11.6 | 11.4 | 11.3 | 11.1 | 11.0 | 10.8 | 10.7 | 10.6 | 10.4 | 10.3 |

TABLE 8
R-1132a/R-32/R-152a/R-1234ze(E) compositions comprising 8% by weight R-1132a

| R1132a | 8% | 8% | 8% | 8% | 8% | 8% | 8% | 8% | 8% | 8% | 8% | 8% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 95 | 98 | 100 | 103 | 105 | 108 | 110 | 113 | 115 | 118 | 120 | 122 |
| Heating COP relative to R-290 | 102% | 102% | 103% | 103% | 103% | 103% | 103% | 104% | 104% | 104% | 104% | 104% |
| Cooling COP relative to R-290 | 105% | 106% | 106% | 107% | 107% | 107% | 108% | 108% | 108% | 109% | 109% | 109% |
| Heating Capacity relative to R-290 | 100% | 100% | 100% | 100% | 101% | 101% | 101% | 101% | 101% | 101% | 102% | 102% |
| Cooling Capacity relative to R-290 | 103% | 103% | 104% | 104% | 104% | 105% | 105% | 105% | 106% | 106% | 106% | 106% |
| Condensing Pressure (bar) | 21.5 | 21.4 | 21.4 | 21.4 | 21.3 | 21.3 | 21.2 | 21.2 | 21.2 | 21.1 | 21.1 | 21.0 |
| Evaporating Pressure (bar) | 4.5 | 4.5 | 4.5 | 4.5 | 4.5 | 4.5 | 4.5 | 4.5 | 4.5 | 4.5 | 4.5 | 4.5 |
| Average Glide (K) | 12.2 | 12.0 | 11.8 | 11.7 | 11.5 | 11.4 | 11.2 | 11.1 | 10.9 | 10.8 | 10.7 | 10.5 |
| R1132a | 8% | 8% | 8% | 8% | 8% | 8% | 8% | 8% | 8% | 8% | 8% | 8% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 109 | 111 | 114 | 116 | 119 | 121 | 124 | 126 | 129 | 131 | 133 | 136 |
| Heating COP relative to R-290 | 102% | 102% | 103% | 103% | 103% | 103% | 103% | 104% | 104% | 104% | 104% | 104% |
| Cooling COP relative to R-290 | 105% | 106% | 106% | 107% | 107% | 107% | 108% | 108% | 108% | 109% | 109% | 109% |
| Heating Capacity relative to R-290 | 103% | 103% | 104% | 104% | 104% | 104% | 104% | 104% | 104% | 105% | 105% | 105% |
| Cooling Capacity relative to R-290 | 107% | 107% | 107% | 108% | 108% | 108% | 108% | 109% | 109% | 109% | 109% | 110% |
| Condensing Pressure (bar) | 22.1 | 22.1 | 22.0 | 22.0 | 21.9 | 21.9 | 21.8 | 21.8 | 21.7 | 21.7 | 21.6 | 21.6 |
| Evaporating Pressure (bar) | 4.7 | 4.7 | 4.7 | 4.7 | 4.7 | 4.7 | 4.7 | 4.7 | 4.7 | 4.7 | 4.7 | 4.7 |
| Average Glide (K) | 12.4 | 12.2 | 12.0 | 11.8 | 11.7 | 11.5 | 11.4 | 11.2 | 11.1 | 10.9 | 10.8 | 10.7 |

TABLE 9
R-1132a/R-32/R-152a/R-1234ze(E) compositions comprising 8% by weight R-1132a

| | | | | | | | | | | | | |
|---|---|---|---|---|---|---|---|---|---|---|---|---|
| R1132a | 8% | 8% | 8% | 8% | 8% | 8% | 8% | 8% | 8% | 8% | 8% | 8% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 122 | 125 | 127 | 130 | 132 | 135 | 137 | 140 | 142 | 144 | 147 | 149 |
| Heating COP relative to R-290 | 102% | 102% | 103% | 103% | 103% | 103% | 103% | 104% | 104% | 104% | 104% | 104% |
| Cooling COP relative to R-290 | 105% | 106% | 106% | 107% | 107% | 107% | 108% | 108% | 108% | 109% | 109% | 109% |
| Heating Capacity relative to R-290 | 107% | 107% | 107% | 107% | 107% | 107% | 107% | 108% | 108% | 108% | 108% | 108% |
| Cooling Capacity relative to R-290 | 110% | 110% | 111% | 111% | 111% | 112% | 112% | 112% | 112% | 112% | 113% | 113% |
| Condensing Pressure (bar) | 22.7 | 22.7 | 22.6 | 22.6 | 22.5 | 22.4 | 22.4 | 22.3 | 22.3 | 22.2 | 22.1 | 22.1 |
| Evaporating Pressure (bar) | 4.9 | 4.9 | 4.9 | 4.9 | 4.9 | 4.9 | 4.8 | 4.8 | 4.8 | 4.8 | 4.8 | 4.8 |
| Average Glide (K) | 12.5 | 12.3 | 12.1 | 11.9 | 11.8 | 11.6 | 11.5 | 11.3 | 11.2 | 11.0 | 10.9 | 10.8 |

| | | | | | | |
|---|---|---|---|---|---|---|
| R1132a | 8% | 8% | 8% | 8% | 8% | 8% |
| R32 | 20% | 20% | 20% | 20% | 20% | 20% |
| R152a | 0% | 2% | 4% | 6% | 8% | 10% |
| R1234zeE | 72% | 70% | 68% | 66% | 64% | 62% |
| GWP | 136 | 138 | 141 | 143 | 146 | 148 |
| Heating COP relative to R-290 | 102% | 102% | 103% | 103% | 103% | 103% |
| Cooling COP relative to R-290 | 105% | 106% | 106% | 107% | 107% | 107% |
| Heating Capacity relative to R-290 | 110% | 110% | 110% | 110% | 111% | 111% |
| Cooling Capacity relative to R-290 | 114% | 114% | 114% | 114% | 115% | 115% |
| Condensing Pressure (bar) | 23.3 | 23.3 | 23.2 | 23.1 | 23.1 | 23.0 |
| Evaporating Pressure (bar) | 5.1 | 5.0 | 5.0 | 5.0 | 5.0 | 5.0 |
| Average Glide (K) | 12.5 | 12.3 | 12.1 | 12.0 | 11.8 | 11.7 |

TABLE 10
R-1132a/R-32/R-152a/R-1234ze(E) compositions comprising 10% by weight R-1132a

| R1132a | 10% | 10% | 10% | 10% | 10% | 10% | 10% | 10% | 10% | 10% | 10% | 10% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 68 | 71 | 73 | 76 | 78 | 81 | 83 | 86 | 88 | 91 | 93 | 95 |
| Heating COP relative to R-290 | 101% | 102% | 102% | 102% | 102% | 103% | 103% | 103% | 103% | 103% | 104% | 104% |
| Cooling COP relative to R-290 | 104% | 104% | 105% | 105% | 106% | 106% | 106% | 107% | 107% | 107% | 108% | 108% |
| Heating Capacity relative to R-290 | 97% | 97% | 97% | 97% | 98% | 98% | 98% | 98% | 99% | 99% | 99% | 99% |
| Cooling Capacity relative to R-290 | 99% | 100% | 100% | 100% | 101% | 101% | 102% | 102% | 102% | 103% | 103% | 103% |
| Condensing Pressure (bar) | 21.2 | 21.2 | 21.1 | 21.1 | 21.1 | 21.0 | 21.0 | 21.0 | 21.0 | 20.9 | 20.9 | 20.9 |
| Evaporating Pressure (bar) | 4.4 | 4.4 | 4.4 | 4.4 | 4.4 | 4.4 | 4.4 | 4.4 | 4.4 | 4.4 | 4.4 | 4.4 |
| Average Glide (K) | 12.6 | 12.5 | 12.3 | 12.1 | 12.0 | 11.9 | 11.7 | 11.6 | 11.4 | 11.3 | 11.2 | 11.1 |
| R1132a | 10% | 10% | 10% | 10% | 10% | 10% | 10% | 10% | 10% | 10% | 10% | 10% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 82 | 84 | 87 | 89 | 92 | 94 | 97 | 99 | 102 | 104 | 106 | 109 |
| Heating COP relative to R-290 | 101% | 102% | 102% | 102% | 102% | 102% | 103% | 103% | 103% | 103% | 103% | 104% |
| Cooling COP relative to R-290 | 104% | 104% | 105% | 105% | 106% | 106% | 106% | 107% | 107% | 107% | 108% | 108% |
| Heating Capacity relative to R-290 | 100% | 100% | 101% | 101% | 101% | 101% | 102% | 102% | 102% | 102% | 102% | 102% |
| Cooling Capacity relative to R-290 | 103% | 103% | 104% | 104% | 104% | 105% | 105% | 106% | 106% | 106% | 106% | 107% |
| Condensing Pressure (bar) | 21.9 | 21.8 | 21.8 | 21.7 | 21.7 | 21.7 | 21.6 | 21.6 | 21.5 | 21.5 | 21.5 | 21.4 |
| Evaporating Pressure (bar) | 4.5 | 4.5 | 4.6 | 4.6 | 4.6 | 4.6 | 4.6 | 4.6 | 4.6 | 4.6 | 4.6 | 4.6 |
| Average Glide (K) | 12.9 | 12.7 | 12.6 | 12.4 | 12.2 | 12.1 | 11.9 | 11.8 | 11.7 | 11.5 | 11.4 | 11.3 |

TABLE 11
R-1132a/R-32/R-152a/R-1234ze(E) compositions comprising 10% by weight R-1132a

| R1132a | 10% | 10% | 10% | 10% | 10% | 10% | 10% | 10% | 10% | 10% | 10% | 10% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 95 | 98 | 100 | 103 | 105 | 108 | 110 | 113 | 115 | 118 | 120 | 122 |
| Heating COP relative to R-290 | 101% | 102% | 102% | 102% | 102% | 102% | 103% | 103% | 103% | 103% | 103% | 104% |
| Cooling COP relative to R-290 | 104% | 104% | 105% | 105% | 106% | 106% | 106% | 107% | 107% | 107% | 108% | 108% |
| Heating Capacity relative to R-290 | 104% | 104% | 104% | 104% | 105% | 105% | 105% | 105% | 105% | 105% | 105% | 106% |
| Cooling Capacity relative to R-290 | 107% | 107% | 107% | 108% | 108% | 108% | 109% | 109% | 109% | 109% | 110% | 110% |
| Condensing Pressure (bar) | 22.5 | 22.5 | 22.4 | 22.4 | 22.3 | 22.3 | 22.2 | 22.2 | 22.1 | 22.1 | 22.0 | 22.0 |
| Evaporating Pressure (bar) | 4.7 | 4.7 | 4.7 | 4.7 | 4.7 | 4.7 | 4.7 | 4.7 | 4.7 | 4.7 | 4.7 | 4.7 |
| Average Glide (K) | 13.1 | 12.9 | 12.7 | 12.6 | 12.4 | 12.3 | 12.1 | 12.0 | 11.8 | 11.7 | 11.6 | 11.5 |
| R1132a | 10% | 10% | 10% | 10% | 10% | 10% | 10% | 10% | 10% | 10% | 10% | 10% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 109 | 111 | 114 | 116 | 119 | 121 | 124 | 126 | 129 | 131 | 133 | 136 |
| Heating COP relative to R-290 | 101% | 101% | 102% | 102% | 102% | 102% | 103% | 103% | 103% | 103% | 103% | 104% |
| Cooling COP relative to R-290 | 104% | 104% | 105% | 105% | 106% | 106% | 106% | 107% | 107% | 107% | 108% | 108% |
| Heating Capacity relative to R-290 | 107% | 107% | 108% | 108% | 108% | 108% | 108% | 108% | 108% | 108% | 109% | 109% |
| Cooling Capacity relative to R-290 | 110% | 111% | 111% | 111% | 112% | 112% | 112% | 112% | 113% | 113% | 113% | 113% |
| Condensing Pressure (bar) | 23.2 | 23.1 | 23.1 | 23.0 | 22.9 | 22.9 | 22.8 | 22.8 | 22.7 | 22.6 | 22.6 | 22.5 |
| Evaporating Pressure (bar) | 4.9 | 4.9 | 4.9 | 4.9 | 4.9 | 4.9 | 4.9 | 4.9 | 4.9 | 4.9 | 4.9 | 4.9 |
| Average Glide (K) | 13.2 | 13.0 | 12.8 | 12.7 | 12.5 | 12.4 | 12.2 | 12.1 | 11.9 | 11.8 | 11.7 | 11.6 |

TABLE 12
R-1132a/R-32/R-152a/R-1234ze(E) compositions comprising 10% by weight R-1132a

| | | | | | | | | | | | | |
|---|---|---|---|---|---|---|---|---|---|---|---|---|
| R1132a | 10% | 10% | 10% | 10% | 10% | 10% | 10% | 10% | 10% | 10% | 10% | 10% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 122 | 125 | 127 | 130 | 132 | 135 | 137 | 140 | 142 | 144 | 147 | 149 |
| Heating COP relative to R-290 | 101% | 101% | 102% | 102% | 102% | 102% | 103% | 103% | 103% | 103% | 103% | 104% |
| Cooling COP relative to R-290 | 104% | 104% | 105% | 105% | 106% | 106% | 106% | 107% | 107% | 107% | 108% | 108% |
| Heating Capacity relative to R-290 | 111% | 111% | 111% | 111% | 111% | 111% | 111% | 111% | 112% | 112% | 112% | 112% |
| Cooling Capacity relative to R-290 | 114% | 114% | 114% | 115% | 115% | 115% | 115% | 116% | 116% | 116% | 116% | 116% |
| Condensing Pressure (bar) | 23.8 | 23.7 | 23.7 | 23.6 | 23.5 | 23.5 | 23.4 | 23.3 | 23.3 | 23.2 | 23.1 | 23.1 |
| Evaporating Pressure (bar) | 5.1 | 5.1 | 5.1 | 5.1 | 5.1 | 5.1 | 5.1 | 5.1 | 5.0 | 5.0 | 5.0 | 5.0 |
| Average Glide (K) | 13.2 | 13.0 | 12.9 | 12.7 | 12.6 | 12.4 | 12.3 | 12.1 | 12.0 | 11.9 | 11.7 | 11.6 |

| | | | | | | | | |
|---|---|---|---|---|---|---|---|---|
| R1132a | 10% | 10% | 10% | 10% | 10% | 10% | 10% | 10% |
| R32 | 20% | 20% | 20% | 20% | 20% | 20% | 22% | 22% |
| R152a | 0% | 2% | 4% | 6% | 8% | 10% | 0% | 2% |
| R1234zeE | 70% | 68% | 66% | 64% | 62% | 60% | 69% | 67% |
| GWP | 136 | 138 | 141 | 143 | 146 | 148 | 146 | 148 |
| Heating COP relative to R-290 | 101% | 101% | 102% | 102% | 102% | 102% | 101% | 101% |
| Cooling COP relative to R-290 | 104% | 105% | 105% | 105% | 106% | 106% | 104% | 105% |
| Heating Capacity relative to R-290 | 114% | 114% | 114% | 114% | 115% | 115% | 117% | 117% |
| Cooling Capacity relative to R-290 | 117% | 118% | 118% | 118% | 118% | 119% | 120% | 120% |
| Condensing Pressure (bar) | 24.4 | 24.3 | 24.3 | 24.2 | 24.1 | 24.0 | 24.9 | 24.8 |
| Evaporating Pressure (bar) | 5.3 | 5.3 | 5.3 | 5.3 | 5.2 | 5.2 | 5.4 | 5.4 |
| Average Glide (K) | 13.2 | 13.0 | 12.9 | 12.7 | 12.5 | 12.4 | 13.1 | 13.0 |

TABLE 13
R-1132a/R-32/R-152a/R-1234ze(E) compositions comprising 12% by weight R-1132a

| R1132a | 12% | 12% | 12% | 12% | 12% | 12% | 12% | 12% | 12% | 12% | 12% | 12% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 68 | 71 | 73 | 76 | 78 | 81 | 83 | 86 | 88 | 91 | 93 | 95 |
| Heating COP relative to R-290 | 101% | 101% | 101% | 101% | 101% | 102% | 102% | 102% | 102% | 103% | 103% | 103% |
| Cooling COP relative to R-290 | 103% | 103% | 104% | 104% | 104% | 105% | 105% | 105% | 106% | 106% | 107% | 107% |
| Heating Capacity relative to R-290 | 100% | 101% | 101% | 101% | 102% | 102% | 102% | 102% | 102% | 103% | 103% | 103% |
| Cooling Capacity relative to R-290 | 103% | 103% | 104% | 104% | 104% | 105% | 105% | 106% | 106% | 106% | 107% | 107% |
| Condensing Pressure (bar) | 22.2 | 22.2 | 22.2 | 22.1 | 22.1 | 22.1 | 22.0 | 22.0 | 21.9 | 21.9 | 21.9 | 21.8 |
| Evaporating Pressure (bar) | 4.6 | 4.6 | 4.6 | 4.6 | 4.6 | 4.6 | 4.6 | 4.6 | 4.6 | 4.6 | 4.6 | 4.6 |
| Average Glide (K) | 13.5 | 13.4 | 13.2 | 13.0 | 12.9 | 12.8 | 12.6 | 12.5 | 12.4 | 12.2 | 12.1 | 12.0 |
| R1132a | 12% | 12% | 12% | 12% | 12% | 12% | 12% | 12% | 12% | 12% | 12% | 12% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 82 | 84 | 87 | 89 | 92 | 94 | 97 | 99 | 102 | 104 | 106 | 109 |
| Heating COP relative to R-290 | 100% | 101% | 101% | 101% | 101% | 102% | 102% | 102% | 102% | 102% | 103% | 103% |
| Cooling COP relative to R-290 | 103% | 103% | 104% | 104% | 104% | 105% | 105% | 105% | 106% | 106% | 106% | 107% |
| Heating Capacity relative to R-290 | 104% | 104% | 105% | 105% | 105% | 105% | 105% | 106% | 106% | 106% | 106% | 106% |
| Cooling Capacity relative to R-290 | 106% | 107% | 107% | 108% | 108% | 108% | 109% | 109% | 109% | 110% | 110% | 110% |
| Condensing Pressure (bar) | 22.9 | 22.9 | 22.8 | 22.8 | 22.7 | 22.7 | 22.6 | 22.6 | 22.5 | 22.5 | 22.4 | 22.4 |
| Evaporating Pressure (bar) | 4.8 | 4.8 | 4.8 | 4.8 | 4.8 | 4.8 | 4.8 | 4.8 | 4.8 | 4.8 | 4.8 | 4.8 |
| Average Glide (K) | 13.7 | 13.5 | 13.4 | 13.2 | 13.1 | 12.9 | 12.8 | 12.7 | 12.5 | 12.4 | 12.3 | 12.2 |

TABLE 14
R-1132a/R-32/R-152a/R-1234ze(E) compositions comprising 12% by weight R-1132a

| R1132a | 12% | 12% | 12% | 12% | 12% | 12% | 12% | 12% | 12% | 12% | 12% | 12% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 95 | 98 | 100 | 103 | 105 | 108 | 110 | 113 | 115 | 118 | 120 | 122 |
| Heating COP relative to R-290 | 100% | 101% | 101% | 101% | 101% | 102% | 102% | 102% | 102% | 102% | 103% | 103% |
| Cooling COP relative to R-290 | 103% | 103% | 104% | 104% | 104% | 105% | 105% | 105% | 106% | 106% | 106% | 107% |
| Heating Capacity relative to R-290 | 108% | 108% | 108% | 108% | 108% | 109% | 109% | 109% | 109% | 109% | 109% | 109% |
| Cooling Capacity relative to R-290 | 110% | 111% | 111% | 111% | 112% | 112% | 112% | 113% | 113% | 113% | 113% | 114% |
| Condensing Pressure (bar) | 23.6 | 23.5 | 23.5 | 23.4 | 23.4 | 23.3 | 23.2 | 23.2 | 23.1 | 23.1 | 23.0 | 23.0 |
| Evaporating Pressure (bar) | 4.9 | 4.9 | 4.9 | 4.9 | 4.9 | 4.9 | 4.9 | 4.9 | 4.9 | 4.9 | 4.9 | 4.9 |
| Average Glide (K) | 13.8 | 13.7 | 13.5 | 13.3 | 13.2 | 13.0 | 12.9 | 12.8 | 12.6 | 12.5 | 12.4 | 12.3 |
| R1132a | 12% | 12% | 12% | 12% | 12% | 12% | 12% | 12% | 12% | 12% | 12% | 12% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 109 | 111 | 114 | 116 | 119 | 121 | 124 | 126 | 129 | 131 | 133 | 136 |
| Heating COP relative to R-290 | 100% | 101% | 101% | 101% | 101% | 102% | 102% | 102% | 102% | 102% | 103% | 103% |
| Cooling COP relative to R-290 | 103% | 103% | 104% | 104% | 104% | 105% | 105% | 105% | 106% | 106% | 106% | 107% |
| Heating Capacity relative to R-290 | 111% | 111% | 112% | 112% | 112% | 112% | 112% | 112% | 112% | 112% | 112% | 112% |
| Cooling Capacity relative to R-290 | 114% | 114% | 115% | 115% | 115% | 115% | 116% | 116% | 116% | 116% | 117% | 117% |
| Condensing Pressure (bar) | 24.2 | 24.2 | 24.1 | 24.0 | 24.0 | 23.9 | 23.8 | 23.8 | 23.7 | 23.6 | 23.6 | 23.5 |
| Evaporating Pressure (bar) | 5.1 | 5.1 | 5.1 | 5.1 | 5.1 | 5.1 | 5.1 | 5.1 | 5.1 | 5.1 | 5.1 | 5.1 |
| Average Glide (K) | 13.9 | 13.7 | 13.6 | 13.4 | 13.2 | 13.1 | 13.0 | 12.8 | 12.7 | 12.6 | 12.5 | 12.3 |

TABLE 15
R-1132a/R-32/R-152a/R-1234ze(E) compositions comprising 12% by weight R-1132a

| | | | | | | | | | | | | |
|---|---|---|---|---|---|---|---|---|---|---|---|---|
| R1132a | 12% | 12% | 12% | 12% | 12% | 12% | 12% | 12% | 12% | 12% | 12% | 12% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 122 | 125 | 127 | 130 | 132 | 135 | 137 | 140 | 142 | 144 | 147 | 149 |
| Heating COP relative to R-290 | 100% | 101% | 101% | 101% | 101% | 102% | 102% | 102% | 102% | 102% | 103% | 103% |
| Cooling COP relative to R-290 | 103% | 103% | 104% | 104% | 104% | 105% | 105% | 106% | 106% | 106% | 106% | 107% |
| Heating Capacity relative to R-290 | 115% | 115% | 115% | 115% | 115% | 115% | 115% | 115% | 115% | 115% | 115% | 115% |
| Cooling Capacity relative to R-290 | 118% | 118% | 118% | 118% | 119% | 119% | 119% | 119% | 120% | 120% | 120% | 120% |
| Condensing Pressure (bar) | 24.9 | 24.8 | 24.7 | 24.6 | 24.5 | 24.5 | 24.4 | 24.3 | 24.2 | 24.2 | 24.1 | 24.0 |
| Evaporating Pressure (bar) | 5.3 | 5.3 | 5.3 | 5.3 | 5.3 | 5.3 | 5.3 | 5.3 | 5.3 | 5.2 | 5.2 | 5.2 |
| Average Glide (K) | 13.9 | 13.7 | 13.5 | 13.4 | 13.2 | 13.1 | 13.0 | 12.8 | 12.7 | 12.6 | 12.5 | 12.4 |

| | | | | | | | | |
|---|---|---|---|---|---|---|---|---|
| R1132a | 12% | 12% | 12% | 12% | 12% | 12% | 12% | 12% |
| R32 | 20% | 20% | 20% | 20% | 20% | 20% | 22% | 22% |
| R152a | 0% | 2% | 4% | 6% | 8% | 10% | 0% | 2% |
| R1234zeE | 68% | 66% | 64% | 62% | 60% | 58% | 67% | 65% |
| GWP | 136 | 138 | 141 | 143 | 146 | 148 | 146 | 148 |
| Heating COP relative to R-290 | 100% | 101% | 101% | 101% | 101% | 102% | 100% | 101% |
| Cooling COP relative to R-290 | 103% | 103% | 104% | 104% | 104% | 105% | 103% | 103% |
| Heating Capacity relative to R-290 | 118% | 118% | 118% | 118% | 119% | 119% | 121% | 121% |
| Cooling Capacity relative to R-290 | 121% | 121% | 122% | 122% | 122% | 122% | 124% | 124% |
| Condensing Pressure (bar) | 25.5 | 25.4 | 25.3 | 25.2 | 25.1 | 25.0 | 25.9 | 25.8 |
| Evaporating Pressure (bar) | 5.5 | 5.5 | 5.5 | 5.5 | 5.5 | 5.5 | 5.7 | 5.7 |
| Average Glide (K) | 13.8 | 13.6 | 13.5 | 13.3 | 13.2 | 13.0 | 13.7 | 13.5 |

TABLE 16
R-1132a/R-32/R-152a/R-1234ze(E) compositions comprising 14% by weight R-1132a

| R1132a | 14% | 14% | 14% | 14% | 14% | 14% | 14% | 14% | 14% | 14% | 14% | 14% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 68 | 71 | 73 | 76 | 78 | 81 | 83 | 86 | 88 | 91 | 93 | 95 |
| Heating COP relative to R-290 | 100% | 100% | 100% | 100% | 101% | 101% | 101% | 101% | 101% | 102% | 102% | 102% |
| Cooling COP relative to R-290 | 101% | 102% | 102% | 103% | 103% | 103% | 104% | 104% | 105% | 105% | 105% | 106% |
| Heating Capacity relative to R-290 | 104% | 105% | 105% | 105% | 105% | 106% | 106% | 106% | 106% | 106% | 107% | 107% |
| Cooling Capacity relative to R-290 | 106% | 107% | 107% | 108% | 108% | 108% | 109% | 109% | 110% | 110% | 110% | 111% |
| Condensing Pressure (bar) | 23.3 | 23.3 | 23.2 | 23.2 | 23.1 | 23.1 | 23.0 | 23.0 | 22.9 | 22.9 | 22.8 | 22.8 |
| Evaporating Pressure (bar) | 4.8 | 4.8 | 4.8 | 4.8 | 4.8 | 4.8 | 4.8 | 4.8 | 4.8 | 4.8 | 4.8 | 4.8 |
| Average Glide (K) | 14.3 | 14.1 | 14.0 | 13.8 | 13.7 | 13.5 | 13.4 | 13.3 | 13.2 | 13.0 | 12.9 | 12.8 |
| R1132a | 14% | 14% | 14% | 14% | 14% | 14% | 14% | 14% | 14% | 14% | 14% | 14% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 82 | 84 | 87 | 89 | 92 | 94 | 97 | 99 | 102 | 104 | 106 | 109 |
| Heating COP relative to R-290 | 100% | 100% | 100% | 100% | 101% | 101% | 101% | 101% | 101% | 102% | 102% | 102% |
| Cooling COP relative to R-290 | 101% | 102% | 102% | 103% | 103% | 103% | 104% | 104% | 105% | 105% | 105% | 106% |
| Heating Capacity relative to R-290 | 108% | 108% | 108% | 109% | 109% | 109% | 109% | 109% | 110% | 110% | 110% | 110% |
| Cooling Capacity relative to R-290 | 110% | 110% | 111% | 111% | 112% | 112% | 112% | 113% | 113% | 113% | 114% | 114% |
| Condensing Pressure (bar) | 24.0 | 23.9 | 23.9 | 23.8 | 23.7 | 23.7 | 23.6 | 23.6 | 23.5 | 23.5 | 23.4 | 23.4 |
| Evaporating Pressure (bar) | 5.0 | 5.0 | 5.0 | 5.0 | 5.0 | 5.0 | 5.0 | 5.0 | 5.0 | 5.0 | 5.0 | 5.0 |
| Average Glide (K) | 14.4 | 14.3 | 14.1 | 14.0 | 13.8 | 13.7 | 13.5 | 13.4 | 13.3 | 13.2 | 13.0 | 12.9 |

TABLE 17
R-1132a/R-32/R-152a/R-1234ze(E) compositions comprising 14% by weight R-1132a

| R1132a | 14% | 14% | 14% | 14% | 14% | 14% | 14% | 14% | 14% | 14% | 14% | 14% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 95 | 98 | 100 | 103 | 105 | 108 | 110 | 113 | 115 | 118 | 120 | 122 |
| Heating COP relative to R-290 | 100% | 100% | 100% | 100% | 101% | 101% | 101% | 101% | 101% | 102% | 102% | 102% |
| Cooling COP relative to R-290 | 101% | 102% | 102% | 103% | 103% | 103% | 104% | 104% | 105% | 105% | 105% | 106% |
| Heating Capacity relative to R-290 | 112% | 112% | 112% | 112% | 112% | 112% | 113% | 113% | 113% | 113% | 113% | 113% |
| Cooling Capacity relative to R-290 | 114% | 114% | 114% | 115% | 115% | 116% | 116% | 116% | 116% | 117% | 117% | 117% |
| Condensing Pressure (bar) | 24.6 | 24.6 | 24.5 | 24.4 | 24.4 | 24.3 | 24.2 | 24.2 | 24.1 | 24.0 | 24.0 | 23.9 |
| Evaporating Pressure (bar) | 5.2 | 5.2 | 5.2 | 5.2 | 5.2 | 5.2 | 5.2 | 5.1 | 5.1 | 5.1 | 5.1 | 5.1 |
| Average Glide (K) | 14.5 | 14.3 | 14.2 | 14.0 | 13.9 | 13.7 | 13.6 | 13.5 | 13.3 | 13.2 | 13.1 | 13.0 |
| R1132a | 14% | 14% | 14% | 14% | 14% | 14% | 14% | 14% | 14% | 14% | 14% | 14% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 109 | 111 | 114 | 116 | 119 | 121 | 124 | 126 | 129 | 131 | 133 | 136 |
| Heating COP relative to R-290 | 100% | 100% | 100% | 100% | 101% | 101% | 101% | 101% | 101% | 102% | 102% | 102% |
| Cooling COP relative to R-290 | 101% | 102% | 102% | 103% | 103% | 103% | 104% | 104% | 105% | 105% | 105% | 106% |
| Heating Capacity relative to R-290 | 115% | 115% | 115% | 116% | 116% | 116% | 116% | 116% | 116% | 116% | 116% | 116% |
| Cooling Capacity relative to R-290 | 117% | 118% | 118% | 118% | 119% | 119% | 119% | 120% | 120% | 120% | 120% | 120% |
| Condensing Pressure (bar) | 25.3 | 25.2 | 25.1 | 25.1 | 25.0 | 24.9 | 24.8 | 24.7 | 24.7 | 24.6 | 24.5 | 24.5 |
| Evaporating Pressure (bar) | 5.4 | 5.4 | 5.4 | 5.4 | 5.3 | 5.3 | 5.3 | 5.3 | 5.3 | 5.3 | 5.3 | 5.3 |
| Average Glide (K) | 14.5 | 14.3 | 14.2 | 14.0 | 13.9 | 13.7 | 13.6 | 13.5 | 13.4 | 13.2 | 13.1 | 13.0 |

TABLE 18
R-1132a/R-32/R-152a/R-1234ze(E) compositions comprising 14% by weight R-1132a

| | | | | | | | | | | | |
|---|---|---|---|---|---|---|---|---|---|---|---|
| R1132a | 14% | 14% | 14% | 14% | 14% | 14% | 14% | 14% | 14% | 14% | 14% |
| R32 | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% |
| R1234zeE | 68% | 66% | 64% | 62% | 60% | 58% | 56% | 54% | 52% | 50% | 48% |
| GWP | 122 | 125 | 127 | 130 | 132 | 135 | 137 | 140 | 142 | 144 | 147 |
| Heating COP relative to R-290 | 100% | 100% | 100% | 100% | 101% | 101% | 101% | 101% | 101% | 102% | 102% |
| Cooling COP relative to R-290 | 101% | 102% | 102% | 103% | 103% | 104% | 104% | 104% | 105% | 105% | 105% |
| Heating Capacity relative to R-290 | 119% | 119% | 119% | 119% | 119% | 119% | 119% | 119% | 119% | 119% | 119% |
| Cooling Capacity relative to R-290 | 121% | 121% | 122% | 122% | 122% | 122% | 123% | 123% | 123% | 123% | 123% |
| Condensing Pressure (bar) | 25.9 | 25.8 | 25.7 | 25.7 | 25.6 | 25.5 | 25.4 | 25.3 | 25.2 | 25.2 | 25.1 |
| Evaporating Pressure (bar) | 5.6 | 5.6 | 5.5 | 5.5 | 5.5 | 5.5 | 5.5 | 5.5 | 5.5 | 5.5 | 5.5 |
| Average Glide (K) | 14.4 | 14.3 | 14.1 | 14.0 | 13.8 | 13.7 | 13.6 | 13.4 | 13.3 | 13.2 | 13.1 |

| | | | | | | | | |
|---|---|---|---|---|---|---|---|---|
| R1132a | 14% | 14% | 14% | 14% | 14% | 14% | 14% | 14% |
| R32 | 20% | 20% | 20% | 20% | 20% | 20% | 22% | 22% |
| R152a | 0% | 2% | 4% | 6% | 8% | 10% | 0% | 2% |
| R1234zeE | 66% | 64% | 62% | 60% | 58% | 56% | 65% | 63% |
| GWP | 136 | 138 | 141 | 143 | 146 | 148 | 146 | 148 |
| Heating COP relative to R-290 | 100% | 100% | 100% | 100% | 101% | 101% | 100% | 100% |
| Cooling COP relative to R-290 | 102% | 102% | 102% | 103% | 103% | 104% | 102% | 102% |
| Heating Capacity relative to R-290 | 122% | 122% | 122% | 122% | 122% | 122% | 125% | 125% |
| Cooling Capacity relative to R-290 | 125% | 125% | 125% | 126% | 126% | 126% | 128% | 128% |
| Condensing Pressure (bar) | 26.5 | 26.4 | 26.3 | 26.2 | 26.1 | 26.1 | 27.0 | 26.9 |
| Evaporating Pressure (bar) | 5.8 | 5.8 | 5.7 | 5.7 | 5.7 | 5.7 | 5.9 | 5.9 |
| Average Glide (K) | 14.3 | 14.1 | 14.0 | 13.9 | 13.7 | 13.6 | 14.2 | 14.0 |

TABLE 19
R-1132a/R-32/R-152a/R-1234ze(E) compositions comprising 16% by weight R-1132a

| R1132a | 16% | 16% | 16% | 16% | 16% | 16% | 16% | 16% | 16% | 16% | 16% | 16% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 68 | 71 | 73 | 76 | 78 | 81 | 83 | 86 | 88 | 91 | 93 | 95 |
| Heating COP relative to R-290 | 99% | 99% | 99% | 99% | 100% | 100% | 100% | 100% | 101% | 101% | 101% | 101% |
| Cooling COP relative to R-290 | 100% | 101% | 101% | 101% | 102% | 102% | 103% | 103% | 103% | 104% | 104% | 104% |
| Heating Capacity relative to R-290 | 108% | 108% | 109% | 109% | 109% | 109% | 110% | 110% | 110% | 110% | 110% | 110% |
| Cooling Capacity relative to R-290 | 110% | 110% | 111% | 111% | 111% | 112% | 112% | 113% | 113% | 113% | 114% | 114% |
| Condensing Pressure (bar) | 24.3 | 24.3 | 24.2 | 24.2 | 24.1 | 24.1 | 24.0 | 24.0 | 23.9 | 23.8 | 23.8 | 23.7 |
| Evaporating Pressure (bar) | 5.0 | 5.0 | 5.0 | 5.0 | 5.0 | 5.0 | 5.0 | 5.0 | 5.0 | 5.0 | 5.0 | 5.0 |
| Average Glide (K) | 14.9 | 14.8 | 14.6 | 14.5 | 14.4 | 14.2 | 14.1 | 14.0 | 13.9 | 13.7 | 13.6 | 13.5 |
| R1132a | 16% | 16% | 16% | 16% | 16% | 16% | 16% | 16% | 16% | 16% | 16% | 16% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 82 | 84 | 87 | 89 | 92 | 94 | 97 | 99 | 102 | 104 | 106 | 109 |
| Heating COP relative to R-290 | 99% | 99% | 99% | 99% | 100% | 100% | 100% | 100% | 101% | 101% | 101% | 101% |
| Cooling COP relative to R-290 | 100% | 100% | 101% | 101% | 102% | 102% | 103% | 103% | 103% | 104% | 104% | 104% |
| Heating Capacity relative to R-290 | 112% | 112% | 112% | 112% | 113% | 113% | 113% | 113% | 113% | 113% | 114% | 114% |
| Cooling Capacity relative to R-290 | 113% | 114% | 114% | 115% | 115% | 115% | 116% | 116% | 116% | 117% | 117% | 117% |
| Condensing Pressure (bar) | 25.0 | 25.0 | 24.9 | 24.8 | 24.8 | 24.7 | 24.6 | 24.6 | 24.5 | 24.4 | 24.4 | 24.3 |
| Evaporating Pressure (bar) | 5.2 | 5.2 | 5.2 | 5.2 | 5.2 | 5.2 | 5.2 | 5.2 | 5.2 | 5.2 | 5.2 | 5.2 |
| Average Glide (K) | 15.0 | 14.9 | 14.7 | 14.6 | 14.4 | 14.3 | 14.2 | 14.0 | 13.9 | 13.8 | 13.7 | 13.6 |

TABLE 20
R-1132a/R-32/R-152a/R-1234ze(E) compositions comprising 16% by weight R-1132a

| R1132a | 16% | 16% | 16% | 16% | 16% | 16% | 16% | 16% | 16% | 16% | 16% | 16% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 95 | 98 | 100 | 103 | 105 | 108 | 110 | 113 | 115 | 118 | 120 | 122 |
| Heating COP relative to R-290 | 99% | 99% | 99% | 99% | 100% | 100% | 100% | 100% | 101% | 101% | 101% | 101% |
| Cooling COP relative to R-290 | 100% | 100% | 101% | 101% | 102% | 102% | 103% | 103% | 103% | 104% | 104% | 104% |
| Heating Capacity relative to R-290 | 115% | 116% | 116% | 116% | 116% | 116% | 116% | 117% | 117% | 117% | 117% | 117% |
| Cooling Capacity relative to R-290 | 117% | 118% | 118% | 118% | 119% | 119% | 119% | 120% | 120% | 120% | 120% | 121% |
| Condensing Pressure (bar) | 25.7 | 25.6 | 25.5 | 25.5 | 25.4 | 25.3 | 25.2 | 25.2 | 25.1 | 25.0 | 24.9 | 24.9 |
| Evaporating Pressure (bar) | 5.4 | 5.4 | 5.4 | 5.4 | 5.4 | 5.4 | 5.4 | 5.4 | 5.4 | 5.4 | 5.3 | 5.3 |
| Average Glide (K) | 15.0 | 14.9 | 14.7 | 14.6 | 14.4 | 14.3 | 14.2 | 14.1 | 13.9 | 13.8 | 13.7 | 13.6 |
| R1132a | 16% | 16% | 16% | 16% | 16% | 16% | 16% | 16% | 16% | 16% | 16% | 16% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 109 | 111 | 114 | 116 | 119 | 121 | 124 | 126 | 129 | 131 | 133 | 136 |
| Heating COP relative to R-290 | 99% | 99% | 99% | 99% | 100% | 100% | 100% | 100% | 101% | 101% | 101% | 101% |
| Cooling COP relative to R-290 | 100% | 101% | 101% | 101% | 102% | 102% | 103% | 103% | 103% | 104% | 104% | 104% |
| Heating Capacity relative to R-290 | 119% | 119% | 119% | 120% | 120% | 120% | 120% | 120% | 120% | 120% | 120% | 120% |
| Cooling Capacity relative to R-290 | 121% | 121% | 122% | 122% | 122% | 122% | 123% | 123% | 123% | 123% | 124% | 124% |
| Condensing Pressure (bar) | 26.3 | 26.3 | 26.2 | 26.1 | 26.0 | 25.9 | 25.8 | 25.7 | 25.7 | 25.6 | 25.5 | 25.4 |
| Evaporating Pressure (bar) | 5.6 | 5.6 | 5.6 | 5.6 | 5.6 | 5.6 | 5.6 | 5.5 | 5.5 | 5.5 | 5.5 | 5.5 |
| Average Glide (K) | 15.0 | 14.8 | 14.7 | 14.5 | 14.4 | 14.3 | 14.1 | 14.0 | 13.9 | 13.8 | 13.7 | 13.6 |

TABLE 21
R-1132a/R-32/R-152a/R-1234ze(E) compositions comprising 16% by weight R-1132a

| | | | | | | | | | | | |
|---|---|---|---|---|---|---|---|---|---|---|---|
| R1132a | 16% | 16% | 16% | 16% | 16% | 16% | 16% | 16% | 16% | 16% | 16% |
| R32 | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% |
| R1234zeE | 66% | 64% | 62% | 60% | 58% | 56% | 54% | 52% | 50% | 48% | 46% |
| GWP | 122 | 125 | 127 | 130 | 132 | 135 | 137 | 140 | 142 | 144 | 147 |
| Heating COP relative to R-290 | 99% | 99% | 99% | 99% | 100% | 100% | 100% | 100% | 101% | 101% | 101% |
| Cooling COP relative to R-290 | 100% | 101% | 101% | 101% | 102% | 102% | 103% | 103% | 103% | 104% | 104% |
| Heating Capacity relative to R-290 | 123% | 123% | 123% | 123% | 123% | 123% | 123% | 123% | 123% | 123% | 123% |
| Cooling Capacity relative to R-290 | 125% | 125% | 125% | 125% | 126% | 126% | 126% | 126% | 127% | 127% | 127% |
| Condensing Pressure (bar) | 27.0 | 26.9 | 26.8 | 26.7 | 26.6 | 26.5 | 26.4 | 26.3 | 26.2 | 26.1 | 26.0 |
| Evaporating Pressure (bar) | 5.8 | 5.8 | 5.8 | 5.8 | 5.8 | 5.7 | 5.7 | 5.7 | 5.7 | 5.7 | 5.7 |
| Average Glide (K) | 14.9 | 14.7 | 14.6 | 14.4 | 14.3 | 14.2 | 14.1 | 13.9 | 13.8 | 13.7 | 13.6 |

| | | | | | | | | |
|---|---|---|---|---|---|---|---|---|
| R1132a | 16% | 16% | 16% | 16% | 16% | 16% | 16% | 16% |
| R32 | 20% | 20% | 20% | 20% | 20% | 20% | 22% | 22% |
| R152a | 0% | 2% | 4% | 6% | 8% | 10% | 0% | 2% |
| R1234zeE | 64% | 62% | 60% | 58% | 56% | 54% | 63% | 61% |
| GWP | 136 | 138 | 141 | 143 | 146 | 148 | 146 | 148 |
| Heating COP relative to R-290 | 99% | 99% | 99% | 99% | 100% | 100% | 99% | 99% |
| Cooling COP relative to R-290 | 100% | 101% | 101% | 102% | 102% | 102% | 100% | 101% |
| Heating Capacity relative to R-290 | 126% | 126% | 126% | 126% | 126% | 126% | 129% | 129% |
| Cooling Capacity relative to R-290 | 128% | 129% | 129% | 129% | 129% | 129% | 131% | 131% |
| Condensing Pressure (bar) | 27.6 | 27.5 | 27.4 | 27.3 | 27.2 | 27.1 | 28.0 | 27.9 |
| Evaporating Pressure (bar) | 6.0 | 6.0 | 6.0 | 6.0 | 6.0 | 5.9 | 6.2 | 6.1 |
| Average Glide (K) | 14.7 | 14.6 | 14.4 | 14.3 | 14.2 | 14.0 | 14.5 | 14.4 |

TABLE 22
R-1132a/R-32/R-152a/R-1234ze(E) compositions comprising 18% by weight R-1132a

| R1132a | 18% | 18% | 18% | 18% | 18% | 18% | 18% | 18% | 18% | 18% | 18% | 18% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 68 | 71 | 73 | 76 | 78 | 81 | 83 | 86 | 88 | 91 | 93 | 95 |
| Heating COP relative to R-290 | 98% | 98% | 98% | 99% | 99% | 99% | 99% | 100% | 100% | 100% | 100% | 100% |
| Cooling COP relative to R-290 | 99% | 99% | 100% | 100% | 101% | 101% | 101% | 102% | 102% | 103% | 103% | 103% |
| Heating Capacity relative to R-290 | 112% | 112% | 112% | 113% | 113% | 113% | 113% | 114% | 114% | 114% | 114% | 114% |
| Cooling Capacity relative to R-290 | 113% | 113% | 114% | 114% | 115% | 115% | 116% | 116% | 116% | 117% | 117% | 117% |
| Condensing Pressure (bar) | 25.4 | 25.3 | 25.3 | 25.2 | 25.1 | 25.1 | 25.0 | 25.0 | 24.9 | 24.8 | 24.8 | 24.7 |
| Evaporating Pressure (bar) | 5.2 | 5.2 | 5.2 | 5.2 | 5.2 | 5.2 | 5.2 | 5.2 | 5.2 | 5.2 | 5.2 | 5.2 |
| Average Glide (K) | 15.5 | 15.3 | 15.2 | 15.1 | 14.9 | 14.8 | 14.7 | 14.6 | 14.4 | 14.3 | 14.2 | 14.1 |
| R1132a | 18% | 18% | 18% | 18% | 18% | 18% | 18% | 18% | 18% | 18% | 18% | 18% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 82 | 84 | 87 | 89 | 92 | 94 | 97 | 99 | 102 | 104 | 106 | 109 |
| Heating COP relative to R-290 | 98% | 98% | 98% | 99% | 99% | 99% | 99% | 100% | 100% | 100% | 100% | 100% |
| Cooling COP relative to R-290 | 99% | 99% | 100% | 100% | 101% | 101% | 101% | 102% | 102% | 103% | 103% | 103% |
| Heating Capacity relative to R-290 | 116% | 116% | 116% | 116% | 117% | 117% | 117% | 117% | 117% | 117% | 117% | 117% |
| Cooling Capacity relative to R-290 | 117% | 117% | 118% | 118% | 118% | 119% | 119% | 120% | 120% | 120% | 120% | 121% |
| Condensing Pressure (bar) | 26.1 | 26.0 | 25.9 | 25.9 | 25.8 | 25.7 | 25.6 | 25.6 | 25.5 | 25.4 | 25.3 | 25.3 |
| Evaporating Pressure (bar) | 5.4 | 5.4 | 5.4 | 5.4 | 5.4 | 5.4 | 5.4 | 5.4 | 5.4 | 5.4 | 5.4 | 5.4 |
| Average Glide (K) | 15.5 | 15.4 | 15.2 | 15.1 | 15.0 | 14.8 | 14.7 | 14.6 | 14.5 | 14.4 | 14.3 | 14.2 |

TABLE 23
R-1132a/R-32/R-152a/R-1234ze(E) compositions comprising 18% by weight R-1132a

| R1132a | 18% | 18% | 18% | 18% | 18% | 18% | 18% | 18% | 18% | 18% | 18% | 18% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 95 | 98 | 100 | 103 | 105 | 108 | 110 | 113 | 115 | 118 | 120 | 122 |
| Heating COP relative to R-290 | 98% | 98% | 98% | 99% | 99% | 99% | 99% | 100% | 100% | 100% | 100% | 100% |
| Cooling COP relative to R-290 | 99% | 99% | 100% | 100% | 101% | 101% | 101% | 102% | 102% | 102% | 103% | 103% |
| Heating Capacity relative to R-290 | 119% | 120% | 120% | 120% | 120% | 120% | 120% | 120% | 120% | 120% | 121% | 121% |
| Cooling Capacity relative to R-290 | 121% | 121% | 121% | 122% | 122% | 122% | 123% | 123% | 123% | 123% | 124% | 124% |
| Condensing Pressure (bar) | 26.7 | 26.7 | 26.6 | 26.5 | 26.4 | 26.3 | 26.2 | 26.2 | 26.1 | 26.0 | 25.9 | 25.8 |
| Evaporating Pressure (bar) | 5.6 | 5.6 | 5.6 | 5.6 | 5.6 | 5.6 | 5.6 | 5.6 | 5.6 | 5.6 | 5.6 | 5.6 |
| Average Glide (K) | 15.5 | 15.3 | 15.2 | 15.1 | 14.9 | 14.8 | 14.7 | 14.6 | 14.4 | 14.3 | 14.2 | 14.1 |
| R1132a | 18% | 18% | 18% | 18% | 18% | 18% | 18% | 18% | 18% | 18% | 18% | 18% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 66% | 64% | 62% | 60% | 58% | 56% | 54% | 52% | 50% | 48% | 46% | 44% |
| GWP | 109 | 111 | 114 | 116 | 119 | 121 | 124 | 126 | 129 | 131 | 133 | 136 |
| Heating COP relative to R-290 | 98% | 98% | 98% | 99% | 99% | 99% | 99% | 100% | 100% | 100% | 100% | 100% |
| Cooling COP relative to R-290 | 99% | 99% | 100% | 100% | 101% | 101% | 101% | 102% | 102% | 103% | 103% | 103% |
| Heating Capacity relative to R-290 | 123% | 123% | 123% | 123% | 123% | 124% | 124% | 124% | 124% | 124% | 124% | 124% |
| Cooling Capacity relative to R-290 | 124% | 125% | 125% | 125% | 126% | 126% | 126% | 126% | 127% | 127% | 127% | 127% |
| Condensing Pressure (bar) | 27.4 | 27.3 | 27.2 | 27.1 | 27.0 | 26.9 | 26.8 | 26.7 | 26.7 | 26.6 | 26.5 | 26.4 |
| Evaporating Pressure (bar) | 5.9 | 5.8 | 5.8 | 5.8 | 5.8 | 5.8 | 5.8 | 5.8 | 5.8 | 5.7 | 5.7 | 5.7 |
| Average Glide (K) | 15.4 | 15.2 | 15.1 | 15.0 | 14.8 | 14.7 | 14.6 | 14.5 | 14.4 | 14.3 | 14.2 | 14.1 |

TABLE 24
R-1132a/R-32/R-152a/R-1234ze(E) compositions comprising 18% by weight R-1132a

| | | | | | | | | | | | |
|---|---|---|---|---|---|---|---|---|---|---|---|
| R1132a | 18% | 18% | 18% | 18% | 18% | 18% | 18% | 18% | 18% | 18% | 18% |
| R32 | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% |
| R1234zeE | 64% | 62% | 60% | 58% | 56% | 54% | 52% | 50% | 48% | 46% | 44% |
| GWP | 122 | 125 | 127 | 130 | 132 | 135 | 137 | 140 | 142 | 144 | 147 |
| Heating COP relative to R-290 | 98% | 98% | 98% | 99% | 99% | 99% | 99% | 100% | 100% | 100% | 100% |
| Cooling COP relative to R-290 | 99% | 99% | 100% | 100% | 101% | 101% | 102% | 102% | 102% | 103% | 103% |
| Heating Capacity relative to R-290 | 127% | 127% | 127% | 127% | 127% | 127% | 127% | 127% | 127% | 127% | 127% |
| Cooling Capacity relative to R-290 | 128% | 128% | 129% | 129% | 129% | 129% | 130% | 130% | 130% | 130% | 130% |
| Condensing Pressure (bar) | 28.0 | 27.9 | 27.8 | 27.7 | 27.6 | 27.5 | 27.4 | 27.3 | 27.2 | 27.1 | 27.0 |
| Evaporating Pressure (bar) | 6.1 | 6.1 | 6.0 | 6.0 | 6.0 | 6.0 | 6.0 | 6.0 | 5.9 | 5.9 | 5.9 |
| Average Glide (K) | 15.2 | 15.1 | 14.9 | 14.8 | 14.7 | 14.6 | 14.5 | 14.4 | 14.3 | 14.2 | 14.1 |

| | | | | | | | | |
|---|---|---|---|---|---|---|---|---|
| R1132a | 18% | 18% | 18% | 18% | 18% | 18% | 18% | 18% |
| R32 | 20% | 20% | 20% | 20% | 20% | 20% | 22% | 22% |
| R152a | 0% | 2% | 4% | 6% | 8% | 10% | 0% | 2% |
| R1234zeE | 62% | 60% | 58% | 56% | 54% | 52% | 61% | 59% |
| GWP | 136 | 138 | 141 | 143 | 146 | 148 | 146 | 148 |
| Heating COP relative to R-290 | 98% | 98% | 98% | 99% | 99% | 99% | 98% | 98% |
| Cooling COP relative to R-290 | 99% | 99% | 100% | 100% | 101% | 101% | 99% | 100% |
| Heating Capacity relative to R-290 | 130% | 130% | 130% | 130% | 130% | 130% | 133% | 133% |
| Cooling Capacity relative to R-290 | 132% | 132% | 132% | 133% | 133% | 133% | 135% | 135% |
| Condensing Pressure (bar) | 28.6 | 28.5 | 28.4 | 28.3 | 28.2 | 28.1 | 29.1 | 29.0 |
| Evaporating Pressure (bar) | 6.3 | 6.3 | 6.2 | 6.2 | 6.2 | 6.2 | 6.4 | 6.4 |
| Average Glide (K) | 15.0 | 14.9 | 14.8 | 14.6 | 14.5 | 14.4 | 14.8 | 14.7 |

TABLE 25
R-1132a/R-32/R-152a/R-1234ze(E) compositions comprising 20% by weight R-1132a

| R1132a | 20% | 20% | 20% | 20% | 20% | 20% | 20% | 20% | 20% | 20% | 20% | 20% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 68 | 71 | 73 | 76 | 78 | 81 | 83 | 86 | 88 | 91 | 93 | 95 |
| Heating COP relative to R-290 | 97% | 97% | 98% | 98% | 98% | 98% | 99% | 99% | 99% | 99% | 99% | 100% |
| Cooling COP relative to R-290 | 97% | 98% | 98% | 99% | 99% | 100% | 100% | 101% | 101% | 101% | 102% | 102% |
| Heating Capacity relative to R-290 | 116% | 116% | 116% | 117% | 117% | 117% | 117% | 117% | 117% | 118% | 118% | 118% |
| Cooling Capacity relative to R-290 | 116% | 117% | 117% | 118% | 118% | 119% | 119% | 119% | 120% | 120% | 120% | 121% |
| Condensing Pressure (bar) | 26.4 | 26.4 | 26.3 | 26.2 | 26.2 | 26.1 | 26.0 | 25.9 | 25.9 | 25.8 | 25.7 | 25.7 |
| Evaporating Pressure (bar) | 5.5 | 5.5 | 5.5 | 5.5 | 5.5 | 5.5 | 5.5 | 5.5 | 5.4 | 5.4 | 5.4 | 5.4 |
| Average Glide (K) | 16.0 | 15.8 | 15.7 | 15.5 | 15.4 | 15.3 | 15.2 | 15.1 | 15.0 | 14.8 | 14.7 | 14.7 |
| R1132a | 20% | 20% | 20% | 20% | 20% | 20% | 20% | 20% | 20% | 20% | 20% | 20% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 82 | 84 | 87 | 89 | 92 | 94 | 97 | 99 | 102 | 104 | 106 | 109 |
| Heating COP relative to R-290 | 97% | 97% | 98% | 98% | 98% | 98% | 99% | 99% | 99% | 99% | 99% | 100% |
| Cooling COP relative to R-290 | 98% | 98% | 98% | 99% | 99% | 100% | 100% | 101% | 101% | 101% | 102% | 102% |
| Heating Capacity relative to R-290 | 120% | 120% | 120% | 120% | 120% | 120% | 121% | 121% | 121% | 121% | 121% | 121% |
| Cooling Capacity relative to R-290 | 120% | 121% | 121% | 121% | 122% | 122% | 123% | 123% | 123% | 123% | 124% | 124% |
| Condensing Pressure (bar) | 27.1 | 27.1 | 27.0 | 26.9 | 26.8 | 26.7 | 26.6 | 26.6 | 26.5 | 26.4 | 26.3 | 26.2 |
| Evaporating Pressure (bar) | 5.7 | 5.7 | 5.7 | 5.7 | 5.7 | 5.7 | 5.6 | 5.6 | 5.6 | 5.6 | 5.6 | 5.6 |
| Average Glide (K) | 15.9 | 15.8 | 15.6 | 15.5 | 15.4 | 15.3 | 15.2 | 15.0 | 14.9 | 14.8 | 14.7 | 14.6 |

TABLE 26
R-1132a/R-32/R-152a/R-1234ze(E) compositions comprising 20% by weight R-1132a

| R1132a | 20% | 20% | 20% | 20% | 20% | 20% | 20% | 20% | 20% | 20% | 20% | 20% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 66% | 64% | 62% | 60% | 58% | 56% | 54% | 52% | 50% | 48% | 46% | 44% |
| GWP | 95 | 98 | 100 | 103 | 105 | 108 | 110 | 113 | 115 | 118 | 120 | 122 |
| Heating COP relative to R-290 | 97% | 97% | 98% | 98% | 98% | 98% | 99% | 99% | 99% | 99% | 99% | 100% |
| Cooling COP relative to R-290 | 98% | 98% | 98% | 99% | 99% | 100% | 100% | 101% | 101% | 101% | 102% | 102% |
| Heating Capacity relative to R-290 | 123% | 123% | 124% | 124% | 124% | 124% | 124% | 124% | 124% | 124% | 124% | 124% |
| Cooling Capacity relative to R-290 | 124% | 124% | 125% | 125% | 125% | 126% | 126% | 126% | 127% | 127% | 127% | 127% |
| Condensing Pressure (bar) | 27.8 | 27.7 | 27.6 | 27.5 | 27.4 | 27.3 | 27.2 | 27.1 | 27.1 | 27.0 | 26.9 | 26.8 |
| Evaporating Pressure (bar) | 5.9 | 5.9 | 5.9 | 5.9 | 5.9 | 5.8 | 5.8 | 5.8 | 5.8 | 5.8 | 5.8 | 5.8 |
| Average Glide (K) | 15.8 | 15.7 | 15.6 | 15.4 | 15.3 | 15.2 | 15.1 | 15.0 | 14.9 | 14.8 | 14.7 | 14.6 |
| R1132a | 20% | 20% | 20% | 20% | 20% | 20% | 20% | 20% | 20% | 20% | 20% | 20% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 64% | 62% | 60% | 58% | 56% | 54% | 52% | 50% | 48% | 46% | 44% | 42% |
| GWP | 109 | 111 | 114 | 116 | 119 | 121 | 124 | 126 | 129 | 131 | 133 | 136 |
| Heating COP relative to R-290 | 97% | 97% | 98% | 98% | 98% | 98% | 99% | 99% | 99% | 99% | 99% | 100% |
| Cooling COP relative to R-290 | 98% | 98% | 99% | 99% | 99% | 100% | 100% | 101% | 101% | 101% | 102% | 102% |
| Heating Capacity relative to R-290 | 127% | 127% | 127% | 127% | 127% | 127% | 127% | 128% | 128% | 128% | 128% | 128% |
| Cooling Capacity relative to R-290 | 128% | 128% | 128% | 129% | 129% | 129% | 130% | 130% | 130% | 130% | 130% | 131% |
| Condensing Pressure (bar) | 28.4 | 28.3 | 28.2 | 28.1 | 28.0 | 27.9 | 27.8 | 27.7 | 27.6 | 27.5 | 27.4 | 27.3 |
| Evaporating Pressure (bar) | 6.1 | 6.1 | 6.1 | 6.1 | 6.1 | 6.0 | 6.0 | 6.0 | 6.0 | 6.0 | 6.0 | 6.0 |
| Average Glide (K) | 15.7 | 15.6 | 15.4 | 15.3 | 15.2 | 15.1 | 15.0 | 14.9 | 14.8 | 14.7 | 14.6 | 14.5 |

TABLE 27
R-1132a/R-32/R-152a/R-1234ze(E) compositions comprising 20% by weight R-1132a

| | | | | | | | | | | | | |
|---|---|---|---|---|---|---|---|---|---|---|---|---|
| R1132a | 18% | 18% | 18% | 18% | 18% | 18% | 18% | 18% | 18% | 18% | 18% | 18% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 64% | 62% | 60% | 58% | 56% | 54% | 52% | 50% | 48% | 46% | 44% | 42% |
| GWP | 122 | 125 | 127 | 130 | 132 | 135 | 137 | 140 | 142 | 144 | 147 | 149 |
| Heating COP relative to R-290 | 98% | 98% | 98% | 99% | 99% | 99% | 99% | 100% | 100% | 100% | 100% | 100% |
| Cooling COP relative to R-290 | 99% | 99% | 100% | 100% | 101% | 101% | 102% | 102% | 102% | 103% | 103% | 103% |
| Heating Capacity relative to R-290 | 127% | 127% | 127% | 127% | 127% | 127% | 127% | 127% | 127% | 127% | 127% | 127% |
| Cooling Capacity relative to R-290 | 128% | 128% | 129% | 129% | 129% | 129% | 130% | 130% | 130% | 130% | 130% | 131% |
| Condensing Pressure (bar) | 28.0 | 27.9 | 27.8 | 27.7 | 27.6 | 27.5 | 27.4 | 27.3 | 27.2 | 27.1 | 27.0 | 26.9 |
| Evaporating Pressure (bar) | 6.1 | 6.1 | 6.0 | 6.0 | 6.0 | 6.0 | 6.0 | 6.0 | 5.9 | 5.9 | 5.9 | 5.9 |
| Average Glide (K) | 15.2 | 15.1 | 14.9 | 14.8 | 14.7 | 14.6 | 14.5 | 14.4 | 14.3 | 14.2 | 14.1 | 14.0 |

| | | | | | | | | |
|---|---|---|---|---|---|---|---|---|
| R1132a | 20% | 20% | 20% | 20% | 20% | 20% | 20% | 20% |
| R32 | 20% | 20% | 20% | 20% | 20% | 20% | 20% | 20% |
| R152a | 0% | 2% | 4% | 6% | 8% | 10% | 0% | 2% |
| R1234zeE | 60% | 58% | 56% | 54% | 52% | 50% | 59% | 57% |
| GWP | 136% | 138% | 141% | 143% | 146% | 148% | 146% | 148% |
| Heating COP relative to R-290 | 97% | 97% | 98% | 98% | 98% | 98% | 97% | 97% |
| Cooling COP relative to R-290 | 98% | 98% | 99% | 99% | 100% | 100% | 98% | 98% |
| Heating Capacity relative to R-290 | 134% | 134% | 134% | 134% | 134% | 134% | 137% | 137% |
| Cooling Capacity relative to R-290 | 135% | 136% | 136% | 136% | 136% | 136% | 138% | 138% |
| Condensing Pressure (bar) | 29.7 | 29.6 | 29.5 | 29.3 | 29.2 | 29.1 | 30.1 | 30.0 |
| Evaporating Pressure (bar) | 6.5 | 6.5 | 6.5 | 6.5 | 6.5 | 6.4 | 6.7 | 6.7 |
| Average Glide (K) | 15.3 | 15.1 | 15.0 | 14.9 | 14.8 | 14.7 | 15.0 | 14.9 |

TABLE 28
compositions comprising 4% by weight
R-1132a and 4% by weight CO₂

| | |
|---|---|
| CO₂ | 4% |
| R1132a | 4% |
| R32 | 18% |
| R152a | 16% |
| R1234zeE | 58% |
| GWP | 142 |
| Heating COP relative to R-290 | 103% |
| Cooling COP relative to R-290 | 108% |
| Heating Capacity relative to R-290 | 113% |
| Cooling Capacity relative to R-290 | 118% |
| Condensing Pressure (bar) | 23.6 |
| Evaporating Pressure (bar) | 5.0 |
| Average Glide (K) | 12.8 |

TABLE 29
R-1132a/R-32/R-152a/R-1234ze(E) compositions comprising 4% by weight R-1132a

| R1132a | 4% | 4% | 4% | 4% | 4% | 4% | 4% | 4% | 4% | 4% | 4% | 4% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 86% | 84% | 82% | 80% | 78% | 76% | 74% | 72% | 70% | 68% | 66% | 64% |
| GWP | 68 | 71 | 73 | 76 | 78 | 81 | 83 | 86 | 88 | 91 | 93 | 95 |
| Heating COP relative to R-290 | 102% | 102% | 102% | 103% | 103% | 103% | 103% | 104% | 104% | 104% | 104% | 104% |
| Cooling COP relative to R-290 | 105% | 106% | 107% | 107% | 108% | 109% | 109% | 110% | 110% | 111% | 111% | 112% |
| Heating Capacity relative to R-290 | 70% | 71% | 71% | 71% | 72% | 72% | 73% | 73% | 73% | 74% | 74% | 75% |
| Cooling Capacity relative to R-290 | 73% | 73% | 74% | 75% | 75% | 76% | 77% | 77% | 78% | 79% | 79% | 80% |
| Condensing Pressure (bar) | 20.3 | 20.2 | 20.2 | 20.2 | 20.2 | 20.2 | 20.2 | 20.2 | 20.2 | 20.1 | 20.1 | 20.1 |
| Evaporating Pressure (bar) | 1.4 | 1.4 | 1.4 | 1.4 | 1.4 | 1.4 | 1.4 | 1.4 | 1.4 | 1.4 | 1.4 | 1.4 |
| Average Glide (K) | 7.4 | 7.3 | 7.2 | 7.1 | 7.0 | 6.9 | 6.8 | 6.7 | 6.6 | 6.5 | 6.4 | 6.3 |
| R1132a | 4% | 4% | 4% | 4% | 4% | 4% | 4% | 4% | 4% | 4% | 4% | 4% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 84% | 82% | 80% | 78% | 76% | 74% | 72% | 70% | 68% | 66% | 64% | 62% |
| GWP | 82 | 84 | 87 | 89 | 92 | 94 | 97 | 99 | 102 | 104 | 106 | 109 |
| Heating COP relative to R-290 | 102% | 102% | 102% | 103% | 103% | 103% | 103% | 104% | 104% | 104% | 104% | 105% |
| Cooling COP relative to R-290 | 106% | 107% | 107% | 108% | 108% | 109% | 110% | 110% | 111% | 111% | 112% | 112% |
| Heating Capacity relative to R-290 | 74% | 74% | 74% | 75% | 75% | 76% | 76% | 76% | 77% | 77% | 77% | 78% |
| Cooling Capacity relative to R-290 | 77% | 77% | 78% | 78% | 79% | 80% | 80% | 81% | 81% | 82% | 83% | 83% |
| Condensing Pressure (bar) | 20.9 | 20.9 | 20.9 | 20.9 | 20.9 | 20.9 | 20.8 | 20.8 | 20.8 | 20.8 | 20.7 | 20.7 |
| Evaporating Pressure (bar) | 1.4 | 1.4 | 1.4 | 1.4 | 1.5 | 1.5 | 1.5 | 1.5 | 1.5 | 1.5 | 1.5 | 1.5 |
| Average Glide (K) | 7.9 | 7.7 | 7.6 | 7.5 | 7.4 | 7.3 | 7.2 | 7.0 | 6.9 | 6.8 | 6.7 | 6.6 |

TABLE 30
R-1132a/R-32/R-152a/R-1234ze(E) compositions comprising 4% by weight R-1132a

| R1132a | 4% | 4% | 4% | 4% | 4% | 4% | 4% | 4% | 4% | 4% | 4% | 4% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 95 | 98 | 100 | 103 | 105 | 108 | 110 | 113 | 115 | 118 | 120 | 122 |
| Heating COP relative to R-290 | 102% | 102% | 103% | 103% | 103% | 103% | 104% | 104% | 104% | 104% | 105% | 105% |
| Cooling COP relative to R-290 | 107% | 107% | 108% | 108% | 109% | 109% | 110% | 111% | 111% | 112% | 112% | 113% |
| Heating Capacity relative to R-290 | 77% | 77% | 78% | 78% | 78% | 79% | 79% | 79% | 80% | 80% | 80% | 81% |
| Cooling Capacity relative to R-290 | 80% | 81% | 82% | 82% | 83% | 83% | 84% | 85% | 85% | 86% | 86% | 87% |
| Condensing Pressure (bar) | 21.6 | 21.6 | 21.6 | 21.6 | 21.5 | 21.5 | 21.5 | 21.4 | 21.4 | 21.4 | 21.3 | 21.3 |
| Evaporating Pressure (bar) | 1.5 | 1.5 | 1.5 | 1.5 | 1.5 | 1.5 | 1.5 | 1.5 | 1.5 | 1.5 | 1.5 | 1.5 |
| Average Glide (K) | 8.3 | 8.1 | 8.0 | 7.9 | 7.7 | 7.6 | 7.5 | 7.4 | 7.3 | 7.2 | 7.1 | 7.0 |
| R1132a | 4% | 4% | 4% | 4% | 4% | 4% | 4% | 4% | 4% | 4% | 4% | 4% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 109 | 111 | 114 | 116 | 119 | 121 | 124 | 126 | 129 | 131 | 133 | 136 |
| Heating COP relative to R-290 | 102% | 103% | 103% | 103% | 103% | 104% | 104% | 104% | 104% | 104% | 105% | 105% |
| Cooling COP relative to R-290 | 107% | 108% | 108% | 109% | 109% | 110% | 110% | 111% | 111% | 112% | 112% | 113% |
| Heating Capacity relative to R-290 | 81% | 81% | 81% | 81% | 82% | 82% | 82% | 83% | 83% | 83% | 83% | 84% |
| Cooling Capacity relative to R-290 | 84% | 85% | 85% | 86% | 87% | 87% | 88% | 88% | 89% | 89% | 90% | 90% |
| Condensing Pressure (bar) | 22.3 | 22.3 | 22.2 | 22.2 | 22.2 | 22.1 | 22.1 | 22.0 | 22.0 | 22.0 | 21.9 | 21.9 |
| Evaporating Pressure (bar) | 1.6 | 1.6 | 1.6 | 1.6 | 1.6 | 1.6 | 1.6 | 1.6 | 1.6 | 1.6 | 1.6 | 1.6 |
| Average Glide (K) | 8.6 | 8.4 | 8.3 | 8.1 | 8.0 | 7.9 | 7.8 | 7.7 | 7.5 | 7.4 | 7.3 | 7.2 |

TABLE 31
R-1132a/R-32/R-152a/R-1234ze(E) compositions comprising 4% by weight R-1132a

| | | | | | | | | | | | | |
|---|---|---|---|---|---|---|---|---|---|---|---|---|
| R1132a | 4% | 4% | 4% | 4% | 4% | 4% | 4% | 4% | 4% | 4% | 4% | 4% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 122 | 125 | 127 | 130 | 132 | 135 | 137 | 140 | 142 | 144 | 147 | 149 |
| Heating COP relative to R-290 | 102% | 103% | 103% | 103% | 103% | 104% | 104% | 104% | 104% | 105% | 105% | 105% |
| Cooling COP relative to R-290 | 107% | 108% | 109% | 109% | 110% | 110% | 111% | 111% | 112% | 112% | 113% | 113% |
| Heating Capacity relative to R-290 | 84% | 84% | 85% | 85% | 85% | 85% | 86% | 86% | 86% | 86% | 87% | 87% |
| Cooling Capacity relative to R-290 | 88% | 89% | 89% | 90% | 90% | 91% | 91% | 92% | 92% | 93% | 93% | 94% |
| Condensing Pressure (bar) | 23.0 | 22.9 | 22.9 | 22.8 | 22.8 | 22.7 | 22.7 | 22.6 | 22.6 | 22.5 | 22.5 | 22.4 |
| Evaporating Pressure (bar) | 1.6 | 1.6 | 1.6 | 1.6 | 1.6 | 1.6 | 1.6 | 1.6 | 1.6 | 1.6 | 1.6 | 1.6 |
| Average Glide (K) | 8.8 | 8.7 | 8.5 | 8.4 | 8.2 | 8.1 | 8.0 | 7.9 | 7.8 | 7.6 | 7.5 | 7.4 |

| | | | | | | |
|---|---|---|---|---|---|---|
| R1132a | 4% | 4% | 4% | 4% | 4% | 4% |
| R32 | 20% | 20% | 20% | 20% | 20% | 20% |
| R152a | 0% | 2% | 4% | 6% | 8% | 10% |
| R1234zeE | 76% | 74% | 72% | 70% | 68% | 66% |
| GWP | 136 | 138 | 141 | 143 | 146 | 148 |
| Heating COP relative to R-290 | 103% | 103% | 103% | 103% | 104% | 104% |
| Cooling COP relative to R-290 | 108% | 108% | 109% | 1019% | 110% | 111% |
| Heating Capacity relative to R-290 | 88% | 88% | 88% | 88% | 89% | 89% |
| Cooling Capacity relative to R-290 | 92% | 93% | 93% | 94% | 94% | 95% |
| Condensing Pressure (bar) | 23.6 | 23.6 | 23.5 | 23.5 | 23.4 | 23.3 |
| Evaporating Pressure (bar) | 1.7 | 1.7 | 1.7 | 1.7 | 1.7 | 1.7 |
| Average Glide (K) | 9.0 | 8.9 | 8.7 | 8.6 | 8.4 | 8.3 |

TABLE 32
R-1132a/R-32/R-152a/R-1234ze(E) compositions comprising 6% by weight R-1132a

| R1132a | 6% | 6% | 6% | 6% | 6% | 6% | 6% | 6% | 6% | 6% | 6% | 6% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 84% | 82% | 80% | 78% | 76% | 74% | 72% | 70% | 68% | 66% | 64% | 62% |
| GWP | 68 | 71 | 73 | 76 | 78 | 81 | 83 | 86 | 88 | 91 | 93 | 95 |
| Heating COP relative to R-290 | 101% | 102% | 102% | 102% | 102% | 103% | 103% | 103% | 103% | 104% | 104% | 104% |
| Cooling COP relative to R-290 | 105% | 105% | 106% | 106% | 107% | 108% | 108% | 109% | 109% | 110% | 111% | 111% |
| Heating Capacity relative to R-290 | 74% | 74% | 74% | 75% | 75% | 76% | 76% | 76% | 77% | 77% | 78% | 78% |
| Cooling Capacity relative to R-290 | 76% | 77% | 77% | 78% | 79% | 79% | 80% | 81% | 81% | 82% | 83% | 83% |
| Condensing Pressure (bar) | 21.3 | 21.3 | 21.3 | 21.3 | 21.3 | 21.2 | 21.2 | 21.2 | 21.2 | 21.2 | 21.1 | 21.1 |
| Evaporating Pressure (bar) | 1.4 | 1.4 | 1.4 | 1.5 | 1.5 | 1.5 | 1.5 | 1.5 | 1.5 | 1.5 | 1.5 | 1.5 |
| Average Glide (K) | 8.5 | 8.4 | 8.3 | 8.1 | 8.0 | 7.9 | 7.8 | 7.7 | 7.6 | 7.5 | 7.4 | 7.3 |
| R1132a | 6% | 6% | 6% | 6% | 6% | 6% | 6% | 6% | 6% | 6% | 6% | 6% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 82 | 84 | 87 | 89 | 92 | 94 | 97 | 99 | 102 | 104 | 106 | 109 |
| Heating COP relative to R-290 | 101% | 102% | 102% | 102% | 103% | 103% | 103% | 103% | 103% | 104% | 104% | 104% |
| Cooling COP relative to R-290 | 105% | 106% | 106% | 107% | 108% | 108% | 109% | 109% | 110% | 110% | 111% | 111% |
| Heating Capacity relative to R-290 | 77% | 77% | 78% | 78% | 79% | 79% | 79% | 80% | 80% | 80% | 81% | 81% |
| Cooling Capacity relative to R-290 | 80% | 80% | 81% | 82% | 82% | 83% | 84% | 84% | 85% | 85% | 86% | 86% |
| Condensing Pressure (bar) | 22.0 | 22.0 | 22.0 | 22.0 | 21.9 | 21.9 | 21.9 | 21.8 | 21.8 | 21.8 | 21.7 | 21.7 |
| Evaporating Pressure (bar) | 1.5 | 1.5 | 1.5 | 1.5 | 1.5 | 1.5 | 1.5 | 1.5 | 1.5 | 1.5 | 1.5 | 1.5 |
| Average Glide (K) | 8.9 | 8.8 | 8.6 | 8.5 | 8.4 | 8.3 | 8.2 | 8.1 | 7.9 | 7.8 | 7.7 | 7.7 |

TABLE 33
R-1132a/R-32/R-152a/R-1234ze(E) compositions comprising 6% by weight R-1132a

| R1132a | 6% | 6% | 6% | 6% | 6% | 6% | 6% | 6% | 6% | 6% | 6% | 6% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 95 | 98 | 100 | 103 | 105 | 108 | 110 | 113 | 115 | 118 | 120 | 122 |
| Heating COP relative to R-290 | 102% | 102% | 102% | 102% | 103% | 103% | 103% | 103% | 104% | 104% | 104% | 104% |
| Cooling COP relative to R-290 | 105% | 106% | 107% | 107% | 108% | 108% | 109% | 110% | 110% | 111% | 111% | 112% |
| Heating Capacity relative to R-290 | 81% | 81% | 81% | 82% | 82% | 82% | 83% | 83% | 83% | 83% | 84% | 84% |
| Cooling Capacity relative to R-290 | 84% | 84% | 85% | 86% | 86% | 87% | 87% | 88% | 88% | 89% | 89% | 90% |
| Condensing Pressure (bar) | 22.7 | 22.7 | 22.7 | 22.6 | 22.6 | 22.5 | 22.5 | 22.5 | 22.4 | 22.4 | 22.3 | 22.3 |
| Evaporating Pressure (bar) | 1.6 | 1.6 | 1.6 | 1.6 | 1.6 | 1.6 | 1.6 | 1.6 | 1.6 | 1.6 | 1.6 | 1.6 |
| Average Glide (K) | 9.2 | 9.1 | 8.9 | 8.8 | 8.7 | 8.6 | 8.4 | 8.3 | 8.2 | 8.1 | 8.0 | 7.9 |
| R1132a | 6% | 6% | 6% | 6% | 6% | 6% | 6% | 6% | 6% | 6% | 6% | 6% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 109 | 111 | 114 | 116 | 119 | 121 | 124 | 126 | 129 | 131 | 133 | 136 |
| Heating COP relative to R-290 | 102% | 102% | 102% | 103% | 103% | 103% | 103% | 104% | 104% | 104% | 104% | 104% |
| Cooling COP relative to R-290 | 106% | 106% | 107% | 108% | 108% | 109% | 109% | 110% | 110% | 111% | 111% | 112% |
| Heating Capacity relative to R-290 | 84% | 84% | 85% | 85% | 85% | 86% | 86% | 86% | 86% | 87% | 87% | 87% |
| Cooling Capacity relative to R-290 | 88% | 88% | 89% | 89% | 90% | 91% | 91% | 92% | 92% | 93% | 93% | 94% |
| Condensing Pressure (bar) | 23.4 | 23.4 | 23.3 | 23.3 | 23.2 | 23.2 | 23.1 | 23.1 | 23.0 | 23.0 | 22.9 | 22.9 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 9.5 | 9.3 | 9.2 | 9.0 | 8.9 | 8.8 | 8.7 | 8.6 | 8.4 | 8.3 | 8.2 | 8.1 |

TABLE 34
R-1132a/R-32/R-152a/R-1234ze(E) compositions comprising 6% by weight R-1132a

| | | | | | | | | | | | | |
|---|---|---|---|---|---|---|---|---|---|---|---|---|
| R1132a | 6% | 6% | 6% | 6% | 6% | 6% | 6% | 6% | 6% | 6% | 6% | 6% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 122 | 125 | 127 | 130 | 132 | 135 | 137 | 140 | 142 | 144 | 147 | 149 |
| Heating COP relative to R-290 | 102% | 102% | 102% | 103% | 103% | 103% | 103% | 104% | 104% | 104% | 104% | 105% |
| Cooling COP relative to R-290 | 106% | 107% | 107% | 108% | 109% | 109% | 110% | 110% | 111% | 111% | 112% | 112% |
| Heating Capacity relative to R-290 | 88% | 88% | 88% | 89% | 89% | 89% | 89% | 90% | 90% | 90% | 90% | 90% |
| Cooling Capacity relative to R-290 | 92% | 92% | 93% | 93% | 94% | 94% | 95% | 95% | 96% | 96% | 97% | 97% |
| Condensing Pressure (bar) | 24.1 | 24.0 | 24.0 | 23.9 | 23.9 | 23.8 | 23.7 | 23.7 | 23.6 | 23.5 | 23.5 | 23.4 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 9.7 | 9.5 | 9.4 | 9.2 | 9.1 | 9.0 | 8.9 | 8.7 | 8.6 | 8.5 | 8.4 | 8.3 |

| | | | | | | |
|---|---|---|---|---|---|---|
| R1132a | 6% | 6% | 6% | 6% | 6% | 6% |
| R32 | 20% | 20% | 20% | 20% | 20% | 20% |
| R152a | 0% | 2% | 4% | 6% | 8% | 10% |
| R1234zeE | 74% | 72% | 70% | 68% | 66% | 64% |
| GWP | 136 | 138 | 141 | 143 | 146 | 148 |
| Heating COP relative to R-290 | 102% | 102% | 102% | 103% | 103% | 103% |
| Cooling COP relative to R-290 | 107% | 107% | 108% | 108% | 109% | 110% |
| Heating Capacity relative to R-290 | 91% | 92% | 92% | 92% | 92% | 93% |
| Cooling Capacity relative to R-290 | 95% | 96% | 97% | 97% | 98% | 98% |
| Condensing Pressure (bar) | 24.7 | 24.7 | 24.6 | 24.5 | 24.5 | 24.4 |
| Evaporating Pressure (bar) | 1.8 | 1.8 | 1.8 | 1.8 | 1.8 | 1.8 |
| Average Glide (K) | 9.8 | 9.6 | 9.5 | 9.4 | 9.2 | 9.1 |

TABLE 35
R-1132a/R-32/R-152a/R-1234ze(E) compositions comprising 8% by weight R-1132a

| R1132a | 8% | 8% | 8% | 8% | 8% | 8% | 8% | 8% | 8% | 8% | 8% | 8% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 82% | 80% | 78% | 76% | 74% | 72% | 70% | 68% | 66% | 64% | 62% | 60% |
| GWP | 68 | 71 | 73 | 76 | 78 | 81 | 83 | 86 | 88 | 91 | 93 | 95 |
| Heating COP relative to R-290 | 101% | 101% | 101% | 102% | 102% | 102% | 102% | 103% | 103% | 103% | 103% | 104% |
| Cooling COP relative to R-290 | 104% | 104% | 105% | 105% | 106% | 107% | 107% | 108% | 108% | 109% | 109% | 110% |
| Heating Capacity relative to R-290 | 77% | 77% | 78% | 78% | 79% | 79% | 79% | 80% | 80% | 80% | 81% | 81% |
| Cooling Capacity relative to R-290 | 79% | 80% | 81% | 81% | 82% | 83% | 83% | 84% | 84% | 85% | 86% | 86% |
| Condensing Pressure (bar) | 22.4 | 22.4 | 22.4 | 22.4 | 22.3 | 22.3 | 22.3 | 22.2 | 22.2 | 22.2 | 22.1 | 22.1 |
| Evaporating Pressure (bar) | 1.5 | 1.5 | 1.5 | 1.5 | 1.5 | 1.5 | 1.5 | 1.5 | 1.5 | 1.5 | 1.5 | 1.5 |
| Average Glide (K) | 9.5 | 9.3 | 9.2 | 9.1 | 9.0 | 8.9 | 8.8 | 8.7 | 8.6 | 8.5 | 8.4 | 8.3 |
| R1132a | 8% | 8% | 8% | 8% | 8% | 8% | 8% | 8% | 8% | 8% | 8% | 8% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 82 | 84 | 87 | 89 | 92 | 94 | 97 | 99 | 102 | 104 | 106 | 109 |
| Heating COP relative to R-290 | 101% | 101% | 101% | 102% | 102% | 102% | 102% | 103% | 103% | 103% | 103% | 104% |
| Cooling COP relative to R-290 | 104% | 105% | 105% | 106% | 106% | 107% | 108% | 108% | 109% | 109% | 110% | 110% |
| Heating Capacity relative to R-290 | 81% | 81% | 81% | 82% | 82% | 82% | 83% | 83% | 83% | 84% | 84% | 84% |
| Cooling Capacity relative to R-290 | 83% | 84% | 84% | 85% | 86% | 86% | 87% | 87% | 88% | 89% | 89% | 90% |
| Condensing Pressure (bar) | 23.1 | 23.1 | 23.1 | 23.0 | 23.0 | 23.0 | 22.9 | 22.9 | 22.8 | 22.8 | 22.8 | 22.7 |
| Evaporating Pressure (bar) | 1.6 | 1.6 | 1.6 | 1.6 | 1.6 | 1.6 | 1.6 | 1.6 | 1.6 | 1.6 | 1.6 | 1.6 |
| Average Glide (K) | 9.8 | 9.6 | 9.5 | 9.4 | 9.3 | 9.2 | 9.1 | 8.9 | 8.8 | 8.7 | 8.6 | 8.6 |

TABLE 36
R-1132a/R-32/R-152a/R-1234ze(E) compositions comprising 8% by weight R-1132a

| R1132a | 8% | 8% | 8% | 8% | 8% | 8% | 8% | 8% | 8% | 8% | 8% | 8% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 95 | 98 | 100 | 103 | 105 | 108 | 110 | 113 | 115 | 118 | 120 | 122 |
| Heating COP relative to R-290 | 101% | 101% | 102% | 102% | 102% | 102% | 103% | 103% | 103% | 103% | 104% | 104% |
| Cooling COP relative to R-290 | 104% | 105% | 106% | 106% | 107% | 107% | 108% | 109% | 109% | 110% | 110% | 111% |
| Heating Capacity relative to R-290 | 84% | 85% | 85% | 85% | 86% | 86% | 86% | 86% | 87% | 87% | 87% | 87% |
| Cooling Capacity relative to R-290 | 87% | 88% | 88% | 89% | 89% | 90% | 91% | 91% | 92% | 92% | 93% | 93% |
| Condensing Pressure (bar) | 23.8 | 23.8 | 23.8 | 23.7 | 23.7 | 23.6 | 23.6 | 23.5 | 23.5 | 23.4 | 23.4 | 23.3 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 10.0 | 9.9 | 9.8 | 9.6 | 9.5 | 9.4 | 9.3 | 9.2 | 9.1 | 9.0 | 8.9 | 8.8 |
| R1132a | 8% | 8% | 8% | 8% | 8% | 8% | 8% | 8% | 8% | 8% | 8% | 8% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 109 | 111 | 114 | 116 | 119 | 121 | 124 | 126 | 129 | 131 | 133 | 136 |
| Heating COP relative to R-290 | 101% | 101% | 102% | 102% | 102% | 102% | 103% | 103% | 103% | 103% | 104% | 104% |
| Cooling COP relative to R-290 | 105% | 105% | 106% | 106% | 107% | 108% | 108% | 109% | 109% | 110% | 110% | 111% |
| Heating Capacity relative to R-290 | 88% | 88% | 88% | 89% | 89% | 89% | 90% | 90% | 90% | 90% | 91% | 91% |
| Cooling Capacity relative to R-290 | 91% | 91% | 92% | 93% | 93% | 94% | 94% | 95% | 95% | 96% | 96% | 97% |
| Condensing Pressure (bar) | 24.5 | 24.5 | 24.4 | 24.4 | 24.3 | 24.2 | 24.2 | 24.1 | 24.1 | 24.0 | 24.0 | 23.9 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 10.2 | 10.1 | 10.0 | 9.8 | 9.7 | 9.6 | 9.5 | 9.4 | 9.2 | 9.1 | 9.0 | 8.9 |

TABLE 37
R-1132a/R-32/R-152a/R-1234ze(E) compositions comprising 8% by weight R-1132a

| | | | | | | | | | | | | |
|---|---|---|---|---|---|---|---|---|---|---|---|---|
| R1132a | 8% | 8% | 8% | 8% | 8% | 8% | 8% | 8% | 8% | 8% | 8% | 8% |
| R32 | 18% | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 122 | 125 | 127 | 130 | 132 | 135 | 137 | 140 | 142 | 144 | 147 | 149 |
| Heating COP relative to R-290 | 101% | 101% | 102% | 102% | 102% | 103% | 103% | 103% | 103% | 104% | 104% | 104% |
| Cooling COP relative to R-290 | 105% | 106% | 106% | 107% | 107% | 108% | 109% | 109% | 110% | 110% | 111% | 111% |
| Heating Capacity relative to R-290 | 91% | 92% | 92% | 92% | 93% | 93% | 93% | 93% | 93% | 94% | 94% | 94% |
| Cooling Capacity relative to R-290 | 95% | 95% | 96% | 97% | 97% | 98% | 98% | 99% | 99% | 100% | 100% | 100% |
| Condensing Pressure (bar) | 25.2 | 25.2 | 25.1 | 25.0 | 24.9 | 24.9 | 24.8 | 24.7 | 24.7 | 24.6 | 24.5 | 24.5 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 10.4 | 10.2 | 10.1 | 10.0 | 9.8 | 9.7 | 9.6 | 9.5 | 9.4 | 9.3 | 9.2 | 9.1 |

| | | | | | | |
|---|---|---|---|---|---|---|
| R1132a | 8% | 8% | 8% | 8% | 8% | 8% |
| R32 | 20% | 20% | 20% | 20% | 20% | 20% |
| R152a | 0% | 2% | 4% | 6% | 8% | 10% |
| R1234zeE | 72% | 70% | 68% | 66% | 64% | 62% |
| GWP | 136 | 138 | 141 | 143 | 146 | 148 |
| Heating COP relative to R-290 | 101% | 102% | 102% | 102% | 102% | 103% |
| Cooling COP relative to R-290 | 105% | 106% | 107% | 107% | 108% | 108% |
| Heating Capacity relative to R-290 | 95% | 95% | 96% | 96% | 96% | 96% |
| Cooling Capacity relative to R-290 | 99% | 99% | 100% | 101% | 101% | 102% |
| Condensing Pressure (bar) | 25.9 | 25.8 | 25.7 | 25.6 | 25.5 | 25.5 |
| Evaporating Pressure (bar) | 1.9 | 1.9 | 1.9 | 1.9 | 1.9 | 1.9 |
| Average Glide (K) | 10.5 | 10.3 | 10.2 | 10.1 | 9.9 | 9.8 |

TABLE 38
R-1132a/R-32/R-152a/R-1234ze(E) compositions comprising 10% by weight R-1132a

| R1132a | 10% | 10% | 10% | 10% | 10% | 10% | 10% | 10% | 10% | 10% | 10% | 10% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 80% | 78% | 76% | 74% | 72% | 70% | 68% | 66% | 64% | 62% | 60% | 58% |
| GWP | 68 | 71 | 73 | 76 | 78 | 81 | 83 | 86 | 88 | 91 | 93 | 95 |
| Heating COP relative to R-290 | 100% | 100% | 101% | 101% | 101% | 101% | 102% | 102% | 102% | 103% | 103% | 103% |
| Cooling COP relative to R-290 | 102% | 103% | 104% | 104% | 105% | 106% | 106% | 107% | 107% | 108% | 108% | 109% |
| Heating Capacity relative to R-290 | 80% | 81% | 81% | 82% | 82% | 82% | 83% | 83% | 84% | 84% | 84% | 84% |
| Cooling Capacity relative to R-290 | 82% | 83% | 84% | 84% | 85% | 86% | 86% | 87% | 88% | 88% | 89% | 89% |
| Condensing Pressure (bar) | 23.5 | 23.5 | 23.5 | 23.4 | 23.4 | 23.4 | 23.3 | 23.3 | 23.3 | 23.2 | 23.2 | 23.1 |
| Evaporating Pressure (bar) | 1.6 | 1.6 | 1.6 | 1.6 | 1.6 | 1.6 | 1.6 | 1.6 | 1.6 | 1.6 | 1.6 | 1.6 |
| Average Glide (K) | 10.3 | 10.2 | 10.0 | 9.9 | 9.8 | 9.7 | 9.6 | 9.5 | 9.4 | 9.3 | 9.2 | 9.1 |
| R1132a | 10% | 10% | 10% | 10% | 10% | 10% | 10% | 10% | 10% | 10% | 10% | 10% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 82 | 84 | 87 | 89 | 92 | 94 | 97 | 99 | 102 | 104 | 106 | 109 |
| Heating COP relative to R-290 | 100% | 101% | 101% | 101% | 101% | 102% | 102% | 102% | 102% | 103% | 103% | 103% |
| Cooling COP relative to R-290 | 103% | 103% | 104% | 105% | 105% | 106% | 106% | 107% | 108% | 108% | 109% | 109% |
| Heating Capacity relative to R-290 | 84% | 85% | 85% | 85% | 86% | 86% | 86% | 87% | 87% | 87% | 87% | 88% |
| Cooling Capacity relative to R-290 | 86% | 87% | 88% | 88% | 89% | 90% | 90% | 91% | 91% | 92% | 92% | 93% |
| Condensing Pressure (bar) | 24.2 | 24.2 | 24.2 | 24.1 | 24.1 | 24.0 | 24.0 | 23.9 | 23.9 | 23.8 | 23.8 | 23.7 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 10.5 | 10.4 | 10.3 | 10.2 | 10.1 | 9.9 | 9.8 | 9.7 | 9.6 | 9.5 | 9.4 | 9.3 |

TABLE 39
R-1132a/R-32/R-152a/R-1234ze(E) compositions comprising 10% by weight R-1132a

| R1132a | 10% | 10% | 10% | 10% | 10% | 10% | 10% | 10% | 10% | 10% | 10% | 10% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 95 | 98 | 100 | 103 | 105 | 108 | 110 | 113 | 115 | 118 | 120 | 122 |
| Heating COP relative to R-290 | 100% | 101% | 101% | 101% | 101% | 102% | 102% | 102% | 102% | 103% | 103% | 103% |
| Cooling COP relative to R-290 | 103% | 104% | 104% | 105% | 106% | 106% | 107% | 107% | 108% | 108% | 109% | 110% |
| Heating Capacity relative to R-290 | 88% | 88% | 89% | 89% | 89% | 89% | 90% | 90% | 90% | 91% | 91% | 91% |
| Cooling Capacity relative to R-290 | 90% | 91% | 92% | 92% | 93% | 93% | 94% | 95% | 95% | 96% | 96% | 97% |
| Condensing Pressure (bar) | 25.0 | 24.9 | 24.9 | 24.8 | 24.8 | 24.7 | 24.6 | 24.6 | 24.5 | 24.4 | 24.4 | 24.3 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 10.8 | 10.6 | 10.5 | 10.4 | 10.2 | 10.1 | 10.0 | 9.9 | 9.8 | 9.7 | 9.6 | 9.5 |
| R1132a | 10% | 10% | 10% | 10% | 10% | 10% | 10% | 10% | 10% | 10% | 10% | 10% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 109 | 111 | 114 | 116 | 119 | 121 | 124 | 126 | 129 | 131 | 133 | 136 |
| Heating COP relative to R-290 | 101% | 101% | 101% | 101% | 102% | 102% | 102% | 102% | 103% | 103% | 103% | 103% |
| Cooling COP relative to R-290 | 103% | 104% | 105% | 105% | 106% | 107% | 107% | 108% | 108% | 109% | 109% | 110% |
| Heating Capacity relative to R-290 | 92% | 92% | 92% | 92% | 93% | 93% | 93% | 93% | 94% | 94% | 94% | 94% |
| Cooling Capacity relative to R-290 | 94% | 95% | 95% | 96% | 97% | 97% | 98% | 98% | 99% | 99% | 100% | 100% |
| Condensing Pressure (bar) | 25.7 | 25.6 | 25.5 | 25.5 | 25.4 | 25.3 | 25.3 | 25.2 | 25.1 | 25.1 | 25.0 | 24.9 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 10.9 | 10.8 | 10.6 | 10.5 | 10.4 | 10.3 | 10.2 | 10.1 | 10.0 | 9.8 | 9.8 | 9.7 |

TABLE 40
R-1132a/R-32/R-152a/R-1234ze(E) compositions comprising 10% by weight R-1132a

| | | | | | | | | | | | |
|---|---|---|---|---|---|---|---|---|---|---|---|
| R1132a | 10% | 10% | 10% | 10% | 10% | 10% | 10% | 10% | 10% | 10% | 10% |
| R32 | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% |
| R1234zeE | 72% | 70% | 68% | 66% | 64% | 62% | 60% | 58% | 56% | 54% | 52% |
| GWP | 122 | 125 | 127 | 130 | 132 | 135 | 137 | 140 | 142 | 144 | 147 |
| Heating COP relative to R-290 | 101% | 101% | 101% | 101% | 102% | 102% | 102% | 102% | 103% | 103% | 103% |
| Cooling COP relative to R-290 | 104% | 104% | 105% | 106% | 106% | 107% | 107% | 108% | 108% | 109% | 109% |
| Heating Capacity relative to R-290 | 95% | 96% | 96% | 96% | 96% | 96% | 97% | 97% | 97% | 97% | 97% |
| Cooling Capacity relative to R-290 | 98% | 99% | 99% | 100% | 101% | 101% | 102% | 102% | 103% | 103% | 103% |
| Condensing Pressure (bar) | 26.3 | 26.3 | 26.2 | 26.1 | 26.0 | 25.9 | 25.9 | 25.8 | 25.7 | 25.6 | 25.6 |
| Evaporating Pressure (bar) | 1.9 | 1.9 | 1.9 | 1.9 | 1.9 | 1.9 | 1.9 | 1.9 | 1.9 | 1.9 | 1.9 |
| Average Glide (K) | 11.0 | 10.9 | 10.7 | 10.6 | 10.5 | 10.4 | 10.3 | 10.2 | 10.0 | 9.9 | 9.8 |

| | | | | | | | | |
|---|---|---|---|---|---|---|---|---|
| R1132a | 10% | 10% | 10% | 10% | 10% | 10% | 10% | 10% |
| R32 | 20% | 20% | 20% | 20% | 20% | 20% | 22% | 22% |
| R152a | 0% | 2% | 4% | 6% | 8% | 10% | 0% | 2% |
| R1234zeE | 70% | 68% | 66% | 64% | 62% | 60% | 69% | 67% |
| GWP | 136 | 138 | 141 | 143 | 146 | 148 | 146 | 148 |
| Heating COP relative to R-290 | 101% | 101% | 101% | 102% | 102% | 102% | 101% | 101% |
| Cooling COP relative to R-290 | 104% | 105% | 105% | 106% | 107% | 107% | 104% | 105% |
| Heating Capacity relative to R-290 | 99% | 99% | 100% | 100% | 100% | 100% | 102% | 102% |
| Cooling Capacity relative to R-290 | 102% | 103% | 103% | 104% | 104% | 105% | 106% | 106% |
| Condensing Pressure (bar) | 27.0 | 26.9 | 26.8 | 26.7 | 26.6 | 26.5 | 27.4 | 27.4 |
| Evaporating Pressure (bar) | 2.0 | 2.0 | 2.0 | 2.0 | 2.0 | 2.0 | 2.0 | 2.0 |
| Average Glide (K) | 11.1 | 10.9 | 10.8 | 10.7 | 10.6 | 10.4 | 11.1 | 10.9 |

TABLE 41
R-1132a/R-32/R-152a/R-1234ze(E) compositions comprising 12% by weight R-1132a

| R1132a | 12% | 12% | 12% | 12% | 12% | 12% | 12% | 12% | 12% | 12% | 12% | 12% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 78% | 76% | 74% | 72% | 70% | 68% | 66% | 64% | 62% | 60% | 58% | 56% |
| GWP | 68 | 71 | 73 | 76 | 78 | 81 | 83 | 86 | 88 | 91 | 93 | 95 |
| Heating COP relative to R-290 | 100% | 100% | 100% | 100% | 101% | 101% | 101% | 101% | 102% | 102% | 102% | 102% |
| Cooling COP relative to R-290 | 101% | 102% | 103% | 103% | 104% | 104% | 105% | 106% | 106% | 107% | 107% | 108% |
| Heating Capacity relative to R-290 | 84% | 84% | 85% | 85% | 86% | 86% | 86% | 87% | 87% | 87% | 88% | 88% |
| Cooling Capacity relative to R-290 | 85% | 86% | 87% | 88% | 88% | 89% | 90% | 90% | 91% | 91% | 92% | 93% |
| Condensing Pressure (bar) | 24.6 | 24.6 | 24.6 | 24.5 | 24.5 | 24.4 | 24.4 | 24.3 | 24.3 | 24.2 | 24.2 | 24.1 |
| Evaporating Pressure (bar) | 1.7 | 1.7 | 1.7 | 1.7 | 1.7 | 1.7 | 1.7 | 1.7 | 1.7 | 1.7 | 1.7 | 1.7 |
| Average Glide (K) | 11.0 | 10.9 | 10.7 | 10.6 | 10.5 | 10.4 | 10.3 | 10.2 | 10.1 | 10.0 | 9.9 | 9.9 |
| R1132a | 12% | 12% | 12% | 12% | 12% | 12% | 12% | 12% | 12% | 12% | 12% | 12% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 82 | 84 | 87 | 89 | 92 | 94 | 97 | 99 | 102 | 104 | 106 | 109 |
| Heating COP relative to R-290 | 100% | 100% | 100% | 100% | 101% | 101% | 101% | 102% | 102% | 102% | 102% | 102% |
| Cooling COP relative to R-290 | 102% | 102% | 103% | 103% | 104% | 105% | 105% | 106% | 106% | 107% | 107% | 108% |
| Heating Capacity relative to R-290 | 88% | 88% | 88% | 89% | 89% | 89% | 90% | 90% | 90% | 91% | 91% | 91% |
| Cooling Capacity relative to R-290 | 89% | 90% | 91% | 91% | 92% | 93% | 93% | 94% | 95% | 95% | 96% | 96% |
| Condensing Pressure (bar) | 25.4 | 25.3 | 25.3 | 25.2 | 25.2 | 25.1 | 25.0 | 25.0 | 24.9 | 24.9 | 24.8 | 24.8 |
| Evaporating Pressure (bar) | 1.7 | 1.7 | 1.8 | 1.8 | 1.8 | 1.8 | 1.8 | 1.8 | 1.8 | 1.8 | 1.8 | 1.8 |
| Average Glide (K) | 11.2 | 11.1 | 11.0 | 10.8 | 10.7 | 10.6 | 10.5 | 10.4 | 10.3 | 10.2 | 10.1 | 10.0 |

TABLE 42
R-1132a/R-32/R-152a/R-1234ze(E) compositions comprising 12% by weight R-1132a

| R1132a | 12% | 12% | 12% | 12% | 12% | 12% | 12% | 12% | 12% | 12% | 12% | 12% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 95 | 98 | 100 | 103 | 105 | 108 | 110 | 113 | 115 | 118 | 120 | 122 |
| Heating COP relative to R-290 | 100% | 100% | 100% | 101% | 101% | 101% | 101% | 102% | 102% | 102% | 102% | 103% |
| Cooling COP relative to R-290 | 102% | 102% | 103% | 104% | 104% | 105% | 106% | 106% | 107% | 107% | 108% | 108% |
| Heating Capacity relative to R-290 | 92% | 92% | 92% | 92% | 93% | 93% | 93% | 94% | 94% | 94% | 94% | 95% |
| Cooling Capacity relative to R-290 | 93% | 94% | 95% | 95% | 96% | 97% | 97% | 98% | 98% | 99% | 99% | 100% |
| Condensing Pressure (bar) | 26.1 | 26.0 | 26.0 | 25.9 | 25.8 | 25.8 | 25.7 | 25.6 | 25.5 | 25.5 | 25.4 | 25.4 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 11.4 | 11.2 | 11.1 | 11.0 | 10.9 | 10.8 | 10.7 | 10.6 | 10.5 | 10.4 | 10.3 | 10.2 |
| R1132a | 12% | 12% | 12% | 12% | 12% | 12% | 12% | 12% | 12% | 12% | 12% | 12% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 109 | 111 | 114 | 116 | 119 | 121 | 124 | 126 | 129 | 131 | 133 | 136 |
| Heating COP relative to R-290 | 100% | 100% | 100% | 101% | 101% | 101% | 101% | 102% | 102% | 102% | 102% | 103% |
| Cooling COP relative to R-290 | 102% | 103% | 103% | 104% | 105% | 105% | 106% | 106% | 107% | 108% | 108% | 109% |
| Heating Capacity relative to R-290 | 95% | 96% | 96% | 96% | 96% | 97% | 97% | 97% | 97% | 98% | 98% | 98% |
| Cooling Capacity relative to R-290 | 98% | 98% | 99% | 99% | 100% | 101% | 101% | 102% | 102% | 103% | 103% | 103% |
| Condensing Pressure (bar) | 26.8 | 26.7 | 26.6 | 26.6 | 26.5 | 26.4 | 26.3 | 26.2 | 26.2 | 26.1 | 26.0 | 25.9 |
| Evaporating Pressure (bar) | 1.9 | 1.9 | 1.9 | 1.9 | 1.9 | 1.9 | 1.9 | 1.9 | 1.9 | 1.9 | 1.9 | 1.9 |
| Average Glide (K) | 11.5 | 11.3 | 11.2 | 11.1 | 11.0 | 10.9 | 10.8 | 10.7 | 10.6 | 10.5 | 10.4 | 10.3 |

TABLE 43
R-1132a/R-32/R-152a/R-1234ze(E) compositions comprising 12% by weight R-1132a

| | | | | | | | | | | | |
|---|---|---|---|---|---|---|---|---|---|---|---|
| R1132a | 12% | 12% | 12% | 12% | 12% | 12% | 12% | 12% | 12% | 12% | 12% |
| R32 | 18% | 18% | 18% | 18% | 18% | 18% | 18% | 18% | 18% | 18% | 18% |
| R152a | 0% | 2% | 4% | 6% | 8% | 10% | 12% | 14% | 16% | 18% | 20% |
| R1234zeE | 70% | 68% | 66% | 64% | 62% | 60% | 58% | 56% | 54% | 52% | 50% |
| GWP | 122 | 125 | 127 | 130 | 132 | 135 | 137 | 140 | 142 | 144 | 147 |
| Heating COP relative to R-290 | 100% | 100% | 100% | 101% | 101% | 101% | 102% | 102% | 102% | 102% | 103% |
| Cooling COP relative to R-290 | 103% | 103% | 104% | 104% | 105% | 106% | 106% | 107% | 107% | 108% | 108% |
| Heating Capacity relative to R-290 | 99% | 99% | 100% | 100% | 100% | 100% | 101% | 101% | 101% | 101% | 101% |
| Cooling Capacity relative to R-290 | 102% | 102% | 103% | 103% | 104% | 104% | 105% | 105% | 106% | 106% | 107% |
| Condensing Pressure (bar) | 27.4 | 27.4 | 27.3 | 27.2 | 27.1 | 27.0 | 26.9 | 26.8 | 26.8 | 26.7 | 26.6 |
| Evaporating Pressure (bar) | 2.0 | 2.0 | 2.0 | 2.0 | 2.0 | 2.0 | 2.0 | 2.0 | 2.0 | 2.0 | 2.0 |
| Average Glide (K) | 11.5 | 11.4 | 11.3 | 11.2 | 11.1 | 10.9 | 10.8 | 10.7 | 10.6 | 10.5 | 10.4 |

| | | | | | | | | |
|---|---|---|---|---|---|---|---|---|
| R1132a | 12% | 12% | 12% | 12% | 12% | 12% | 12% | 12% |
| R32 | 20% | 20% | 20% | 20% | 20% | 20% | 22% | 22% |
| R152a | 0% | 2% | 4% | 6% | 8% | 10% | 0% | 2% |
| R1234zeE | 68% | 66% | 64% | 62% | 60% | 58% | 67% | 65% |
| GWP | 136 | 138 | 141 | 143 | 146 | 148 | 146 | 148 |
| Heating COP relative to R-290 | 100% | 100% | 101% | 101% | 101% | 101% | 100% | 100% |
| Cooling COP relative to R-290 | 103% | 103% | 104% | 105% | 105% | 106% | 103% | 104% |
| Heating Capacity relative to R-290 | 103% | 103% | 103% | 104% | 104% | 104% | 106% | 106% |
| Cooling Capacity relative to R-290 | 106% | 106% | 107% | 107% | 108% | 108% | 109% | 109% |
| Condensing Pressure (bar) | 28.1 | 28.0 | 27.9 | 27.8 | 27.7 | 27.6 | 28.6 | 28.5 |
| Evaporating Pressure (bar) | 2.1 | 2.1 | 2.1 | 2.1 | 2.1 | 2.1 | 2.1 | 2.1 |
| Average Glide (K) | 11.6 | 11.4 | 11.3 | 11.2 | 11.1 | 11.0 | 11.6 | 11.4 |

TABLE 44
R-1132a/R-32/R-152a/R-1234ze(E) compositions comprising 14% by weight R-1132a

| R1132a | 14% | 14% | 14% | 14% | 14% | 14% | 14% | 14% | 14% | 14% | 14% | 14% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 76% | 74% | 72% | 70% | 68% | 66% | 64% | 62% | 60% | 58% | 56% | 54% |
| GWP | 68 | 71 | 73 | 76 | 78 | 81 | 83 | 86 | 88 | 91 | 93 | 95 |
| Heating COP relative to R-290 | 99% | 99% | 99% | 100% | 100% | 100% | 101% | 101% | 101% | 101% | 102% | 102% |
| Cooling COP relative to R-290 | 100% | 101% | 101% | 102% | 103% | 103% | 104% | 104% | 105% | 105% | 106% | 107% |
| Heating Capacity relative to R-290 | 87% | 88% | 88% | 89% | 89% | 89% | 90% | 90% | 90% | 91% | 91% | 91% |
| Cooling Capacity relative to R-290 | 88% | 89% | 90% | 91% | 91% | 92% | 93% | 93% | 94% | 94% | 95% | 96% |
| Condensing Pressure (bar) | 25.8 | 25.7 | 25.7 | 25.6 | 25.5 | 25.5 | 25.4 | 25.4 | 25.3 | 25.3 | 25.2 | 25.2 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 11.6 | 11.5 | 11.4 | 11.3 | 11.2 | 11.1 | 11.0 | 10.9 | 10.8 | 10.7 | 10.6 | 10.5 |
| R1132a | 14% | 14% | 14% | 14% | 14% | 14% | 14% | 14% | 14% | 14% | 14% | 14% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 82 | 84 | 87 | 89 | 92 | 94 | 97 | 99 | 102 | 104 | 106 | 109 |
| Heating COP relative to R-290 | 99% | 99% | 100% | 100% | 100% | 100% | 101% | 101% | 101% | 101% | 102% | 102% |
| Cooling COP relative to R-290 | 100% | 101% | 102% | 102% | 103% | 103% | 104% | 105% | 105% | 106% | 106% | 107% |
| Heating Capacity relative to R-290 | 91% | 92% | 92% | 92% | 93% | 93% | 93% | 94% | 94% | 94% | 95% | 95% |
| Cooling Capacity relative to R-290 | 93% | 93% | 94% | 95% | 95% | 96% | 97% | 97% | 98% | 98% | 99% | 99% |
| Condensing Pressure (bar) | 26.5 | 26.4 | 26.4 | 26.3 | 26.2 | 26.2 | 26.1 | 26.1 | 26.0 | 25.9 | 25.8 | 25.8 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 11.8 | 11.6 | 11.5 | 11.4 | 11.3 | 11.2 | 11.1 | 11.0 | 10.9 | 10.8 | 10.7 | 10.7 |

TABLE 45
R-1132a/R-32/R-152a/R-1234ze(E) compositions comprising 14% by weight R-1132a

| R1132a | 14% | 14% | 14% | 14% | 14% | 14% | 14% | 14% | 14% | 14% | 14% | 14% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 95 | 98 | 100 | 103 | 105 | 108 | 110 | 113 | 115 | 118 | 120 | 122 |
| Heating COP relative to R-290 | 99% | 99% | 100% | 100% | 100% | 101% | 101% | 101% | 101% | 101% | 102% | 102% |
| Cooling COP relative to R-290 | 101% | 101% | 102% | 102% | 103% | 104% | 104% | 105% | 105% | 106% | 107% | 107% |
| Heating Capacity relative to R-290 | 95% | 96% | 96% | 96% | 96% | 97% | 97% | 97% | 98% | 98% | 98% | 98% |
| Cooling Capacity relative to R-290 | 97% | 97% | 98% | 99% | 99% | 100% | 100% | 101% | 102% | 102% | 103% | 103% |
| Condensing Pressure (bar) | 27.2 | 27.1 | 27.1 | 27.0 | 26.9 | 26.8 | 26.8 | 26.7 | 26.6 | 26.5 | 26.4 | 26.4 |
| Evaporating Pressure (bar) | 1.9 | 1.9 | 1.9 | 1.9 | 1.9 | 1.9 | 1.9 | 1.9 | 1.9 | 1.9 | 1.9 | 1.9 |
| Average Glide (K) | 11.9 | 11.8 | 11.6 | 11.5 | 11.4 | 11.3 | 11.2 | 11.1 | 11.0 | 10.9 | 10.8 | 10.8 |
| R1132a | 14% | 14% | 14% | 14% | 14% | 14% | 14% | 14% | 14% | 14% | 14% | 14% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 109 | 111 | 114 | 116 | 119 | 121 | 124 | 126 | 129 | 131 | 133 | 136 |
| Heating COP relative to R-290 | 99% | 99% | 100% | 100% | 100% | 101% | 101% | 101% | 101% | 102% | 102% | 102% |
| Cooling COP relative to R-290 | 101% | 101% | 102% | 103% | 103% | 104% | 105% | 105% | 106% | 106% | 107% | 107% |
| Heating Capacity relative to R-290 | 99% | 99% | 100% | 100% | 100% | 100% | 101% | 101% | 101% | 101% | 101% | 102% |
| Cooling Capacity relative to R-290 | 101% | 101% | 102% | 103% | 103% | 104% | 104% | 105% | 105% | 106% | 106% | 107% |
| Condensing Pressure (bar) | 27.9 | 27.8 | 27.7 | 27.7 | 27.6 | 27.5 | 27.4 | 27.3 | 27.2 | 27.1 | 27.0 | 27.0 |
| Evaporating Pressure (bar) | 2.0 | 2.0 | 2.0 | 2.0 | 2.0 | 2.0 | 2.0 | 2.0 | 2.0 | 2.0 | 2.0 | 2.0 |
| Average Glide (K) | 12.0 | 11.8 | 11.7 | 11.6 | 11.5 | 11.4 | 11.3 | 11.2 | 11.1 | 11.0 | 10.9 | 10.8 |

TABLE 46
R-1132a/R-32/R-152a/R-1234ze(E) compositions comprising 14% by weight R-1132a

| R1132a | 14% | 14% | 14% | 14% | 14% | 14% | 14% | 14% | 14% | 14% |
|---|---|---|---|---|---|---|---|---|---|---|
| R32 | 18% | 18% | 18% | 18% | 18% | 18% | 18% | 18% | 18% | 18% |
| R152a | 0% | 2% | 4% | 6% | 8% | 10% | 12% | 14% | 16% | 18% |
| R1234zeE | 68% | 66% | 64% | 62% | 60% | 58% | 56% | 54% | 52% | 50% |
| GWP | 122 | 125 | 127 | 130 | 132 | 135 | 137 | 140 | 142 | 144 |
| Heating COP relative to R-290 | 99% | 100% | 100% | 100% | 100% | 101% | 101% | 101% | 101% | 102% |
| Cooling COP relative to R-290 | 101% | 102% | 102% | 103% | 104% | 104% | 105% | 105% | 106% | 107% |
| Heating Capacity relative to R-290 | 103% | 103% | 104% | 104% | 104% | 104% | 104% | 104% | 105% | 105% |
| Cooling Capacity relative to R-290 | 105% | 106% | 106% | 107% | 107% | 108% | 108% | 109% | 109% | 110% |
| Condensing Pressure (bar) | 28.6 | 28.5 | 28.4 | 28.3 | 28.2 | 28.1 | 28.0 | 27.9 | 27.8 | 27.7 |
| Evaporating Pressure (bar) | 2.1 | 2.1 | 2.1 | 2.1 | 2.1 | 2.1 | 2.1 | 2.1 | 2.1 | 2.1 |
| Average Glide (K) | 12.0 | 11.9 | 11.7 | 11.6 | 11.5 | 11.4 | 11.3 | 11.2 | 11.1 | 11.0 |
| R1132a | 14% | 14% | 14% | 14% | 14% | 14% | 14% | 14% | 14% | 14% |
| R32 | 18% | 18% | 20% | 20% | 20% | 20% | 20% | 20% | 22% | 22% |
| R152a | 20% | 22% | 0% | 2% | 4% | 6% | 8% | 10% | 0% | 2% |
| R1234zeE | 48% | 46% | 66% | 64% | 62% | 60% | 58% | 56% | 65% | 63% |
| GWP | 147 | 149 | 136 | 138 | 141 | 143 | 146 | 148 | 146 | 148 |
| Heating COP relative to R-290 | 102% | 102% | 99% | 100% | 100% | 100% | 101% | 101% | 100% | 100% |
| Cooling COP relative to R-290 | 107% | 108% | 102% | 102% | 103% | 103% | 104% | 105% | 102% | 102% |
| Heating Capacity relative to R-290 | 105% | 105% | 107% | 107% | 107% | 108% | 108% | 108% | 110% | 110% |
| Cooling Capacity relative to R-290 | 110% | 111% | 109% | 110% | 110% | 111% | 111% | 112% | 112% | 113% |
| Condensing Pressure (bar) | 27.6 | 27.5 | 29.2 | 29.1 | 29.0 | 28.9 | 28.8 | 28.7 | 29.7 | 29.6 |
| Evaporating Pressure (bar) | 2.0 | 2.0 | 2.2 | 2.2 | 2.2 | 2.2 | 2.2 | 2.1 | 2.2 | 2.2 |
| Average Glide (K) | 10.9 | 10.9 | 12.0 | 11.8 | 11.7 | 11.6 | 11.5 | 11.4 | 11.9 | 11.8 |

TABLE 47
R-1132a/R-32/R-152a/R-1234ze(E) compositions comprising 16% by weight R-1132a

| R1132a | 16% | 16% | 16% | 16% | 16% | 16% | 16% | 16% | 16% | 16% | 16% | 16% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 74% | 72% | 70% | 68% | 66% | 64% | 62% | 60% | 58% | 56% | 54% | 52% |
| GWP | 68 | 71 | 73 | 76 | 78 | 81 | 83 | 86 | 88 | 91 | 93 | 95 |
| Heating COP relative to R-290 | 98% | 99% | 99% | 99% | 99% | 100% | 100% | 100% | 101% | 101% | 101% | 101% |
| Cooling COP relative to R-290 | 99% | 99% | 100% | 101% | 101% | 102% | 103% | 103% | 104% | 104% | 105% | 105% |
| Heating Capacity relative to R-290 | 91% | 92% | 92% | 92% | 93% | 93% | 93% | 94% | 94% | 94% | 95% | 95% |
| Cooling Capacity relative to R-290 | 91% | 92% | 93% | 94% | 94% | 95% | 96% | 96% | 97% | 98% | 98% | 99% |
| Condensing Pressure (bar) | 26.9 | 26.8 | 26.8 | 26.7 | 26.6 | 26.6 | 26.5 | 26.4 | 26.4 | 26.3 | 26.2 | 26.2 |
| Evaporating Pressure (bar) | 1.8 | 1.8 | 1.8 | 1.8 | 1.8 | 1.8 | 1.8 | 1.8 | 1.8 | 1.8 | 1.8 | 1.8 |
| Average Glide (K) | 12.1 | 12.0 | 11.9 | 11.8 | 11.7 | 11.6 | 11.5 | 11.4 | 11.3 | 11.2 | 11.2 | 11.1 |
| R1132a | 16% | 16% | 16% | 16% | 16% | 16% | 16% | 16% | 16% | 16% | 16% | 16% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 82 | 84 | 87 | 89 | 92 | 94 | 97 | 99 | 102 | 104 | 106 | 109 |
| Heating COP relative to R-290 | 98% | 99% | 99% | 99% | 100% | 100% | 100% | 100% | 101% | 101% | 101% | 101% |
| Cooling COP relative to R-290 | 99% | 100% | 100% | 101% | 102% | 102% | 103% | 103% | 104% | 105% | 105% | 106% |
| Heating Capacity relative to R-290 | 95% | 95% | 96% | 96% | 96% | 97% | 97% | 97% | 98% | 98% | 98% | 98% |
| Cooling Capacity relative to R-290 | 96% | 96% | 97% | 98% | 98% | 99% | 100% | 100% | 101% | 101% | 102% | 103% |
| Condensing Pressure (bar) | 27.6 | 27.6 | 27.5 | 27.4 | 27.3 | 27.2 | 27.2 | 27.1 | 27.0 | 26.9 | 26.9 | 26.8 |
| Evaporating Pressure (bar) | 1.9 | 1.9 | 1.9 | 1.9 | 1.9 | 1.9 | 1.9 | 1.9 | 1.9 | 1.9 | 1.9 | 1.9 |
| Average Glide (K) | 12.3 | 12.1 | 12.0 | 11.9 | 11.8 | 11.7 | 11.6 | 11.5 | 11.4 | 11.4 | 11.3 | 11.2 |

TABLE 48
R-1132a/R-32/R-152a/R-1234ze(E) compositions comprising 16% by weight R-1132a

| R1132a | 16% | 16% | 16% | 16% | 16% | 16% | 16% | 16% | 16% | 16% | 16% | 16% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 95 | 98 | 100 | 103 | 105 | 108 | 110 | 113 | 115 | 118 | 120 | 122 |
| Heating COP relative to R-290 | 98% | 99% | 99% | 99% | 100% | 100% | 100% | 100% | 101% | 101% | 101% | 101% |
| Cooling COP relative to R-290 | 99% | 100% | 100% | 101% | 102% | 102% | 103% | 104% | 104% | 105% | 105% | 106% |
| Heating Capacity relative to R-290 | 99% | 99% | 100% | 100% | 100% | 101% | 101% | 101% | 101% | 101% | 102% | 102% |
| Cooling Capacity relative to R-290 | 100% | 100% | 101% | 102% | 102% | 103% | 104% | 104% | 105% | 105% | 106% | 106% |
| Condensing Pressure (bar) | 28.3 | 28.3 | 28.2 | 28.1 | 28.0 | 27.9 | 27.8 | 27.7 | 27.7 | 27.6 | 27.5 | 27.4 |
| Evaporating Pressure (bar) | 2.0 | 2.0 | 2.0 | 2.0 | 2.0 | 2.0 | 2.0 | 2.0 | 2.0 | 2.0 | 2.0 | 2.0 |
| Average Glide (K) | 12.3 | 12.2 | 12.1 | 12.0 | 11.9 | 11.8 | 11.7 | 11.6 | 11.5 | 11.4 | 11.3 | 11.3 |
| R1132a | 16% | 16% | 16% | 16% | 16% | 16% | 16% | 16% | 16% | 16% | 16% | 16% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 109 | 111 | 114 | 116 | 119 | 121 | 124 | 126 | 129 | 131 | 133 | 136 |
| Heating COP relative to R-290 | 99% | 99% | 99% | 99% | 100% | 100% | 100% | 100% | 101% | 101% | 101% | 101% |
| Cooling COP relative to R-290 | 100% | 100% | 101% | 101% | 102% | 103% | 103% | 104% | 104% | 105% | 106% | 106% |
| Heating Capacity relative to R-290 | 103% | 103% | 104% | 104% | 104% | 104% | 104% | 105% | 105% | 105% | 105% | 105% |
| Cooling Capacity relative to R-290 | 104% | 105% | 105% | 106% | 106% | 107% | 108% | 108% | 109% | 109% | 110% | 110% |
| Condensing Pressure (bar) | 29.0 | 28.9 | 28.8 | 28.7 | 28.6 | 28.6 | 28.4 | 28.4 | 28.3 | 28.2 | 28.1 | 28.0 |
| Evaporating Pressure (bar) | 2.1 | 2.1 | 2.1 | 2.1 | 2.1 | 2.1 | 2.1 | 2.1 | 2.1 | 2.1 | 2.1 | 2.1 |
| Average Glide (K) | 12.4 | 12.2 | 12.1 | 12.0 | 11.9 | 11.8 | 11.7 | 11.6 | 11.5 | 11.5 | 11.4 | 11.3 |

TABLE 49
R-1132a/R-32/R-152a/R-1234ze(E) compositions comprising 16% by weight R-1132a

| R1132a | 16% | 16% | 16% | 16% | 16% | 16% | 16% | 16% | 16% | 16% |
|---|---|---|---|---|---|---|---|---|---|---|
| R32 | 18% | 18% | 18% | 18% | 18% | 18% | 18% | 18% | 18% | 18% |
| R152a | 0% | 2% | 4% | 6% | 8% | 10% | 12% | 14% | 16% | 18% |
| R1234zeE | 66% | 64% | 62% | 60% | 58% | 56% | 54% | 52% | 50% | 48% |
| GWP | 122 | 125 | 127 | 130 | 132 | 135 | 137 | 140 | 142 | 144 |
| Heating COP relative to R-290 | 99% | 99% | 99% | 100% | 100% | 100% | 100% | 101% | 101% | 101% |
| Cooling COP relative to R-290 | 100% | 100% | 101% | 102% | 102% | 103% | 104% | 104% | 105% | 105% |
| Heating Capacity relative to R-290 | 107% | 107% | 107% | 108% | 108% | 108% | 108% | 108% | 108% | 108% |
| Cooling Capacity relative to R-290 | 108% | 109% | 109% | 110% | 111% | 111% | 112% | 112% | 113% | 113% |
| Condensing Pressure (bar) | 29.7 | 29.6 | 29.5 | 29.4 | 29.3 | 29.2 | 29.1 | 28.9 | 28.9 | 28.7 |
| Evaporating Pressure (bar) | 2.2 | 2.2 | 2.2 | 2.2 | 2.2 | 2.2 | 2.2 | 2.2 | 2.1 | 2.1 |
| Average Glide (K) | 12.4 | 12.2 | 12.1 | 12.0 | 11.9 | 11.8 | 11.7 | 11.6 | 11.5 | 11.5 |
| R1132a | 16% | 16% | 16% | 16% | 16% | 16% | 16% | 16% | 16% | 16% |
| R32 | 18% | 18% | 20% | 20% | 20% | 20% | 20% | 20% | 22% | 22% |
| R152a | 20% | 22% | 0% | 2% | 4% | 6% | 8% | 10% | 0% | 2% |
| R1234zeE | 46% | 44% | 64% | 62% | 60% | 58% | 56% | 54% | 63% | 61% |
| GWP | 147 | 149 | 136 | 138 | 141 | 143 | 146 | 148 | 146 | 148 |
| Heating COP relative to R-290 | 101% | 102% | 99% | 99% | 99% | 100% | 100% | 100% | 99% | 99% |
| Cooling COP relative to R-290 | 106% | 106% | 100% | 101% | 101% | 102% | 103% | 103% | 100% | 101% |
| Heating Capacity relative to R-290 | 109% | 109% | 111% | 111% | 111% | 112% | 112% | 112% | 114% | 114% |
| Cooling Capacity relative to R-290 | 114% | 114% | 113% | 113% | 114% | 114% | 115% | 115% | 116% | 116% |
| Condensing Pressure (bar) | 28.6 | 28.5 | 30.3 | 30.2 | 30.1 | 30.0 | 29.9 | 29.8 | 30.8 | 30.7 |
| Evaporating Pressure (bar) | 2.1 | 2.1 | 2.3 | 2.3 | 2.3 | 2.3 | 2.2 | 2.2 | 2.3 | 2.3 |
| Average Glide (K) | 11.4 | 11.3 | 12.3 | 12.2 | 12.1 | 12.0 | 11.9 | 11.8 | 12.2 | 12.1 |

TABLE 50
R-1132a/R-32/R-152a/R-1234ze(E) compositions comprising 18% by weight R-1132a

| R1132a | 18% | 18% | 18% | 18% | 18% | 18% | 18% | 18% | 18% | 18% | 18% | 18% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 72% | 70% | 68% | 66% | 64% | 62% | 60% | 58% | 56% | 54% | 52% | 50% |
| GWP | 68 | 71 | 73 | 76 | 78 | 81 | 83 | 86 | 88 | 91 | 93 | 95 |
| Heating COP relative to R-290 | 98% | 98% | 98% | 98% | 99% | 99% | 99% | 100% | 100% | 100% | 100% | 101% |
| Cooling COP relative to R-290 | 97% | 98% | 99% | 99% | 100% | 101% | 101% | 102% | 103% | 103% | 104% | 104% |
| Heating Capacity relative to R-290 | 95% | 95% | 96% | 96% | 96% | 97% | 97% | 97% | 98% | 98% | 98% | 98% |
| Cooling Capacity relative to R-290 | 95% | 95% | 96% | 97% | 98% | 98% | 99% | 100% | 100% | 101% | 101% | 102% |
| Condensing Pressure (bar) | 28.0 | 27.9 | 27.9 | 27.8 | 27.7 | 27.6 | 27.6 | 27.5 | 27.4 | 27.4 | 27.3 | 27.2 |
| Evaporating Pressure (bar) | 1.9 | 1.9 | 1.9 | 1.9 | 1.9 | 1.9 | 1.9 | 1.9 | 1.9 | 1.9 | 1.9 | 1.9 |
| Average Glide (K) | 12.5 | 12.4 | 12.3 | 12.2 | 12.1 | 12.1 | 12.0 | 11.9 | 11.8 | 11.7 | 11.6 | 11.6 |
| R1132a | 18% | 18% | 18% | 18% | 18% | 18% | 18% | 18% | 18% | 18% | 18% | 18% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 82 | 84 | 87 | 89 | 92 | 94 | 97 | 99 | 102 | 104 | 106 | 109 |
| Heating COP relative to R-290 | 98% | 98% | 98% | 99% | 99% | 99% | 99% | 100% | 100% | 100% | 100% | 101% |
| Cooling COP relative to R-290 | 98% | 98% | 99% | 100% | 100% | 101% | 102% | 102% | 103% | 103% | 104% | 104% |
| Heating Capacity relative to R-290 | 99% | 99% | 99% | 100% | 100% | 100% | 101% | 101% | 101% | 102% | 102% | 102% |
| Cooling Capacity relative to R-290 | 99% | 100% | 100% | 101% | 102% | 102% | 103% | 104% | 104% | 105% | 105% | 106% |
| Condensing Pressure (bar) | 28.7 | 28.7 | 28.6 | 28.5 | 28.4 | 28.3 | 28.2 | 28.1 | 28.1 | 28.0 | 27.9 | 27.8 |
| Evaporating Pressure (bar) | 2.0 | 2.0 | 2.0 | 2.0 | 2.0 | 2.0 | 2.0 | 2.0 | 2.0 | 2.0 | 2.0 | 2.0 |
| Average Glide (K) | 12.6 | 12.5 | 12.4 | 12.3 | 12.2 | 12.1 | 12.0 | 12.0 | 11.9 | 11.8 | 11.7 | 11.6 |

TABLE 51
R-1132a/R-32/R-152a/R-1234ze(E) compositions comprising 18% by weight R-1132a

| R1132a | 18% | 18% | 18% | 18% | 18% | 18% | 18% | 18% | 18% | 18% | 18% | 18% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 95 | 98 | 100 | 103 | 105 | 108 | 110 | 113 | 115 | 118 | 120 | 122 |
| Heating COP relative to R-290 | 98% | 98% | 98% | 99% | 99% | 99% | 100% | 100% | 100% | 100% | 101% | 101% |
| Cooling COP relative to R-290 | 98% | 99% | 99% | 100% | 101% | 101% | 102% | 102% | 103% | 104% | 104% | 105% |
| Heating Capacity relative to R-290 | 103% | 103% | 103% | 104% | 104% | 104% | 104% | 105% | 105% | 105% | 105% | 105% |
| Cooling Capacity relative to R-290 | 103% | 104% | 104% | 105% | 106% | 106% | 107% | 107% | 108% | 109% | 109% | 110% |
| Condensing Pressure (bar) | 29.4 | 29.4 | 29.3 | 29.2 | 29.1 | 29.0 | 28.9 | 28.8 | 28.7 | 28.6 | 28.5 | 28.4 |
| Evaporating Pressure (bar) | 2.1 | 2.1 | 2.1 | 2.1 | 2.1 | 2.1 | 2.1 | 2.1 | 2.1 | 2.1 | 2.1 | 2.1 |
| Average Glide (K) | 12.7 | 12.6 | 12.5 | 12.4 | 12.3 | 12.2 | 12.1 | 12.0 | 11.9 | 11.8 | 11.8 | 11.7 |
| R1132a | 18% | 18% | 18% | 18% | 18% | 18% | 18% | 18% | 18% | 18% | 18% | 18% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 66% | 64% | 62% | 60% | 58% | 56% | 54% | 52% | 50% | 48% | 46% | 44% |
| GWP | 109 | 111 | 114 | 116 | 119 | 121 | 124 | 126 | 129 | 131 | 133 | 136 |
| Heating COP relative to R-290 | 98% | 98% | 98% | 99% | 99% | 99% | 100% | 100% | 100% | 100% | 101% | 101% |
| Cooling COP relative to R-290 | 98% | 99% | 99% | 100% | 101% | 101% | 102% | 103% | 103% | 104% | 104% | 105% |
| Heating Capacity relative to R-290 | 107% | 107% | 107% | 108% | 108% | 108% | 108% | 108% | 109% | 109% | 109% | 109% |
| Cooling Capacity relative to R-290 | 107% | 108% | 109% | 109% | 110% | 110% | 111% | 111% | 112% | 112% | 113% | 113% |
| Condensing Pressure (bar) | 30.1 | 30.0 | 29.9 | 29.8 | 29.7 | 29.6 | 29.5 | 29.4 | 29.3 | 29.2 | 29.1 | 29.0 |
| Evaporating Pressure (bar) | 2.2 | 2.2 | 2.2 | 2.2 | 2.2 | 2.2 | 2.2 | 2.2 | 2.2 | 2.2 | 2.2 | 2.1 |
| Average Glide (K) | 12.7 | 12.6 | 12.5 | 12.4 | 12.3 | 12.2 | 12.1 | 12.0 | 11.9 | 11.8 | 11.8 | 11.7 |

TABLE 52
R-1132a/R-32/R-152a/R-1234ze(E) compositions comprising 18% by weight R-1132a

| R1132a | 18% | 18% | 18% | 18% | 18% | 18% | 18% | 18% | 18% | 18% |
|---|---|---|---|---|---|---|---|---|---|---|
| R32 | 18% | 18% | 18% | 18% | 18% | 18% | 18% | 18% | 18% | 18% |
| R152a | 0% | 2% | 4% | 6% | 8% | 10% | 12% | 14% | 16% | 18% |
| R1234zeE | 64% | 62% | 60% | 58% | 56% | 54% | 52% | 50% | 48% | 46% |
| GWP | 122 | 125 | 127 | 130 | 132 | 135 | 137 | 140 | 142 | 144 |
| Heating COP relative to R-290 | 98% | 98% | 99% | 99% | 99% | 99% | 100% | 100% | 100% | 101% |
| Cooling COP relative to R-290 | 99% | 99% | 100% | 100% | 101% | 102% | 102% | 103% | 103% | 104% |
| Heating Capacity relative to R-290 | 111% | 111% | 111% | 112% | 112% | 112% | 112% | 112% | 112% | 112% |
| Cooling Capacity relative to R-290 | 112% | 112% | 113% | 113% | 114% | 114% | 115% | 115% | 116% | 116% |
| Condensing Pressure (bar) | 30.8 | 30.7 | 30.6 | 30.5 | 30.4 | 30.2 | 30.1 | 30.0 | 29.9 | 29.8 |
| Evaporating Pressure (bar) | 2.3 | 2.3 | 2.3 | 2.3 | 2.3 | 2.3 | 2.3 | 2.2 | 2.2 | 2.2 |
| Average Glide (K) | 12.7 | 12.5 | 12.4 | 12.3 | 12.2 | 12.1 | 12.1 | 12.0 | 11.9 | 11.8 |
| R1132a | 18% | 18% | 18% | 18% | 18% | 18% | 18% | 18% | 18% | 18% |
| R32 | 18% | 18% | 20% | 20% | 20% | 20% | 20% | 20% | 22% | 22% |
| R152a | 20% | 22% | 0% | 2% | 4% | 6% | 8% | 10% | 0% | 2% |
| R1234zeE | 44% | 42% | 62% | 60% | 58% | 56% | 54% | 52% | 61% | 59% |
| GWP | 147 | 149 | 136 | 138 | 141 | 143 | 146 | 148 | 146 | 148 |
| Heating COP relative to R-290 | 101% | 101% | 98% | 98% | 99% | 99% | 99% | 100% | 98% | 98% |
| Cooling COP relative to R-290 | 105% | 105% | 99% | 99% | 100% | 101% | 101% | 102% | 99% | 100% |
| Heating Capacity relative to R-290 | 112% | 113% | 115% | 115% | 115% | 116% | 116% | 116% | 118% | 118% |
| Cooling Capacity relative to R-290 | 117% | 117% | 116% | 117% | 117% | 118% | 118% | 119% | 119% | 120% |
| Condensing Pressure (bar) | 29.7 | 29.6 | 31.5 | 31.4 | 31.2 | 31.1 | 31.0 | 30.9 | 31.9 | 31.8 |
| Evaporating Pressure (bar) | 2.2 | 2.2 | 2.4 | 2.4 | 2.4 | 2.4 | 2.4 | 2.3 | 2.5 | 2.4 |
| Average Glide (K) | 11.7 | 11.7 | 12.6 | 12.5 | 12.4 | 12.3 | 12.2 | 12.1 | 12.5 | 12.4 |

TABLE 53
R-1132a/R-32/R-152a/R-1234ze(E) compositions comprising 20% by weight R-1132a

| R1132a | 20% | 20% | 20% | 20% | 20% | 20% | 20% | 20% | 20% | 20% | 20% | 20% |
|---|---|---|---|---|---|---|---|---|---|---|---|---|
| R32 | 10% | 10% | 10% | 10% | 10% | 10% | 10% | 10% | 10% | 10% | 10% | 10% |
| R152a | 0% | 2% | 4% | 6% | 8% | 10% | 12% | 14% | 16% | 18% | 20% | 22% |
| R1234zeE | 70% | 68% | 66% | 64% | 62% | 60% | 58% | 56% | 54% | 52% | 50% | 48% |
| GWP | 68 | 71 | 73 | 76 | 78 | 81 | 83 | 86 | 88 | 91 | 93 | 95 |
| Heating COP relative to R-290 | 97% | 97% | 98% | 98% | 98% | 98% | 99% | 99% | 99% | 99% | 100% | 100% |
| Cooling COP relative to R-290 | 96% | 97% | 97% | 98% | 99% | 99% | 100% | 101% | 101% | 102% | 102% | 103% |
| Heating Capacity relative to R-290 | 99% | 99% | 99% | 100% | 100% | 100% | 101% | 101% | 101% | 102% | 102% | 102% |
| Cooling Capacity relative to R-290 | 98% | 98% | 99% | 100% | 101% | 101% | 102% | 103% | 103% | 104% | 105% | 105% |
| Condensing Pressure (bar) | 29.1 | 29.0 | 29.0 | 28.9 | 28.8 | 28.7 | 28.6 | 28.5 | 28.5 | 28.4 | 28.3 | 28.2 |
| Evaporating Pressure (bar) | 2.0 | 2.0 | 2.0 | 2.0 | 2.0 | 2.0 | 2.0 | 2.0 | 2.0 | 2.0 | 2.0 | 2.0 |
| Average Glide (K) | 12.9 | 12.8 | 12.7 | 12.6 | 12.5 | 12.4 | 12.4 | 12.3 | 12.2 | 12.1 | 12.1 | 12.0 |
| R1132a | 20% | 20% | 20% | 20% | 20% | 20% | 20% | 20% | 20% | 20% | 20% | 20% |
| R32 | 12% | 12% | 12% | 12% | 12% | 12% | 12% | 12% | 12% | 12% | 12% | 12% |
| R152a | 0% | 2% | 4% | 6% | 8% | 10% | 12% | 14% | 16% | 18% | 20% | 22% |
| R1234zeE | 68% | 66% | 64% | 62% | 60% | 58% | 56% | 54% | 52% | 50% | 48% | 46% |
| GWP | 82 | 84 | 87 | 89 | 92 | 94 | 97 | 99 | 102 | 104 | 106 | 109 |
| Heating COP relative to R-290 | 97% | 97% | 98% | 98% | 98% | 99% | 99% | 99% | 99% | 100% | 100% | 100% |
| Cooling COP relative to R-290 | 96% | 97% | 98% | 98% | 99% | 100% | 100% | 101% | 101% | 102% | 103% | 103% |
| Heating Capacity relative to R-290 | 103% | 103% | 103% | 104% | 104% | 104% | 105% | 105% | 105% | 105% | 105% | 106% |
| Cooling Capacity relative to R-290 | 102% | 103% | 103% | 104% | 105% | 105% | 106% | 107% | 107% | 108% | 108% | 109% |
| Condensing Pressure (bar) | 29.8 | 29.8 | 29.7 | 29.6 | 29.5 | 29.4 | 29.3 | 29.2 | 29.1 | 29.0 | 28.9 | 28.8 |
| Evaporating Pressure (bar) | 2.1 | 2.1 | 2.1 | 2.1 | 2.1 | 2.1 | 2.1 | 2.1 | 2.1 | 2.1 | 2.1 | 2.1 |
| Average Glide (K) | 13.0 | 12.9 | 12.8 | 12.7 | 12.6 | 12.5 | 12.4 | 12.3 | 12.2 | 12.2 | 12.1 | 12.0 |

TABLE 54
R-1132a/R-32/R-152a/R-1234ze(E) compositions comprising 20% by weight R-1132a

| R1132a | 20% | 20% | 20% | 20% | 20% | 20% | 20% | 20% | 20% | 20% | 20% | 20% |
|---|---|---|---|---|---|---|---|---|---|---|---|---|
| R32 | 14% | 14% | 14% | 14% | 14% | 14% | 14% | 14% | 14% | 14% | 14% | 14% |
| R152a | 0% | 2% | 4% | 6% | 8% | 10% | 12% | 14% | 16% | 18% | 20% | 22% |
| R1234zeE | 66% | 64% | 62% | 60% | 58% | 56% | 54% | 52% | 50% | 48% | 46% | 44% |
| GWP | 95 | 98 | 100 | 103 | 105 | 108 | 110 | 113 | 115 | 118 | 120 | 122 |
| Heating COP relative to R-290 | 97% | 97% | 98% | 98% | 98% | 99% | 99% | 99% | 99% | 100% | 100% | 100% |
| Cooling COP relative to R-290 | 97% | 97% | 98% | 99% | 99% | 100% | 100% | 101% | 102% | 102% | 103% | 103% |
| Heating Capacity relative to R-290 | 107% | 107% | 107% | 108% | 108% | 108% | 108% | 109% | 109% | 109% | 109% | 109% |
| Cooling Capacity relative to R-290 | 106% | 107% | 108% | 108% | 109% | 110% | 110% | 111% | 111% | 112% | 112% | 113% |
| Condensing Pressure (bar) | 30.5 | 30.5 | 30.4 | 30.2 | 30.1 | 30.0 | 29.9 | 29.8 | 29.7 | 29.6 | 29.5 | 29.4 |
| Evaporating Pressure (bar) | 2.2 | 2.2 | 2.2 | 2.2 | 2.2 | 2.2 | 2.2 | 2.2 | 2.2 | 2.2 | 2.2 | 2.2 |
| Average Glide (K) | 13.0 | 12.9 | 12.8 | 12.7 | 12.6 | 12.5 | 12.4 | 12.3 | 12.3 | 12.2 | 12.1 | 12.1 |
| R1132a | 20% | 20% | 20% | 20% | 20% | 20% | 20% | 20% | 20% | 20% | 20% | 20% |
| R32 | 16% | 16% | 16% | 16% | 16% | 16% | 16% | 16% | 16% | 16% | 16% | 16% |
| R152a | 0% | 2% | 4% | 6% | 8% | 10% | 12% | 14% | 16% | 18% | 20% | 22% |
| R1234zeE | 64% | 62% | 60% | 58% | 56% | 54% | 52% | 50% | 48% | 46% | 44% | 42% |
| GWP | 109 | 111 | 114 | 116 | 119 | 121 | 124 | 126 | 129 | 131 | 133 | 136 |
| Heating COP relative to R-290 | 97% | 98% | 98% | 98% | 98% | 99% | 99% | 99% | 100% | 100% | 100% | 100% |
| Cooling COP relative to R-290 | 97% | 98% | 98% | 99% | 100% | 100% | 101% | 101% | 102% | 103% | 103% | 104% |
| Heating Capacity relative to R-290 | 111% | 111% | 111% | 112% | 112% | 112% | 112% | 112% | 112% | 113% | 113% | 113% |
| Cooling Capacity relative to R-290 | 111% | 111% | 112% | 112% | 113% | 114% | 114% | 115% | 115% | 116% | 116% | 117% |
| Condensing Pressure (bar) | 31.2 | 31.1 | 31.0 | 30.9 | 30.8 | 30.7 | 30.6 | 30.5 | 30.3 | 30.2 | 30.1 | 30.0 |
| Evaporating Pressure (bar) | 2.3 | 2.3 | 2.3 | 2.3 | 2.3 | 2.3 | 2.3 | 2.3 | 2.3 | 2.3 | 2.2 | 2.2 |
| Average Glide (K) | 13.0 | 12.8 | 12.7 | 12.6 | 12.6 | 12.5 | 12.4 | 12.3 | 12.2 | 12.2 | 12.1 | 12.0 |

TABLE 55
R-1132a/R-32/R-152a/R-1234ze(E) compositions comprising 20% by weight R-1132a

| R1132a | 20% | 20% | 20% | 20% | 20% | 20% | 20% | 20% | 20% | 20% |
|---|---|---|---|---|---|---|---|---|---|---|
| R32 | 18% | 18% | 18% | 18% | 18% | 18% | 18% | 18% | 18% | 18% |
| R152a | 0% | 2% | 4% | 6% | 8% | 10% | 12% | 14% | 16% | 18% |
| R1234zeE | 62% | 60% | 58% | 56% | 54% | 52% | 50% | 48% | 46% | 44% |
| GWP | 122 | 125 | 127 | 130 | 132 | 135 | 137 | 140 | 142 | 144 |
| Heating COP relative to R-290 | 97% | 98% | 98% | 98% | 99% | 99% | 99% | 99% | 100% | 100% |
| Cooling COP relative to R-290 | 97% | 98% | 99% | 99% | 100% | 100% | 101% | 102% | 102% | 103% |
| Heating Capacity relative to R-290 | 115% | 115% | 116% | 116% | 116% | 116% | 116% | 116% | 116% | 116% |
| Cooling Capacity relative to R-290 | 115% | 116% | 116% | 117% | 117% | 118% | 118% | 119% | 119% | 120% |
| Condensing Pressure (bar) | 31.9 | 31.8 | 31.7 | 31.6 | 31.4 | 31.3 | 31.2 | 31.1 | 30.9 | 30.8 |
| Evaporating Pressure (bar) | 2.4 | 2.4 | 2.4 | 2.4 | 2.4 | 2.4 | 2.4 | 2.3 | 2.3 | 2.3 |
| Average Glide (K) | 12.9 | 12.8 | 12.7 | 12.6 | 12.5 | 12.4 | 12.3 | 12.3 | 12.2 | 12.1 |
| R1132a | 20% | 20% | 20% | 20% | 20% | 20% | 20% | 20% | 20% | 20% |
| R32 | 18% | 18% | 20% | 20% | 20% | 20% | 20% | 20% | 22% | 22% |
| R152a | 20% | 22% | 0% | 2% | 4% | 6% | 8% | 10% | 0% | 2% |
| R1234zeE | 42% | 40% | 60% | 58% | 56% | 54% | 52% | 50% | 59% | 57% |
| GWP | 147 | 149 | 136 | 138 | 141 | 143 | 146 | 148 | 146 | 148 |
| Heating COP relative to R-290 | 100% | 100% | 97% | 98% | 98% | 98% | 99% | 99% | 98% | 98% |
| Cooling COP relative to R-290 | 103% | 104% | 98% | 98% | 99% | 99% | 100% | 101% | 98% | 98% |
| Heating Capacity relative to R-290 | 116% | 116% | 119% | 120% | 120% | 120% | 120% | 120% | 123% | 123% |
| Cooling Capacity relative to R-290 | 120% | 121% | 119% | 120% | 121% | 121% | 122% | 122% | 123% | 123% |
| Condensing Pressure (bar) | 30.7 | 30.6 | 32.6 | 32.5 | 32.3 | 32.2 | 32.0 | 31.9 | 33.1 | 32.9 |
| Evaporating Pressure (bar) | 2.3 | 2.3 | 2.5 | 2.5 | 2.5 | 2.5 | 2.5 | 2.4 | 2.6 | 2.6 |
| Average Glide (K) | 12.0 | 12.0 | 12.8 | 12.7 | 12.6 | 12.5 | 12.4 | 12.3 | 12.6 | 12.5 |

TABLE 56
compositions comprising CO₂, R-1132a, R-32, R-1234ze(E) and R-152a

| | | | | | | | | | | | | |
|---|---|---|---|---|---|---|---|---|---|---|---|---|
| CO₂ | 4% | 4% | 6% | 4% | 4% | 6% | 4% | 4% | 6% | 4% | 4% | 6% |
| R1132a | 4% | 6% | 6% | 4% | 6% | 6% | 4% | 6% | 6% | 4% | 6% | 6% |
| R32 | 14% | 14% | 14% | 16% | 16% | 16% | 18% | 18% | 18% | 14% | 14% | 14% |
| R152a | 14% | 14% | 14% | 14% | 14% | 14% | 14% | 14% | 14% | 14% | 14% | 14% |
| R1234zeE | 64% | 62% | 60% | 62% | 60% | 58% | 60% | 58% | 56% | 64% | 62% | 60% |
| GWP | 113 | 113 | 113 | 126 | 126 | 126 | 140 | 140 | 140 | 113 | 113 | 113 |
| Heating COP relative to R-290 | 102% | 101% | 100% | 102% | 101% | 100% | 102% | 101% | 100% | 102% | 101% | 100% |
| Cooling COP relative to R-290 | 107% | 105% | 103% | 107% | 105% | 103% | 107% | 105% | 104% | 107% | 105% | 103% |
| Heating Capacity relative to R-290 | 90% | 93% | 98% | 93% | 96% | 101% | 96% | 99% | 104% | 90% | 93% | 98% |
| Cooling Capacity relative to R-290 | 94% | 97% | 101% | 97% | 100% | 104% | 101% | 103% | 108% | 94% | 97% | 101% |
| Condensing Pressure (bar) | 27.6 | 28.7 | 30.7 | 28.2 | 29.4 | 31.3 | 28.8 | 30.0 | 31.9 | 27.6 | 28.7 | 30.7 |
| Evaporating Pressure (bar) | 2.2 | 2.2 | 2.4 | 2.2 | 2.3 | 2.4 | 2.3 | 2.4 | 2.5 | 2.2 | 2.2 | 2.4 |
| Average Glide (K) | 10.2 | 10.8 | 11.9 | 10.3 | 10.8 | 11.9 | 10.3 | 10.9 | 11.8 | 10.2 | 10.8 | 11.9 |

TABLE 57
compositions comprising CO₂, R-1132a, R-32, R-1234ze(E) and R-152a

| | | | | | | | | | | | | |
|---|---|---|---|---|---|---|---|---|---|---|---|---|
| CO₂ | 4% | 4% | 6% | 4% | 4% | 6% | 4% | 4% | 6% | 4% | 4% | 6% |
| R1132a | 4% | 6% | 6% | 4% | 6% | 6% | 4% | 6% | 6% | 4% | 6% | 6% |
| R32 | 16% | 16% | 16% | 18% | 18% | 18% | 14% | 14% | 14% | 16% | 16% | 16% |
| R152a | 14% | 14% | 14% | 14% | 14% | 14% | 12% | 12% | 12% | 12% | 12% | 12% |
| R1234zeE | 62% | 60% | 58% | 60% | 58% | 56% | 66% | 64% | 62% | 64% | 62% | 60% |
| GWP | 126 | 126 | 126 | 140 | 140 | 140 | 110 | 110 | 110 | 124 | 124 | 124 |
| Heating COP relative to R-290 | 102% | 101% | 100% | 102% | 101% | 100% | 102% | 101% | 100% | 102% | 101% | 100% |
| Cooling COP relative to R-290 | 107% | 105% | 103% | 107% | 105% | 104% | 106% | 104% | 103% | 106% | 104% | 103% |
| Heating Capacity relative to R-290 | 93% | 96% | 101% | 96% | 99% | 104% | 90% | 93% | 98% | 93% | 96% | 101% |
| Cooling Capacity relative to R-290 | 97% | 100% | 104% | 101% | 103% | 108% | 94% | 96% | 100% | 97% | 99% | 104% |
| Condensing Pressure (bar) | 28.2 | 29.4 | 31.3 | 28.8 | 30.0 | 31.9 | 27.6 | 28.8 | 30.8 | 28.3 | 29.4 | 31.4 |
| Evaporating Pressure (bar) | 2.2 | 2.3 | 2.4 | 2.3 | 2.4 | 2.5 | 2.2 | 2.2 | 2.4 | 2.2 | 2.3 | 2.4 |
| Average Glide (K) | 10.3 | 10.8 | 11.9 | 10.3 | 10.9 | 11.8 | 10.3 | 10.9 | 12.0 | 10.4 | 10.9 | 12.0 |

TABLE 58
compositions comprising CO₂, R-1132a, R-32, R-1234ze(E) and R-152a

| | | | | | | | | | | | | |
|---|---|---|---|---|---|---|---|---|---|---|---|---|
| CO₂ | 4% | 4% | 6% | 4% | 4% | 6% | 4% | 4% | 6% | 4% | 4% | 6% |
| R1132a | 4% | 6% | 6% | 4% | 6% | 6% | 4% | 6% | 6% | 4% | 6% | 6% |
| R32 | 18% | 18% | 18% | 14% | 14% | 14% | 16% | 16% | 16% | 18% | 18% | 18% |
| R152a | 12% | 12% | 12% | 12% | 12% | 12% | 12% | 12% | 12% | 14% | 12% | 12% |
| R1234zeE | 62% | 60% | 58% | 66% | 64% | 62% | 64% | 62% | 60% | 60% | 60% | 58% |
| GWP | 137 | 137 | 137 | 110 | 110 | 110 | 124 | 124 | 124 | 140 | 137 | 137 |
| Heating COP relative to R-290 | 102% | 101% | 100% | 102% | 101% | 100% | 102% | 101% | 100% | 102% | 101% | 100% |
| Cooling COP relative to R-290 | 106% | 105% | 103% | 106% | 104% | 103% | 106% | 104% | 103% | 107% | 105% | 103% |
| Heating Capacity relative to R-290 | 96% | 99% | 104% | 90% | 93% | 98% | 93% | 96% | 101% | 96% | 99% | 104% |
| Cooling Capacity relative to R-290 | 100% | 103% | 107% | 94% | 96% | 100% | 97% | 99% | 104% | 101% | 103% | 107% |
| Condensing Pressure (bar) | 28.9 | 30.1 | 32.0 | 27.6 | 28.8 | 30.8 | 28.3 | 29.4 | 31.4 | 28.8 | 30.1 | 32.0 |
| Evaporating Pressure (bar) | 2.3 | 2.4 | 2.5 | 2.2 | 2.2 | 2.4 | 2.2 | 2.3 | 2.4 | 2.3 | 2.4 | 2.5 |
| Average Glide (K) | 10.4 | 10.9 | 11.9 | 10.3 | 10.9 | 12.0 | 10.4 | 10.9 | 12.0 | 10.3 | 10.9 | 11.9 |

1. A composition comprising:
(a) 1,1-difluoroethylene (R-1132a);
(b) difluoromethane (R-32);
(c) 1,1-difluoroethane (R-152a); and
(d) trans-1,3,3,3-tetrafluoropropene (R-1234ze(E)).

2. The composition according to claim 1 comprising from about 1 to about 20% by weight R-1132a, from about 2 to about 20% by weight, from about 3 to about 20% by weight, from about 4 to about 18% by weight, or from about 4 to about 16% by weight.

3. The composition according to claim 1 comprising from about 1 to about 35% by weight R-32, from about 2 to about 30% by weight, from about 5 to about 28% by weight, from about 7 to about 25% by weight, or from about 10 to about 22% by weight.

4. The composition according to claim 1 comprising from about 1 to about 50% by weight R-152a, from about 2 to about 40% by weight, from about 3 to about 35% by weight, from about 3 to about 30% by weight, or from about 4 to about 25% by weight.

5. The composition according to claim 1 comprising from about 30 to about 90% by weight R-1234ze(E), from about 30 to about 85% by weight, from about 35 to about 80% by weight, from about 40 to about 75% by weight, or from about 45 to about 70% by weight.

6. The composition according to claim 1, wherein the composition comprises;
from about 1 to about 20% by weight R-1132a, from about 1 to about 35% by weight R-32, from about 1 to about 50% by weight R-152a and from about 30 to about 90% by weight R-1234ze(E),
from about 2 to about 20% by weight R-1132a, from about 2 to about 30% by weight R-32, from about 2 to about 40% by weight R-152a and from about 30 to about 85% by weight R-1234ze(E), or
from about 3 to about 20% by weight R-1132a, from about 5 to about 28% by weight R-32, from about 3 to about 35% by weight R-152a and from about 35 to about 80% by weight R-1234ze(E).

7. The composition according to claim 1, wherein the composition comprises;
from about 6 to about 16% by weight R-1132a, from about 15 to about 22% by weight R-32, from about 7 to about 20% by weight R-152a and from about 50 to 60% by weight R-1234ze(E), or
from about 8 to about 16% by weight R-1132a, from about 16 to about 21% by weight R-32, from about 8 to about 18% by weight R-152a and from about 50 to 60% by weight R-1234ze(E).

8. The composition according to claim 1, wherein the weight ratio of R-152a to R-1234ze(E) is 1:1.5 or less, 1:2 or less, 1:2.5 or less, or 1:3 or less.

9. The composition according to claim 1, wherein the R-152a is present in the compositions of the invention in an amount such that the weight ratio of R-152a and R-1234ze(E) is from about 1:3 to about 1:15, from about 1:3.1 to about 1:12, or from about 1:3.2 to 1:10.

10. The composition according to claim 1, wherein the composition further comprises R-1132(E), wherein the R-1132(E) is present in an amount of from about 1 to about 32% by weight, from about 1 to about 28% by weight, from about 2 to about 25% by weight, or from about 6 to about 24% by weight, or from about 9 to about 21% by weight.

11. The composition according to claim 10, wherein the R-1132(E) is present in an amount less than that of R-32 on weight basis.

12. The composition according to claim 1 wherein the composition further comprises from 0 to 15% by weight 2,3,3,3-tetrafluoropropene (R-1234yf), from 0 to about 10% by weight R-1234yf, or wherein the composition is substantially free of R-1234yf.

13. The composition according to claim 1, wherein the composition further comprises carbon dioxide (CO₂).

14. The composition according to claim 13, wherein the CO₂ is present in an amount of from about 1 to about 20% by weight, from about 1 to about 18% by weight, from about 2 to about 18% by weight, or from about 2 to about 16% by weight

15. The composition according to claim 13, wherein the R-1132a and the CO₂ are present in a combined amount of from about 2 to about 25% by weight, from about 3 or about 4 to about 20% by weight, from about 5 to about 18% by weight, or from about 6 to about 18% by weight.

16. The composition according to claim 13:
wherein the composition comprises R-1132a and CO₂ in a combined amount of from about 2 to about 25% by weight, from about 1 to about 35% by weight R-32, from about 1 to about 50% by weight R-152a and from about 30 to about 90% by weight R-1234ze(E),
wherein the composition comprises R-1132a and CO₂ in a combined amount of from about 3 to about 20% by weight, from about 2 to about 30% by weight R-32, from about 2 to about 40% by weight R-152a and from about 30 to about 85% by weight R-1234ze(E), or
wherein the composition comprises R-1132a and CO₂ in a combined amount of from about 5 to about 20% by weight, from about 5 to about 28% by weight R-32, from about 3 to about 35% by weight R-152a and from about 35 to about 80% by weight R-1234ze(E).

17. The composition according to claim 13:
comprising CO₂ and R-1132a in a combined amount of from about 4 to about 16% by weight, from about 15 to about 22% by weight R-32, from about 11 to about 22% by weight R-152a and from about 50 to 65% by weight R-1234ze(E), or
comprising R-1132a and CO₂ in a combined amount of from about 6 to about 18% by weight, from about 15 to about 22% by weight R-32, from about 10 to about 18% by weight R-152a and from about 50 to 60% by weight R-1234ze(E).

18. The composition according to claim 1 consisting essentially of the stated components.

19. The composition according to claim 1, wherein the composition has a Global Warming Potential (GWP) of less than 250, less than 200, less than 175, or less than 150.

20. The composition according to claim 1, wherein the composition is less flammable than R-1132a and/or R-1132(E) alone.

21. The composition according to claim 20 wherein the composition has:
a. a higher flammable limit;
b. a higher ignition energy; and/or
c. a lower flame velocity
compared to R-1132a and/or R-1132(E) alone, optionally wherein the composition is non-flammable.

22. The composition according to claim 1, wherein the composition has a coefficient of performance (COP) that is within about 10% of that of propane, within about 7%, within about 5%, or wherein the COP is equivalent or higher than that of propane.

23. The composition according to claim 1, wherein the composition has a volumetric refrigeration capacity that is within about 15% of that of propane, within about 10%, within about 5%, or wherein the volumetric refrigeration capacity is greater than or equal to that of propane.

24. The composition according to claim 1 wherein the composition has a temperature glide in an evaporator or condenser of from about 20K to about 5K, or from about 15K to about 5K.

25. The composition according to claim 1, wherein the composition has a burning velocity of less than about 10 cm/s as measured by ASHRAE Standard 34.

26. The composition according to claim 1, wherein the composition has a bubble point at atmospheric pressure of below about −42° C., or below about −50° C.

27. The composition according to claim 1, wherein the composition has a total generation potential of TFA from unit mass of the composition which is less than that of the equivalent mass of R-1234yf, 15% or less, 2% or less, or 1% or less.

28. The composition according to claim 1, further comprising a lubricant, wherein the lubricant is selected from mineral oil, silicone oil, polyalkyl benzenes (PABs), polyol esters (POEs), polyalkylene glycols (PAGs), polyalkylene glycol esters (PAG esters), polyvinyl ethers (PVEs), poly (alpha-olefins) and combinations thereof, or wherein the lubricant is selected from PAGs or POEs.

29. The composition according to claim 1, further comprising a stabiliser, wherein the stabiliser is selected from diene-based compounds, phosphates, phenol compounds (such as 2,6-Di-tert-butyl-4-methylphenol) and epoxides, and mixtures thereof.

30. The composition according to claim 1, further comprising a flame retardant, wherein the flame retardant is selected from the group consisting of tri-(2-chloroethyl)-phosphate, (chloropropyl) phosphate, tri-(2,3-dibromopropyl)-phosphate, tri-(1,3-dichloropropyl)-phosphate, diammonium phosphate, various halogenated aromatic compounds, antimony oxide, aluminium trihydrate, polyvinyl chloride, a fluorinated iodocarbon, a fluorinated bromocarbon, trifluoro iodomethane, perfluoroalkyl amines, bromo-fluoroalkyl amines and mixtures thereof.

31. A liquid chiller system comprising a composition as defined in claim 1, wherein the liquid chiller system comprises at least one counter-flow heat exchanger for exchanging heat between the composition and the liquid.

32. The liquid chiller system according to claim 31, wherein the system is adapted for cooling and/or heating the passenger cabin and/or for cooling the battery of an electric vehicle.

33. The liquid chiller system according to claim 31, wherein the liquid is selected from water, brine, glycol, a synthetic hydrocarbon fluid, a silicone-based fluid or wholly or partially fluorinated organic fluid, fluid blends with freeze point or viscosity reduction additives and mixtures thereof.

34. A thermal management system of an electric vehicle comprising the liquid chiller system as defined in claim 31.

35. A method for operating a heat transfer device comprising at least one counter-flow heat exchanger for exchanging heat between the composition and the liquid, wherein the heat transfer device is a liquid chiller system and/or is incorporated into a thermal management system of an electric vehicle, the method comprising introducing the composition according to claim 1 into the heat transfer device.

36. A method for modifying a heat transfer device comprising introducing the composition according to claim 1 as a replacement for an existing refrigerant.

37. The method according to claim 36, wherein the existing refrigerant is of comprises propane and/or 2,3,3,3-tetrafluoropropene (R-1234yf).

38. The method according to claim 36, wherein the the existing refrigerant is replaced in a liquid chiller system.

39. The method according to claim 38, wherein the liquid chiller system is adapted for cooling and/or heating the passenger cabin and/or for cooling the battery of an electric vehicle.

40. A method of producing cooling which method comprises evaporating a composition as defined in claim 1 in the vicinity of a body to be cooled.

41. A method for producing heating which method comprises condensing a composition as defined in claim 1 in the vicinity of a body to be heated.

42. The method of claim 36 comprising the step of removing the existing refrigerant, and introducing the replacement composition, wherein the heat transfer device is a thermal management system of an electric vehicle.

43. The method according to claim 42, wherein the existing heat transfer composition is propane (R-290) or 2,3,3,3-tetrafluoropropene (R-1234yf).

44. The method according to claim 42, wherein the existing refrigerant comprises propane and/or 2,3,3,3-tetrafluoropropene (R-1234yf), or wherein the existing refrigerant is propane or R-1234yf.
